(19) United States
(12) Patent Application Publication
(10) Pub. No.: US 2012/0044996 A1
(43) Pub. Date: Feb. 23, 2012

(54) IMAGE PROCESSING DEVICE AND METHOD

(76) Inventor: Kazushi Sato, Kanagawa (JP)

(21) Appl. No.: 13/148,893

(22) PCT Filed: Feb. 12, 2010
(86) PCT No.: PCT/JP2010/052020

§ 371 Date: Nov. 9, 2011

(30) Foreign Application Priority Data
Feb. 20, 2009 (JP) 2009037466

(51) Int. Cl. H04N 7/26

(52) U.S. Cl. 375/240.16; 375/E07.125

(57) ABSTRACT

The present invention relates to an image processing device an method whereby processing efficiency can be improved.

In the event that an object block is a block B1, pixels UB1 and a pixel LUB1 adjacent to the object block at the upper portion and upper left portion, and pixels LB0 adjacent to the left portion of the block B0, are set as a template. In the event that an object block is a block B2, a pixel LUB2 and pixels LB2 adjacent to the object block at the upper left portion and left portion, and pixels UB0 adjacent to the upper portion of the block B0, are set as a template. In the event that an object block is a block B3, a pixel LUB0 adjacent to the block B0 at the upper left portion, pixels UB1 adjacent to the upper portion of the block B1, and pixels LB2 adjacent to the left portion of the block B2, are set as a template. The present invention can be applied to an image encoding device which encodes with the H.264/AVC format, for example.

### TECHNICAL FIELD

The present invention relates to an image processing device and method, and more particularly relates to an image processing device and method whereby processing efficiency in template matching prediction processing is improved.

### BACKGROUND ART

In recent years, there is widespread use of devices which perform compression encoding of images using formats such as MPEG with which compression is performed by orthogonal transform such as discrete cosine transform and the like and motion compensation, using redundancy inherent to image information, aiming for highly-efficient information transmission and accumulation when handling image information as digital. Examples of such encoding formats includes MPEG (Moving Picture Experts Group) and so forth.

In particular, MPEG2 (ISO/IEC 13818-2) is defined as a general-purpose image encoding format, which is a standard covering both interlaced scanning images and progressive scanning images, and standard-resolution images and high-resolution images, and is currently widely used in a broad range of professional and consumer use applications. For example, with an interlaced scanning image with standard resolution of 720×480 pixels for example, a code amount (bit rate) of 4 to 8 Mbps is applied by using the MPEG2 compression format. Also, with an interlaced scanning image with high resolution of 1920×1088 pixels for example, a code amount (bit rate) of 18 to 22 Mbps is applied by using the MPEG2 compression format. Thus, high compression and good image quality can be realized.

MPEG2 was primarily for high-quality encoding suitable for broadcasting, but did not handle code amount (bit rate) lower than MPEG1, i.e., high-compression encoding formats. Due to portable terminals coming into widespread use, it is thought that demand for such encoding formats will increase, and accordingly the MPEG4 encoding format has been standardized. As for an image encoding format, the stipulations thereof were recognized as an international Standard as ISO/IEC 14496-2 in December 1998.

Further, in recent years, normalization of a Standard called H.26L (ITU-T Q6/16 VCEG) is proceeding, initially aiming for image encoding for videoconferencing. While H.26L requires a greater computation amount for encoding and decoding thereof as compared with conventional encoding formats such as MPEG2 and MPEG4, it is known that a higher encoding efficiency is realized. Also, currently, standardization including functions not supported by H.26L to realize higher encoding efficiency is being performed based on H.26L, as Joint Model of Enhanced-Compression Video Coding. The schedule of standardization is to make an international Standard called H.264 and MPEG-4 Part 10 (Advanced Video Coding, hereinafter written as H.264/AVC) by March of 2003.

Now, with the MPEG2 format, half-pixel precision motion prediction/compensation is performed by linear interpolation processing. On the other hand, with the H.264/AVC format, quarter-pixel precision motion prediction/compensation is performed using 6-tap FIR (Finite Impulse Response Filter).

Also, with the MPEG2 format, in the case of frame motion compensation mode, motion prediction/compensation processing is performed in 16×16 pixel increments, and in the case of field motion compensation mode, motion prediction/compensation processing is performed in 16×8 pixel increments for each of a first field and a second field.

On the other hand, with the H.264/AVC format, motion prediction/compensation processing can be performed with variable block sizes. That is to say, with the H.264/AVC format, a macro block configured of 16×16 pixels can be divided into partitions of any one of 16×16, 16×8, 8×16, or 8×8, with each having independent motion vector information. Also, a partition of 8×8 can be divided into sub-partitions of any one of 8×8, 8×4, 4×8, or 4×4, with each having independent motion vector information.

However, with the H.264/AVC format, motion prediction/compensation processing is performed with quarter-pixel precision and variable blocks as described above, resulting in massive motion vector information being generated, which has led to deterioration in encoding efficiency if this is encoded as it is. Accordingly, there has been proposed suppression in deterioration of encoding efficiency by a method in which prediction motion vector information of a motion compensation block which is to be encoded being generated by median operation using motion vector information of an adjacent motion compensation block already encoded, or the like.

However, even with median prediction, the percentage of motion vector information in the image compression information is not small. Accordingly, the format described in PTL 1 has been proposed. This format is to search, from a decoded image, a region of the image with great correlation with the decoded image of a template region that is part of the decoded image, as well as being adjacent to a region of the image to be encoded in a predetermined positional relation, and to perform prediction based on the predetermined positional relation with the searched region.

This method is called template matching, and uses a decoded image for matching, so the same processing can be used at the encoding device and decoding device by determining a search range beforehand. That is to say, deterioration in encoding efficiency can be suppressed by performing the prediction/compensation processing such as described above at the decoding device as well, since there is no need to have motion vector information within image compression information from the encoding device.

The template matching format can be used for both intra prediction and inter prediction, and will hereinafter be referred to as intra template matching prediction processing and inter template matching prediction processing.

### CITATION LIST

### Patent Literature

PTL 1: Japanese Unexamined Patent Application Publication No. 2007-43651

### SUMMARY OF INVENTION

### Technical Problem

Now, with reference to FIG. 1, let us consider a case of performing processing in 8×8 pixel block increments in intra or inter template matching prediction processing. The example in FIG. 1 illustrates a 16×16 pixel macro block. The macro block is configured of an upper left block 0, upper right block 1, lower left block 2, and lower right block 3, each configured of 8×8 pixels.

For example, in the event of performing template matching prediction processing at block 1, adjacent pixels P1, P2, and P3, which are adjacent to block 1 at the upper portion, upper left portion, and left portion, and are a part of the decoded image, are used as template regions.

That is to say, unless the encoding processing of block 0 ends, the adjacent pixels P3 of the template regions do not become available (available), so template matching prediction processing cannot be performed at block 1. Accordingly, with the conventional template matching prediction processing, it has been difficult to perform prediction processing of block 0 and block 1 within a macro block by parallel processing or pipeline processing.

The same can be said regarding performing intra or inter template matching prediction processing with 4×4 blocks as increments within 8×8 sub-blocks.

The present invention has been made in light of such a situation, and improves processing efficiency in template matching prediction processing.

### Solution to Problem

An image processing device according to a first aspect of the present invention includes: template pixel setting means for setting pixels of a template used for calculation of a motion vector of a block configuring a predetermined block of an image, out of pixels adjacent to one of the blocks by a predetermined positional relation and also generated from a decoded image, in accordance to the address of the block within the predetermined block; and template motion prediction compensation means for calculating a motion vector of the block, using the template made up of the pixels set by the template pixel setting means.

Further included may be encoding means for encoding the block, using the motion vector calculated by the template motion prediction compensation means.

The template pixel setting means may set, for an upper left block situated at the upper left of the predetermined block, pixels adjacent to the left portion, upper portion, and upper left portion of the upper left block, as the template.

The template pixel setting means may set, for an upper right block situated at the upper right of the predetermined block, pixels adjacent to the upper portion and upper left portion of the upper right block, and pixels adjacent to the left portion of an upper left block situated to the upper left in the predetermined block, as the template.

The template pixel setting means may set, for a lower left block situated at the lower left of the predetermined block, pixels adjacent to the upper left portion and left portion of the lower left block, and pixels adjacent to the upper portion of an upper left block situated to the upper left in the predetermined block, as the template.

The template pixel setting means may set, for a lower right block situated at the lower right of the predetermined block, a pixel adjacent to the upper left portion of an upper left block situated at the upper left in the predetermined block, pixels adjacent to the upper portion of an upper right block situated at the upper right in the predetermined block, and pixels adjacent to the left portion of a lower left block situated at the lower left in the predetermined block, as the template.

The template pixel setting means may set, for a lower right block situated at the lower right of the predetermined block, pixels adjacent to the upper portion and upper left portion of an upper right block situated at the upper right in the predetermined block, and pixels adjacent to the left portion of a lower left block situated to the lower left in the predetermined block, as the template.

The template pixel setting means may set, for a lower right block situated at the lower right of the predetermined block, pixels adjacent to the upper portion of an upper right block situated at the upper right in the predetermined block, and pixels adjacent to the left portion and upper left portion of a lower left block situated to the lower left in the predetermined block, as the template.

An image processing method according to the first aspect of the present invention includes the step of an image processing device setting pixels of a template used for calculation of a motion vector of a block configuring a predetermined block of an image, out of pixels adjacent to one of the blocks by a predetermined positional relation, in accordance to the address of the block within the predetermined block, and calculating the motion vector of the block, using the template made up of the pixels that have been set.

An image processing device according to a second aspect of the present invention includes: decoding means for decoding an image of an encoded block; template pixel setting means for setting pixels of a template used for calculation of a motion vector of a block configuring a predetermined block of an image, out of pixels adjacent to one of the blocks by a predetermined positional relation and also generated from a decoded image, in accordance to the address of the block within the predetermined block; template motion prediction means for calculating a motion vector of the block, using the template made up of the pixels set by the template pixel setting means; and motion compensation means for generating a prediction image of the block, using the image decoded by the decoding means, and the motion vector calculated by the template motion prediction means.

The template pixel setting means may set, for an upper left block situated at the upper left of the predetermined block, pixels adjacent to the left portion, upper portion, and upper left portion of the upper left block, as the template.

The template pixel setting means may set, for an upper right block situated at the upper right of the predetermined block, pixels adjacent to the upper portion and upper left portion of the upper right block, and pixels adjacent to the left portion of an upper left block situated to the upper left in the predetermined block, as the template.

The template pixel setting means may set, for a lower left block situated at the lower left of the predetermined block, pixels adjacent to the upper left portion and left portion of the lower left block, and pixels adjacent to the upper portion of an upper left block situated to the upper left in the predetermined block, as the template.

The template pixel setting means may set, for a lower right block situated at the lower right of the predetermined block, a pixel adjacent to the upper left portion of an upper left block situated at the upper left in the predetermined block, pixels adjacent to the upper portion of an upper right block situated at the upper right in the predetermined block, and pixels adjacent to the left portion of a lower left block situated at the lower left in the predetermined block, as the template.

The template pixel setting means may set, for a lower right block situated at the lower right of the predetermined block, pixels adjacent to the upper portion and upper left portion of an upper right block situated at the upper right in the predetermined block, and pixels adjacent to the left portion of a lower left block situated to the lower left in the predetermined block, as the template.

An image processing method according to the second aspect of the present invention includes the step of an image processing device decoding an image of an encoded block, setting pixels of a template used for calculation of a motion vector of a block configuring a predetermined block of an image, out of pixels adjacent to one of the blocks by a predetermined positional relation and also generated from a decoded image, in accordance to the address of the block within the predetermined block, calculating a motion vector of the block, using the template made up of the pixels that have been set, and generating a prediction image of the block, using the decoded image and the calculated motion vector.

With the first aspect of the present invention, pixels of a template used for calculation of a motion vector of a block configuring a predetermined block of an image, are set, out of pixels adjacent to one of the blocks by a predetermined positional relation, in accordance to the address of the block within the predetermined block. The motion vector of the block is then calculated, using the template made up of the pixels that have been set.

With the second aspect of the present invention, an image of an encoded block is decoded, pixels of a template used for calculation of a motion vector of a block configuring a predetermined block of an image, are set, out of pixels adjacent to one of the blocks by a predetermined positional relation and also generated from a decoded image, in accordance to the address of the block within the predetermined block, and a motion vector of the block is calculated, using the template made up of the set pixels. A prediction image of the block is then generated, using the decoded image and the calculated motion vector.

Note that the above-described image processing devices may each be independent devices, or may be internal blocks configuring a single image encoding device or image decoding device.

### ADVANTAGEOUS EFFECTS OF INVENTION

According to the first aspect of the present invention, a motion vector of a block of an image can be calculated. Also, according to the first aspect of the present invention, prediction processing efficiency can be improved.

According to the second aspect of the present invention, an image can be decoded. Also, according to the second aspect of the present invention, prediction processing efficiency can be improved.

### BRIEF DESCRIPTION OF DRAWINGS

FIG. 1 is a diagram describing a conventional template.

FIG. 2 is a block diagram illustrating an embodiment of an image encoding device to which the present invention has been applied.

FIG. 3 is a diagram describing variable block size motion prediction/compensation processing.

FIG. 4 is a diagram describing quarter-pixel precision motion prediction/compensation processing.

FIG. 5 is a diagram describing a multi-reference frame motion prediction/compensation processing method.

FIG. 6 is a diagram describing an example of a method for generation of motion vector information.

FIG. 7 is a block diagram illustrating a detail configuration example of various parts performing processing relating to a template prediction mode.

FIG. 8 is a diagram illustrating an example of template pixel settings in the event that the block size is 8×8 pixels.

FIG. 9 is a diagram illustrating another example of template pixel settings.

FIG. 10 is a diagram illustrating an example of template pixel settings in the event that the block size is 4×4 pixels.

FIG. 11 is a diagram illustrating another example of template pixel settings.

FIG. 12 is a flowchart describing encoding processing of the image encoding device in FIG. 2.

FIG. 13 is a flowchart describing the prediction processing of step S21 in FIG. 12.

FIG. 14 is a diagram describing the order of processing in the case of a 16×16 pixel intra prediction mode.

FIG. 15 is a diagram illustrating the types of 4×4 pixel intra prediction modes for luminance signals.

FIG. 16 is a diagram illustrating the types of 4×4 pixel intra prediction modes for luminance signals.

FIG. 17 is a diagram describing the directions of 4×4 pixel intra prediction.

FIG. 18 is a diagram describing 4×4 pixel intra prediction.

FIG. 19 is a diagram describing encoding with 4×4 pixel intra prediction mode for luminance signals.

FIG. 20 is a diagram illustrating the types of 16×16 pixel intra prediction modes for luminance signals.

FIG. 21 is a diagram illustrating the types of 16×16 pixel intra prediction modes for luminance signals.

FIG. 22 is a diagram describing 16×16 pixel intra prediction.

FIG. 23 is a diagram illustrating the types of pixel intra prediction modes for color difference signals.

FIG. 24 is a flowchart describing the intra ediction processing of step S31 in FIG. 13.

FIG. 25 is a flowchart describing the intra motion prediction processing of step S32 in FIG. 13.

FIG. 26 is a flowchart describing the inter template motion prediction processing of step S33 in FIG. 13.

FIG. 27 is a diagram describing the intra template matching method.

FIG. 28 is a flowchart describing the inter template motion prediction processing in step S35 of FIG. 13.

FIG. 29 is a diagram describing the inter template matching method.

FIG. 30 is a flowchart describing the template pixel setting processing in step S61 in FIG. 26 or step S71 in FIG. 28.

FIG. 31 is a diagram describing the advantages of template pixel setting.

FIG. 32 is a block diagram illustrating an embodiment of an image decoding device to which the present invention has been applied.

FIG. 33 is a flowchart describing decoding processing of an image encoding device shown in FIG. 32.

FIG. 34 is a flowchart describing the prediction processing in step S138 in FIG. 33.

FIG. 35 is a diagram illustrating an example of expanded block size.

FIG. 36 is a block diagram illustrating a configuration example of computer hardware.

FIG. 37 is a block diagram illustrating a primary configuration example of a television receiver to which the present invention has been applied.

FIG. 38 is a block diagram illustrating a primary configuration example of a cellular telephone to which the present invention has been applied.

FIG. 39 is a block diagram illustrating a primary configuration example of a hard disk recorder to which the present invention has been applied.

FIG. 40 is a block diagram illustrating a primary configuration example of a camera to which the present invention has been applied.

### DESCRIPTION OF EMBODIMENTS

Embodiments of the present invention will now be described with reference to the drawings.

### Configuration Example of Image Encoding Device

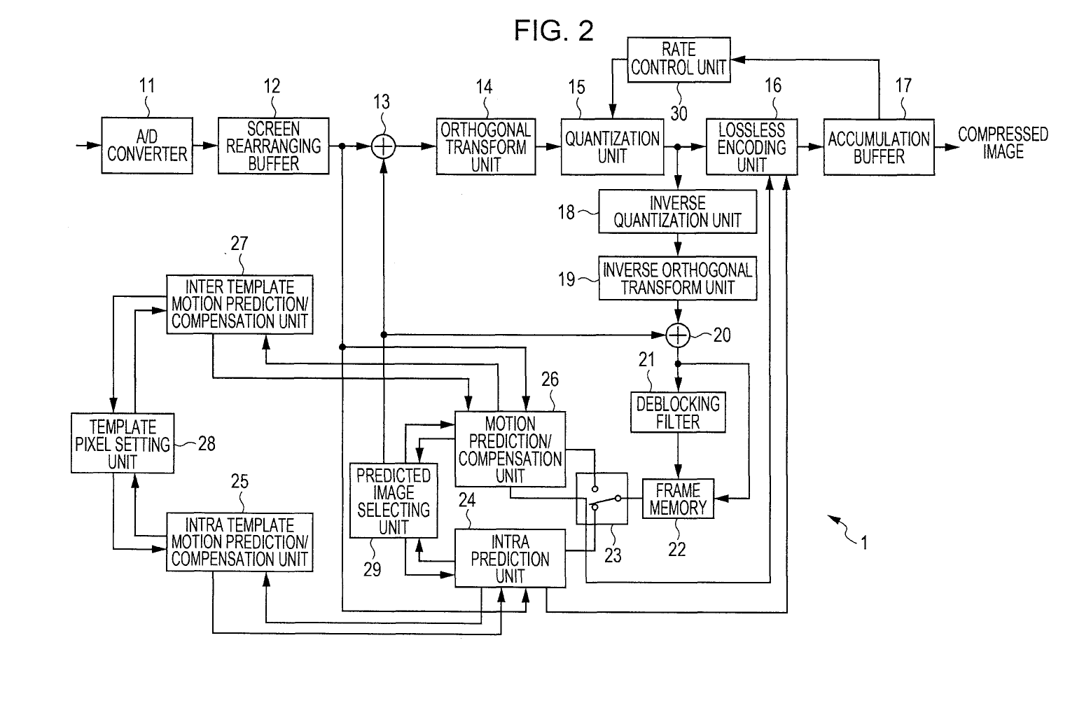

FIG. 2 illustrates the configuration of an embodiment of an image encoding device serving as an image processing device to which the present invention has been applied.

The image encoding device 1 performs compression encoding of images with H.264 and MPEG-4 Part 10 (Advanced Video Coding) (hereinafter written as H.264/AVC) format.

In the example in FIG. 2, the image encoding device 1 includes an A/D converter 11, a screen rearranging buffer 12, a computing unit 13, an orthogonal transform unit 14, a quantization unit 15, a lossless encoding unit 16, an accumulation buffer 17, an inverse quantization unit 18, an inverse orthogonal transform unit 19, a computing unit 20, a deblocking filter 21, a frame memory 22, a switch 23, an intra prediction unit 24, an intra template motion prediction/compensation unit 25, a motion prediction/compensation unit 26, an intra template motion prediction/compensation unit 27, a template pixel setting unit 28, a predicted image selecting unit 29, and a rate control unit 30.

Note that in the following, the intra template motion prediction/compensation unit 25 and the intra template motion prediction/compensation unit 27 will each be called intra TP motion prediction/compensation unit 25 and inter TP motion prediction/compensation unit 27.

The A/D converter 11 performs A/D conversion of input images, and outputs to the screen rearranging buffer 12 so as to be stored. The screen rearranging buffer 12 rearranges the images of frames which are in the order of display stored, in the order of frames for encoding in accordance with the GOP (Group of Picture).

The computing unit 13 subtracts a predicted image from the intra prediction unit 24 or a predicted image from the motion prediction/compensation unit 26, selected by the predicted image selecting unit 29, from the image read out from the screen rearranging buffer 12, and outputs the difference information thereof to the orthogonal transform unit 14. The orthogonal transform unit 14 performs orthogonal transform such as disperse cosine transform, Karhunen-Loève transform, or the like, on the difference information from the computing unit 13, and outputs transform coefficients thereof. The quantization unit 15 quantizes the transform coefficients which the orthogonal transform unit 14 outputs.

The quantized transform coefficients which are output from the quantization unit 15 are input to the lossless encoding unit 16 where they are subjected to lossless encoding such as variable-length encoding, arithmetic encoding, or the like, and compressed.

The lossless encoding unit 16 obtains information indicating intra prediction and intra template prediction from the intra prediction unit 24, and obtains information indicating inter prediction and inter template prediction from the motion prediction/compensation unit 26. Note that the information indicating intra prediction and intra template prediction will also be called intra prediction mode information and intra template prediction mode information hereinafter. Also, the information indicating inter prediction and inter template prediction will also be called inter prediction mode information and inter template prediction mode information hereinafter.

The lossless encoding unit 16 encodes the quantized transform coefficients, and also encodes information indicating intra prediction and intra template prediction, information indicating inter prediction and inter template prediction and so forth, and makes this to be part of header information of the compressed image. The lossless encoding unit 16 supplies the encoded data to the accumulation buffer 17 so as to be accumulated.

For example, with the lossless encoding unit 16, lossless encoding such as variable-length encoding or arithmetic encoding or the like is performed. Examples of variable length encoding include CAVLC (Context-Adaptive Variable Length Coding) stipulated by the H.264/AVC format, and so forth. Examples of arithmetic encoding include CABAC (Context-Adaptive Binary Arithmetic Coding) and so forth.

The accumulation buffer 17 outputs the data supplied from the lossless encoding unit 16 to a downstream unshown recording device or transfer path or the like, for example, as a compressed image encoded by the H.264/AVC format.

Also, the quantized transform coefficients output from the quantization unit 15 are also input to the inverse quantization unit 18 and quantized, and subjected to inverse orthogonal transform at the inverse orthogonal transform unit 19. The output that has been subjected to inverse orthogonal transform is added with a predicted image supplied from the predicted image selecting unit 29 by the computing unit 20, and becomes a locally-decoded image. The deblocking filter 21 removes block noise in the decoded image, which is then supplied to the frame memory 22, and accumulated. The frame memory 22 also receives supply of the image before the deblocking filter processing by the deblocking filter 21, which is accumulated.

The switch 23 outputs a reference image accumulated in the frame memory 22 to the motion prediction/compensation unit 26 or the intra prediction unit 24.

With the image encoding device 1, for example, an I picture, B pictures, and P pictures, from the screen rearranging buffer 12, are supplied to the intra prediction unit 24 as images for intra prediction (also called intra processing). Also, B pictures and P pictures read out from the screen rearranging buffer 12 are supplied to the motion prediction/compensation unit 26 as images for inter prediction (also called inter processing).

The intra prediction unit 24 performs intra prediction processing for all candidate intra prediction modes, based on images for intra prediction read out from the screen rearranging buffer 12 and the reference image supplied from the frame memory 22, and generates a predicted image. Also, the intra prediction unit 24 supplies images read out from the screen rearranging buffer 12 for intra prediction and the reference image supplied from the frame memory 22 via the switch 23, to the intra TP motion prediction/compensation unit 25.

The intra prediction unit 24 calculates a cost function value for all candidate intra prediction modes. The intra prediction unit 24 determines the prediction mode which gives the smallest value of the calculated cost function values and the cost function values for the intra template prediction modes calculated by the intra TP motion prediction/compensation unit 25, to be an optimal intra prediction mode.

The intra prediction unit 24 supplies the predicted image generated in the optimal intra prediction mode and the cost function value thereof to the predicted image selecting unit 29. In the event that the predicted image generated in the optimal intra prediction mode is selected by the predicted image selecting unit 29, the intra prediction unit 24 supplies information relating to the optimal intra prediction mode (intra prediction mode information or intra template prediction mode information) to the lossless encoding unit 16. The lossless encoding unit 16 encodes this information so as to be a part of the header information in the compressed image.

The intra TP motion prediction/compensation unit 25 is input with the images for intra prediction read out from the screen rearranging buffer 12 and the reference image supplied from the frame memory 22. The intra TP motion prediction/compensation unit 25 performs motion prediction and compensation processing of luminance signals in the intra template prediction mode, using these images, and generates a predicted image of luminance signals using a template made of pixels set by the template pixel setting unit 28. The intra TP motion prediction/compensation unit 25 then calculates a cost function value for the intra template prediction mode, and supplies the calculated cost function value and predicted image to the intra prediction unit 24.

The motion prediction/compensation unit 26 performs motion prediction and compensation processing for all candidate inter prediction modes. That is to say, the inter TP motion prediction/compensation unit 26 is supplied with the images for intra prediction read out from the screen rearranging buffer 12 and the reference image supplied from the frame memory 22 via the switch 23. Based on the images for intra prediction and reference image, the inter TP motion prediction/compensation unit 26 detects motion vectors for all candidate inter prediction modes, subjects the reference image to compensation processing based on the motion vectors, and generates a predicted image. Also, the inter TP motion prediction/compensation unit 27 supplies the images for intra prediction read out from the screen rearranging buffer 12 and the reference image supplied from the frame memory 22 to the inter TP motion prediction/compensation unit 27, via the switch 23.

The motion prediction/compensation unit 26 calculates cost function values for all candidate inter prediction modes. The motion prediction/compensation unit 26 determines the prediction mode which gives the smallest value of the cost function values for the inter prediction modes and the cost function values for the inter template prediction modes from the inter TP motion prediction/compensation unit 27, to be an optimal inter prediction mode.

The motion prediction/compensation unit 26 supplies the predicted image generated by the optimal inter prediction mode, and the cost function values thereof, to the predicted image selecting unit 29. In the event that the predicted image generated in the optimal inter prediction mode is selected by the predicted image selecting unit 29, information corresponding to the optimal inter prediction mode (motion vector information, reference frame information, etc.) is output to the lossless encoding unit 16.

Note that if necessary, motion vector information, flag information, reference frame information, and so forth, are also output to the lossless encoding unit 16. The lossless encoding unit 16 subjects also the information from the motion prediction/compensation unit 26 to lossless encoding such as variable-length encoding, arithmetic encoding, or the like, and inserts this to the header portion of the compressed image.

The inter TP motion prediction/compensation unit 27 is input with the images for inter prediction read out from the screen rearranging buffer 12 and the reference image supplied from the frame memory 22. The inter TP motion prediction/compensation unit 27 uses these images to perform motion prediction and compensation processing of the template prediction modes using the template made up of pixels set by the template pixel setting unit 28, and generates a predated image. The inter TP motion prediction/compensation unit 27 calculates cost function values for the inter template prediction modes, and supplies the calculated cost function values and predicted images to the motion prediction/compensation unit 26.

The template pixel setting unit 28 sets pixels in the template for calculating the motion vectors of the block which is the object of intra or inter template prediction mode in accordance with the address within macro block (or sub block) of the object block. The pixel information of the template that has been set is supplied to the intra TP motion prediction/compensation unit 25 or inter TP motion prediction/compensation unit 27.

The predicted image selecting unit 29 determines the optimal prediction mode from the optimal intra prediction mode and optimal inter prediction mode, based on the cost function values output from the intra prediction unit 24 or motion prediction/compensation unit 26. The predicted image selecting unit 29 then selects the predicted image of the optimal prediction mode that has been determined, and supplies this to the computing units 13 and 20. At this time, the predicted image selecting unit 29 supplies the selection information of the predicted image to the intra prediction unit 24 or motion prediction/compensation unit 26.

The rate control unit 30 controls the rate of quantization operations of the quantization unit 15 so that overflow or underflow does not occur, based on the compressed images accumulated in the accumulation buffer 17.

### [Description of H.264/AVC Format]

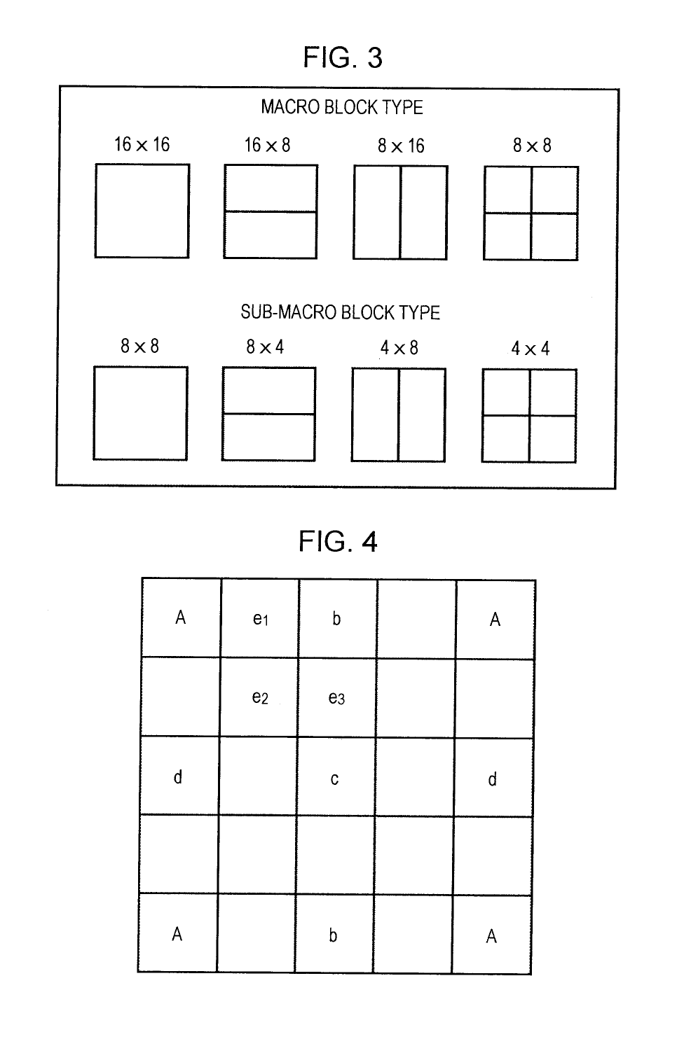

FIG. 3 is a diagram describing examples of block sizes in motion prediction/compensation according to the H.264/AVC format. With the H.264/AVC format, motion prediction/compensation processing is performed with variable block sizes.

Shown at the upper tier in FIG. 3 are macro blocks configured of 16×16 pixels divided into partitions of, from the left, 16×16 pixels, 16×8 pixels, 8×16 pixels, and 8×8 pixels, in that order. Also, shown at the lower tier in FIG. 3 are macro blocks configured of 8×8 pixels divided into partitions of, from the left, 8×8 pixels, 8×4 pixels, 4×8 pixels, and 4×4 pixels, in that order.

That is to say, with the H.264/AVC format, a macro block can be divided into partitions of any one of 16×16 pixels, 16×8 pixels, 8×16 pixels, or 8×8 pixels, with each having independent motion vector information. Also, a partition of 8×8 pixels can be divided into sub-partitions of any one of 8×8 pixels, 8×4 pixels, 4×8 pixels, or 4×4 pixels, with each having independent motion vector information.

FIG. 4 is a diagram for describing prediction/compensation processing of quarter-pixel precision with the H.264/AVC format. With the H.264/AVC format, quarter-pixel precision prediction/compensation processing is performed using 6-tap FIR (Finite Impulse Response Filter) filter.

In the example in FIG. 4, a position A indicates integer-precision pixel positions, positions b, c, and d indicate half-pixel precision positions, and positions e1, e2, and e3 indicate quarter-pixel precision positions. First, in the following Clip( ) is defined as in the following Expression (1).

$$\begin{matrix}[ Math . 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

Note that in the event that the input image is of 8-bit precision, the value of max pix is 255.

The pixel values at positions b and d are generated as with the following Expression (2), using a 6-tap FIR filter.

[Math. 2]

F=A₋₂−5·A₋₁+20·A₀+20·A₁−5·A₂+A₃

b, d=Clip1((F+16)>>5) (2)

The pixel value at the position c is generated as with the following Expression (3), using a 6-tap FIR filter in the horizontal direction and vertical direction.

[Math. 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512) [symbol] 10) (3)

Note that Clip processing is performed just once at the end, following having performed product-sum processing in both the horizontal direction and vertical direction.

The positions e1 through e3 are generated by linear interpolation as with the following Expression (4).

[Math. 4]

e₁=(A+b+1)>>1

e₂=(b+d+1)>>1

e₃=(b+c+1)>>1 (4)

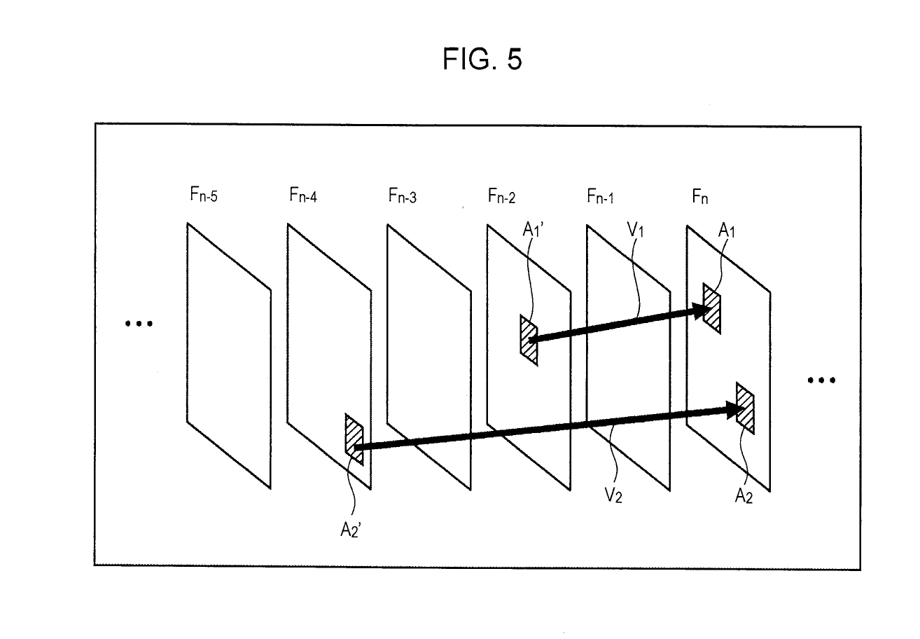

FIG. 5 is a drawing describing motion prediction/compensation processing of multi-reference frames in the H.264/AVC format. The H.264/AVC format stipulates the motion prediction/compensation method of multi-reference frames (Multi-Reference Frame).

In the example in FIG. 5, an object frame Fn to be encoded from now, and already-encoded frames Fn-5, . . . , Fn-1, are shown. The frame Fn-1 is a frame one before the object frame Fn, the frame Fn-2 is a frame two before the object frame Fn, and the frame Fn-3 is a frame three before the object frame Fn. Also, the frame Fn-4 is a frame four before the object frame Fn, and the frame Fn-5 is a frame five before the object frame Fn. Generally, the closer the frame is to the object frame on the temporal axis, the smaller the attached reference picture No. (ref_id) is. That is to say, the reference picture No. is smallest for frame fn-1, and thereafter the reference picture No. is smaller in the order of Fn-2, . . . , Fn-5.

Block A1 and block A2 are displayed in the object frame Fn, with a motion vector V1 having been found due to correlation with a block A1′ in the frame Fn-2 two back. Also, a motion vector V2 has been found for block A2 due to correlation with a block A1′ in the frame Fn-4 four back.

As described above, with the H.264/AVC format, multiple reference frames are stored in memory, and different reference frames can be referred to for one frame (picture). That is to say, each block in one picture can have independent reference frame information (reference picture No. (ref_id)), such as block A1 referring to frame Fn-2, block A2 referring to frame Fn-4, and so on, for example.

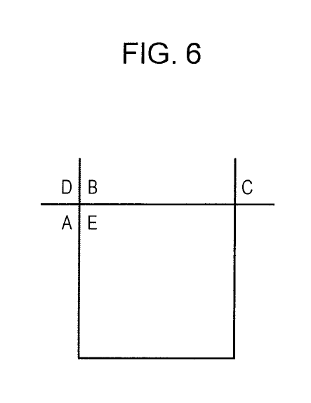

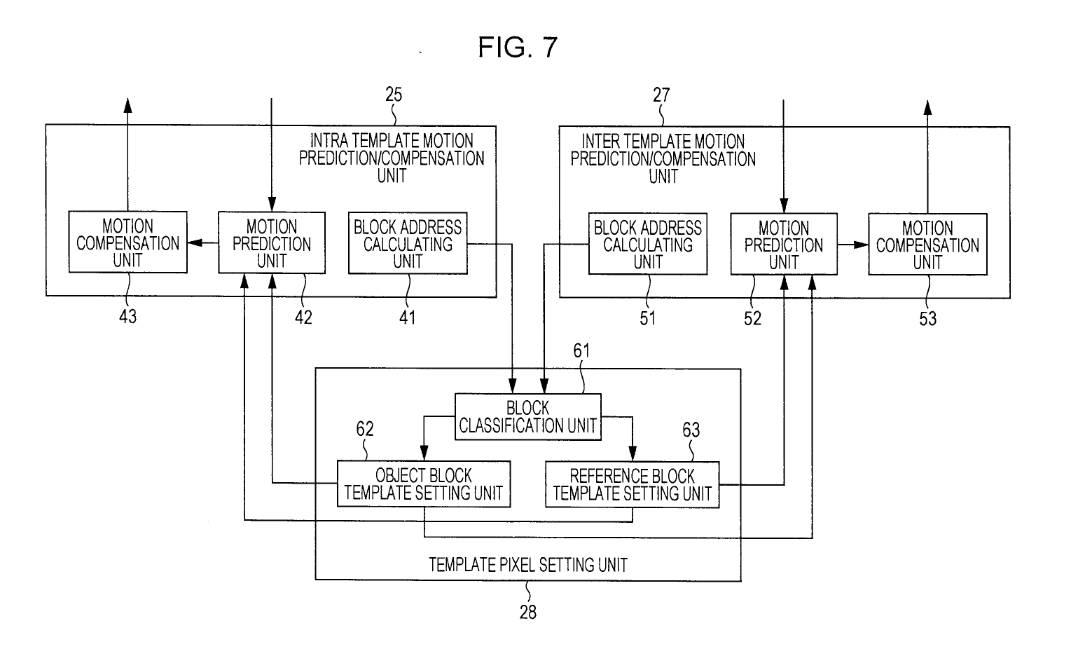

With the H.264/AVC format, motion prediction/compensation processing is performed as described above with reference to FIG. 2 through FIG. 5, resulting in massive motion vector information being generated, which has led to deterioration in encoding efficiency if this is encoded as it is. In contrast, with the H.264/AVC format, reduction in the encoded information of motion vectors is realized with the method shown in FIG. 6.

FIG. 6 is a diagram describing a motion vector information generating method with the H.264/AVC format. The example in FIG. 6 shows an object block E to be encoded from now (e.g., 16×16 pixels), and blocks A through D which have already been encoded and are adjacent to the object block E.

That is to say, the block D is situated adjacent to the upper left of the object block E, the block B is situated adjacent above the object block E, the block C is situated adjacent to the upper right of the object block E, and the block A is situated adjacent to the left of the object block E. Note that the reason why blocks A through D are not sectioned off is to express that they are blocks of one of the configurations of 16×16 pixels through 4×4 pixels, described above with FIG. 3.

For example, let us express motion vector information as to X (=A, B, C, D, E) as mvₓ. First, prediction motion vector information (prediction value of motion vector) pmv_{E} as to the object block E is generated as shown in the following Expression (5), using motion vector information relating to the blocks A, B, and C.

pmv_{E}=med(mv_{A}, mv_{B}, mv_{C}) (5)

In the event that the motion vector information relating to the block C is not available (is unavailable) due to a reason such as being at the edge of the image frame, or not being encoded yet, the motion vector information relating to the block D is substituted instead of the motion vector information relating to the block C.

Data mvd_{E} to be added to the header portion of the compressed image, as motion vector information as to the object block E, is generated as shown in the following Expression (6), using pmv_{E}.

mvd_{E}=mv_{E}−pmv_{E} (6)

Note that in actual practice, processing is performed independently for each component of the horizontal direction and vertical direction of the motion vector information.

Thus, motion vector information can be reduced by generating prediction motion vector information, and adding the difference between the prediction motion vector information generated from correlation with adjacent blocks and the motion vector information to the header portion of the compressed image.

Now, even with median prediction, the percentage of motion vector information in the image compression information is not small. Accordingly, with the image encoding device 1, templates which are adjacent to the region of the image to be encoded with a predetermined positional relation and are also part of the decoded image are used, so motion prediction compensation processing is also performed for template prediction modes regarding which motion vectors do not need to be sent to the decoding side. At this time, pixels to be used for the templates are set at the image encoding device 1.

### Detailed Configuration Example of Each Part

FIG. 7 is a block diagram illustrating the detailed configuration of each part performing processing relating to the template prediction modes described above. The example in FIG. 7 shows the detailed configuration of the intra TP motion prediction/compensation unit 25, inter TP motion prediction/compensation unit 27, and template pixel setting unit 28.

In the case of the example in FIG. 7, the intra TP motion prediction/compensation unit 25 is configured of a block address calculating unit 41, motion prediction unit 42, and motion compensation unit 43. The block address calculating unit 41 calculates, for an object block to be encoded, addresses within a macro block thereof, and supplies the calculated address information to a block classifying unit 61.

The motion prediction unit 42 is input with images for intra prediction read out from the screen rearranging buffer 12 and reference images supplied from the frame memory 22. The motion prediction unit 42 is also input with reference blocks and reference block template information, set by an object block template setting unit 62 and reference block template setting unit 63.

The motion prediction unit 42 uses the images for intra prediction and reference images to perform intra template prediction mode motion prediction, using the object block and reference block template pixel values set by the object block template setting unit 62 and reference block template setting unit 63. At this time, the calculated motion vectors and reference images are supplied to the motion compensation unit 43.

The motion compensation unit 43 uses the motion vectors and reference images calculated by the motion prediction unit 42 to perform motion compensation processing and generate a predicted image. Further, the motion compensation unit 43 calculates a cost function value for the intra template prediction mode, and supplies the calculated cost function value and predicted image to the intra prediction unit 24.

The inter TP motion prediction/compensation unit 27 is configured of a block address calculation unit 51, motion prediction unit 52, and motion compensation unit 53. The block address calculation unit 51 calculates, for an object block to be encoded, addresses within a macro block thereof, and supplies the calculated address information to the block classifying unit 61.

The motion prediction unit 52 is input with images for inter prediction read out from the screen rearranging buffer 12 and reference images supplied from the frame memory 22. The motion prediction unit 52 is also input with reference blocks and reference block template information, set by the object block template setting unit 62 and reference block template setting unit 63.

The motion prediction unit 52 uses the images for inter prediction and reference images to perform inter template prediction mode motion prediction, using the reference block and reference block template pixel values set by the object block template setting unit 62 and reference block template setting unit 63. At this time, the calculated motion vectors and reference images are supplied to the motion compensation unit 53.

The motion compensation unit 53 uses the motion vectors and reference images calculated by the motion prediction unit 52 to perform motion compensation processing and generate a predicted image. Further, the motion compensation unit 53 calculates a cost function value for the inter template prediction mode, and supplies the calculated cost function value and predicted image to the motion prediction/compensation unit 26.

The template pixel setting unit 28 is configured of the block classifying unit 61, object block template setting unit 62, and reference block template setting unit 63. Note that hereinafter, the object block template setting unit 62 and reference block template setting unit 63 will be referred to as object block TP setting unit 62 and reference block TP setting unit 63, respectively.

The block classifying unit 61 classifies which block an object block to be processed by an intra or inter template prediction mode is; a block at the upper left within the macro block, a block at the upper right, a block at the lower left, or a block at the lower right. The block classifying unit 61 supplies information regarding which block the object block is, to the object block TP setting unit 62 and reference block TP setting unit 63.

The object block TP setting unit 62 performs setting of pixels making up a template, in accordance with which position the position of the object block within the macro block is. Information of the template in the object block that has been set is supplied to the motion prediction unit 42 or the motion prediction unit 52.

The reference block TP setting unit 63 performs setting of pixels making up a template, in accordance with which position the position of the object block within the macro block is. That is to say, the reference block TP setting unit 63 sets pixels at the same positions in the object block to pixels making up the template for the reference block. Information of the template in the object block that has been set is supplied to the motion prediction unit 42 or the motion prediction unit 52.

### Example of Template Pixel Setting Processing

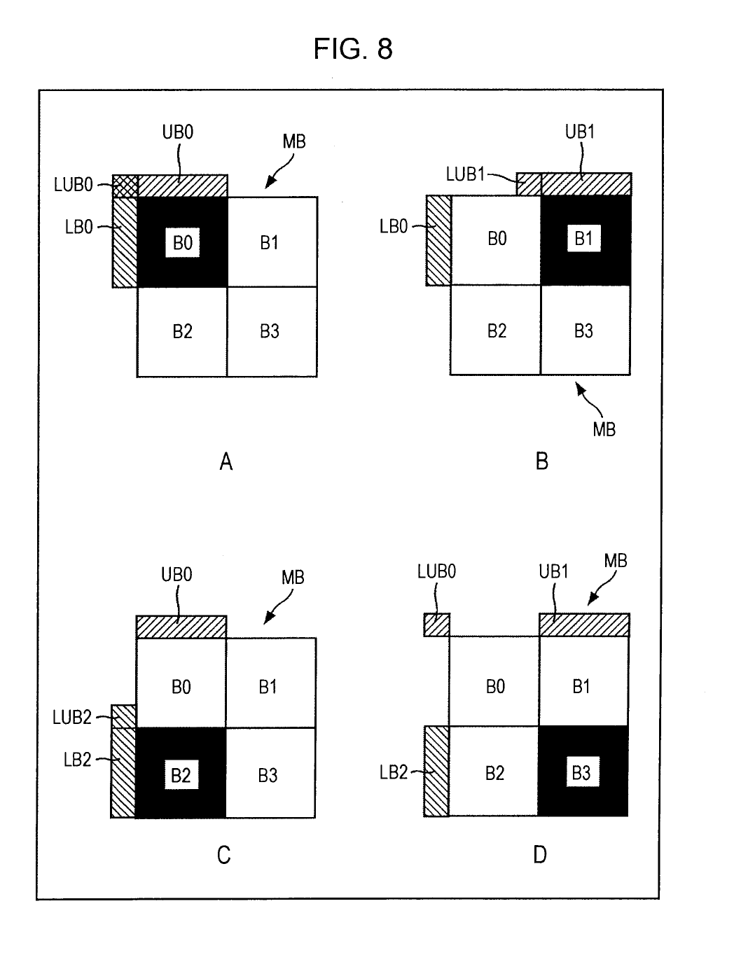

A in FIG. 8 through D in FIG. 8 illustrate examples of templates according to the position of the object block within the macro block. In the case of the examples in A in FIG. 8 through D in FIG. 8, a macro block MB of 16×16 pixels is shown, with the macro block MB being made up of four blocks, B0 through B3 each made up of 8×8 pixels. Also, in this example, the processing is performed in the order of blocks B0 through B3, i.e., in raster scan order.

Block B0 is a block situated at the upper left within the macro block MB, and block B1 is a block situated at the upper right within the macro block MB. Also, block B2 is a block situated at the lower left within the macro block MB, and block B3 is a block situated at the lower right within the macro block MB.

That is to say, A in FIG. 8 illustrates an example in the case of a template where the object block is block B0. B in FIG. 8 illustrates an example in the case of a template where the object block is block B1. C in FIG. 8 illustrates an example in the case of a template where the object block is block B2. D in FIG. 8 illustrates an example in the case of a template where the object block is block B3.

The block classifying unit 61 classifies at which position within the macro block MB an object block to be processed by an intra or inter template prediction mode is, i.e., which block of blocks B0 through B3.

The object block TP setting unit 62 and reference block TP setting unit 63 set pixels making up each of a template corresponding to the object block and reference block, according to which position in the macro block MB the object block is (which block it is).

That is, in the event that the object block is the block B0, pixels UB0, pixel LUB0, and pixels LB0, adjacent to the upper portion, upper left portion, and left portion of the object block, respectively, are set as a template, as shown in A in FIG. 8. The pixel values of the template configured of the pixels UB0, pixel LUB0, and pixels LB0, that have been set, are then used for matching.

In the event that the object block is the block B1, pixels UB1 and pixel LUB1, adjacent to the upper portion and upper left portion of the object block, respectively, and pixels LB0 adjacent to the left portion of the block B0, are set as a template, as shown in B in FIG. 8. The pixel values of the template configured of the pixels UB1, pixel LUB1, and pixels LB0, that have been set, are then used for matching.

In the event that the object block is the block B2, pixel LUB2 and pixels LB2, adjacent to the upper left portion and left portion of the object block, respectively, and pixels UB0 adjacent to the upper portion of the block B0, are set as a template, as shown in C in FIG. 8. The pixel values of the template configured of the pixels UB0, pixel LUB2, and pixels LB2, that have been set, are then used for matching.

In the event that the object block is the block B3, pixel LUB0 adjacent to the upper left portion of the block B0, pixels UB1 adjacent to the upper portion of the block B1, and pixels LB2 adjacent to the left portion of the block B2, are set as a template, as shown in D in FIG. 8. The pixel values of the template configured of the pixels UB1, pixel LUB0, and pixels LB2, that have been set, are then used for matching.

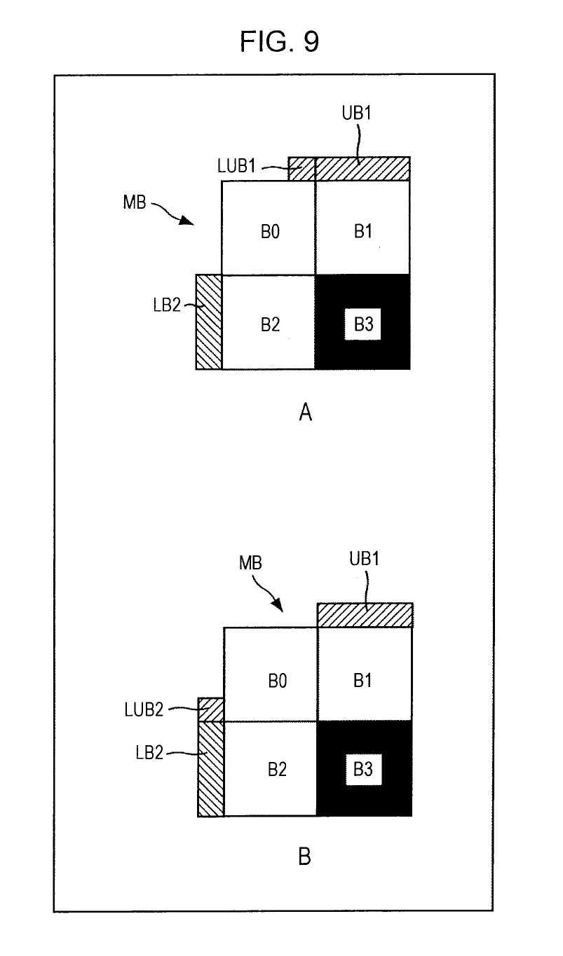

Note that in the event that the object block is the block B3, the template shown in A in FIG. 9 or in B in FIG. 9 may be used, not restricted to the example of the template in D in FIG. 8.

That is to say, in the event that the object block is the block B3, pixel LUB1 adjacent to the upper left portion of the block B1 and pixels UB1 adjacent to the upper portion thereof, and pixels LB2 adjacent to the left portion of the block B2, are set as a template, as shown in A in FIG. 9. The pixel values of the template configured of the pixels UB1, pixel LUB1, and pixels LB2, that have been set, are then used for matching.

Alternatively, in the event that the object block is the block B3, pixels UB1 adjacent to the upper portion of the block B1, and pixel LUB2 adjacent to the upper left portion of the block B2 and pixels LB2 adjacent to the left portion thereof, are set as a template, as shown in B in FIG. 9. The pixel values of the template configured of the pixels UB1, pixel LUB2, and pixels LB2, that have been set, are then used for matching.

Now, the pixels UB0, pixel LUB0, pixels LB0, pixel LUB1, pixels UB1, pixel LUB2, and pixels LB2, are each pixels adjacent to the macro block MB with a predetermined positional relation.

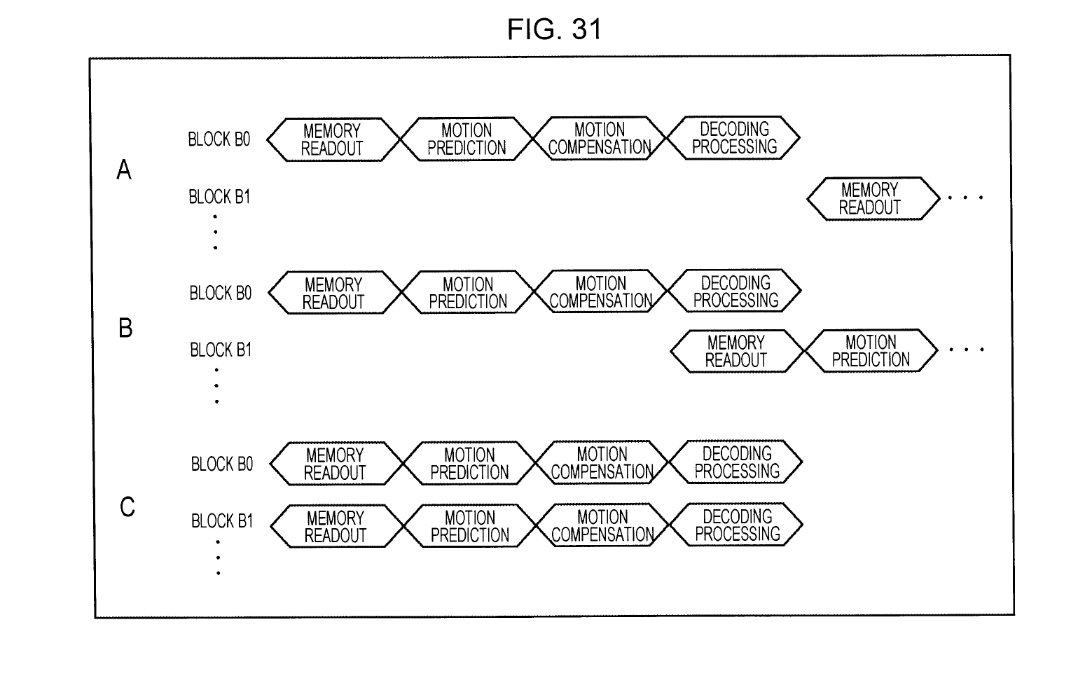

Thus, by constantly using pixels adjacent to the macro block of the object block for pixels making up the template, the processing as to the blocks B0 through B3 within the macro block MB can be realized by parallel processing or pipeline processing. Details of the advantages thereof will be described later with reference to A in FIG. 31 through C in FIG. 31.

### Other Example of Template Pixel Setting Processing

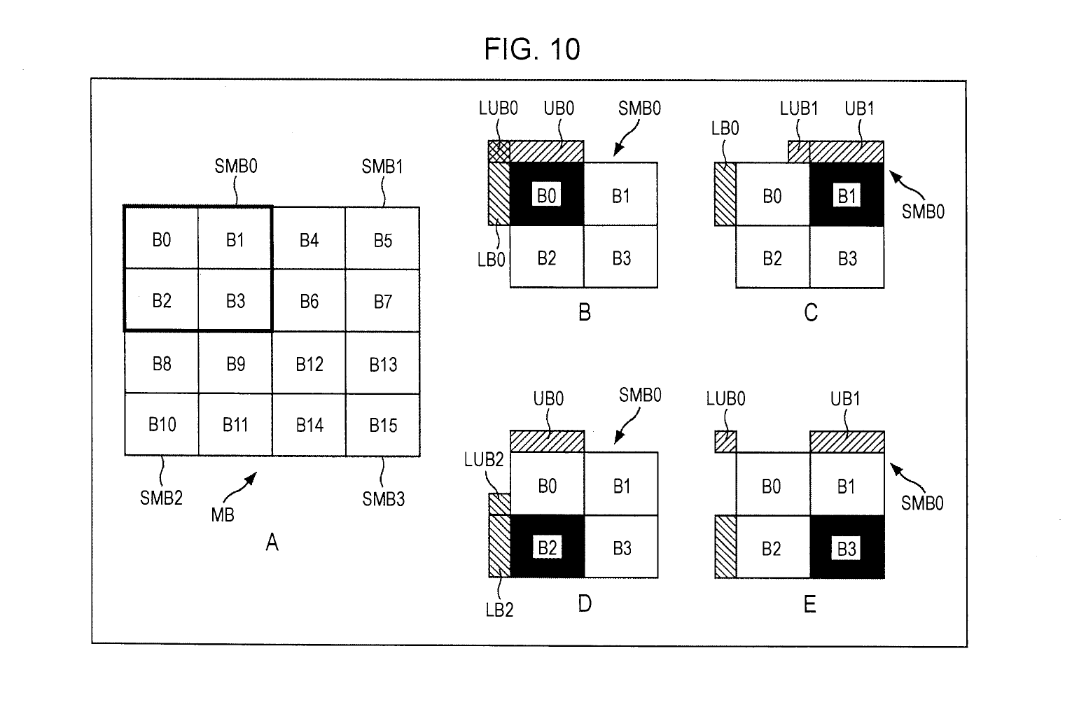

A in FIG. 10 through E in FIG. 10 illustrate examples of templates in the event that the block size is 4×4. In the case of the example in A in FIG. 10, a macro block MB of 16×16 pixels is shown, with the macro block MB being made up of 16 blocks, B0 through B15 each made up of 4×4 pixels. Of these, a sub-macro block SMB0 is configured of blocks B0 through B3, a sub-macro block SMB1 is configured of blocks B4 through B7. Also, a sub-macro block SMB2 is configured of blocks B8 through B11, and a sub-macro block SMB3 is configured of blocks B12 through B15.

Note that the processing at block B0, block B4, block B8, and block B12 is basically the same processing, and the processing at block B1, block B5, block B9, and block B13 is basically the same processing. The processing at block B2, block B6, block B10, and block B14 is basically the same processing, and the processing at block B3, block B7, block B11, and block B15 is basically the same processing. Accordingly, in the following, the 8×8 pixel sub-macro block SMB0 configured of the blocks B0 through B3 will be described as an example.

That is, B in FIG. 10 illustrates an example of a template in a case where the object block within the sub-macro block SMB0 is the block B0. C in FIG. 10 illustrates an example of a template in a case where the object block within the sub-macro block SMB0 is the block B1. D in FIG. 10 illustrates an example of a template in a case where the object block within the sub-macro block SMB0 is the block B2. E in FIG. 10 illustrates an example of a template in a case where the object block within the sub-macro block SMB0 is the block B3.

Now, description will be made in raster scan order, which is the order of processing. In the event that the object block is the block B0, pixels UB0, pixel LUB0, and pixels LB0, adjacent to the upper portion, upper left portion, and left portion of the object block, respectively, are set as a template, as shown in B in FIG. 10. The pixel values of the template configured of the pixels UB0, pixel LUB0, and pixels LB0, that have been set, are then used for matching.

In the event that the object block is the block B1, pixels UB1 and pixel LUB1, adjacent to the upper portion and upper left portion of the object block, respectively, and pixels LB0 adjacent to the left portion of the block B0, are set as a template, as shown in C in FIG. 10. The pixel values of the template configured of the pixels UB1, pixel LUB1, and pixels LB0, that have been set, are then used for matching.

In the event that the object block is the block B2, pixel LUB2 and pixels LB2, adjacent to the upper left portion and left portion of the object block, respectively, and pixels UB0 adjacent to the upper portion of the block B0, are set as a template, as shown in D in FIG. 10. The pixel values of the template configured of the pixels UB0, pixel LUB2, and pixels LB2, that have been set, are then used for matching.

In the event that the object block is the block B3, pixel LUB0 adjacent to the upper left portion of the block B0, pixels UB1 adjacent to the upper portion of the block B1, and pixels LB2 adjacent to the left portion of the block B2, are set as a template, as shown in E in FIG. 10. The pixel values of the template configured of the pixels UB1, pixel LUB0, and pixels LB2, that have been set, are then used for matching.

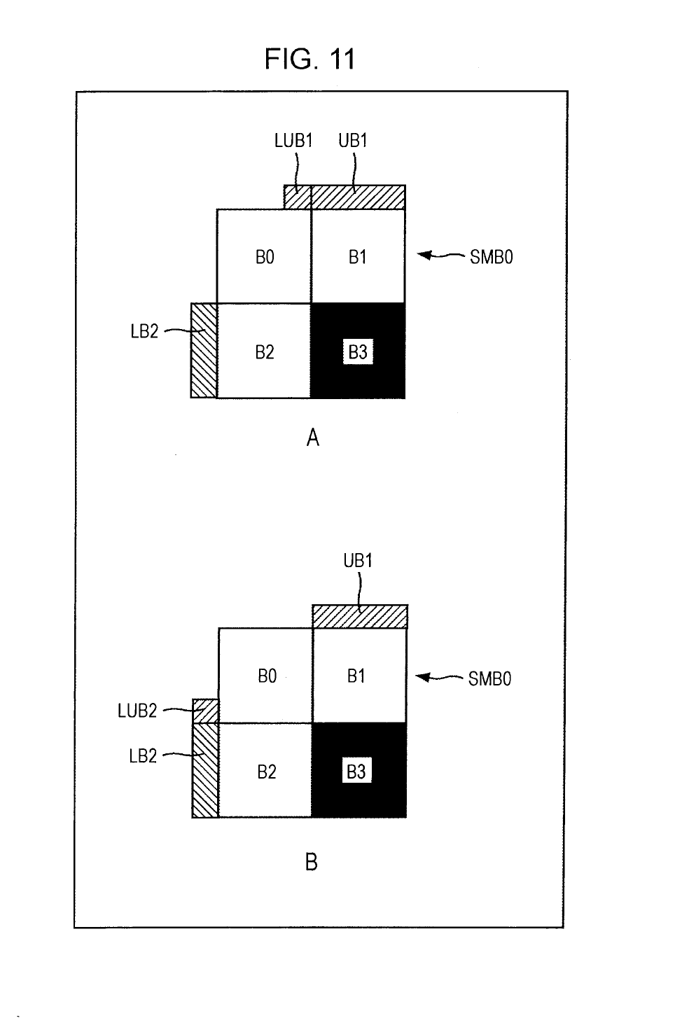

Note that in the event that the object block is the block B3, the template shown in A in FIG. 11 or in B in FIG. 11 may be used, not restricted to the example of the template in E in FIG. 10.

That is to say, in the event that the object block is the block B3, pixel LUB1 adjacent to the upper left portion of the block B1 and pixels UB1 adjacent to the upper portion thereof, and pixels LB2 adjacent to the left portion of the block B2, are set as a template, as shown in A in FIG. 11. The pixel values of the template configured of the pixels UB1, pixel LUB1, and pixels LB2, that have been set, are then used for matching.

Alternatively, in the event that the object block is the block B3, pixels UB1 adjacent to the upper portion of the block B1, and pixel LUB2 adjacent to the upper left portion of the block B2 and pixels LB2 adjacent to the left portion thereof, are set as a template, as shown in B in FIG. 11. The pixel values of the template configured of the pixels UB1, pixel LUB2, and pixels LB2, that have been set, are then used for matching.

Now, the pixels UB0, pixel LUB0, pixels LB0, pixel LUB1, pixels UB1, pixel LUB2, and pixels LB2, are each pixels adjacent to the sub-macro block SMB0 with a predetermined positional relation.

Thus, by constantly using pixels adjacent to the macro block of the object block for pixels making up the template, the processing as to the blocks B0 through B3 within the sub-macro block SMB0 can be realized by parallel processing or pipeline processing.

### [Description of Encoding Processing]

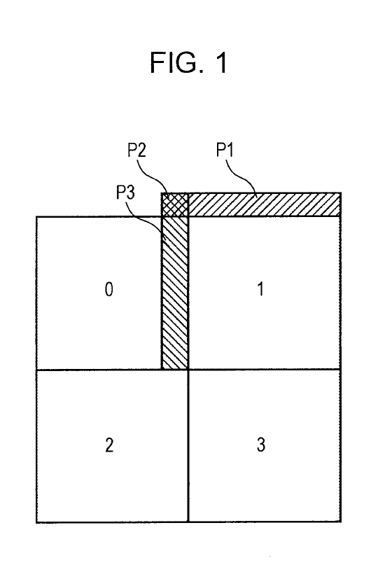

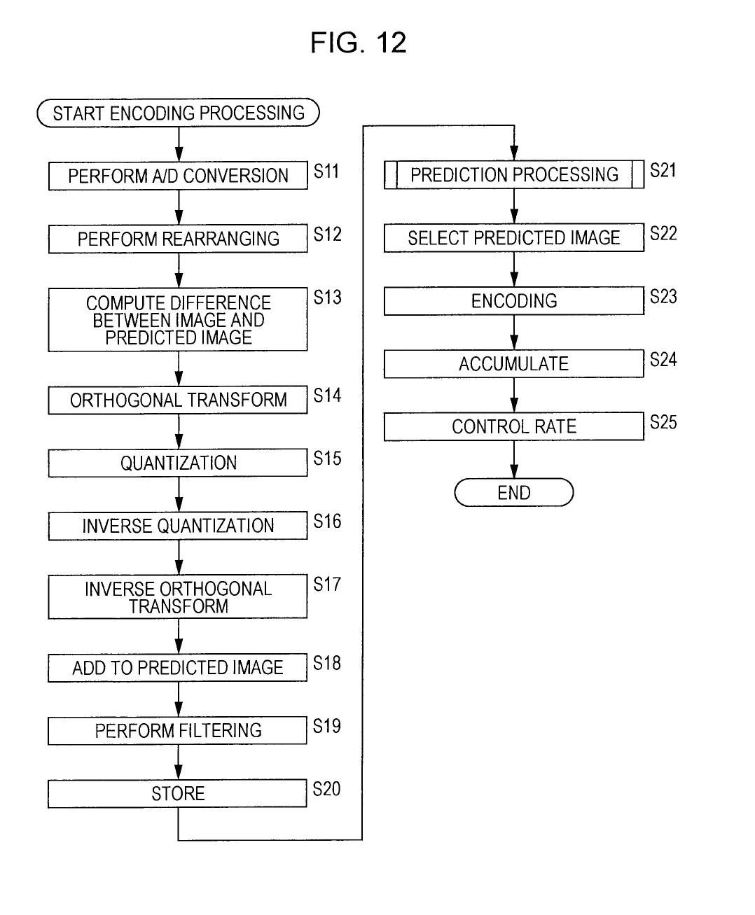

Next, the encoding processing of the image encoding device 1 in FIG. 1 will be described with reference to the flowchart in FIG. 12.

In step S11, the A/D converter 11 performs A/D conversion of an input image. In step S12, the screen rearranging buffer 12 stores the image supplied from the A/D converter 11, and performs rearranged of the pictures from the display order to the encoding order.

In step S13, the computing unit 13 computes the difference between the image rearranged in step S12 and a prediction image. The prediction image is supplied from the motion prediction/compensation unit 26 in the case of performing inter prediction, and from the intra prediction unit 24 in the case of performing intra prediction, to the computing unit 13 via the predicted image selecting unit 29.

The amount of data of the difference data is smaller in comparison to that of the original image data. Accordingly, the data amount can be compressed as compared to a case of performing encoding of the image as it is.

In step S14, the orthogonal transform unit 14 performs orthogonal transform of the difference information supplied from the computing unit 13. Specifically, orthogonal transform such as disperse cosine transform, Karhunen-Loève transform, or the like, is performed, and transform coefficients are output. In step S15, the quantization unit 15 performs quantization of the transform coefficients. The rate is controlled for this quantization, as described with the processing in step S25 described later.

The difference information quantized as described above is locally decoded as follows. That is to say, in step S16, the inverse quantization unit 18 performs inverse quantization of the transform coefficients quantized by the quantization unit 15, with properties corresponding to the properties of the quantization unit 15. In step S17, the inverse orthogonal transform unit 19 performs inverse orthogonal transform of the transform coefficients subjected to inverse quantization at the inverse quantization unit 18, with properties corresponding to the properties of the orthogonal transform unit 14.

In step S18, the computing unit 20 adds the predicted image input via the predicted image selecting unit 29 to the locally decoded difference information, and generates a locally decoded image (image corresponding to the input to the computing unit 13). In step S19, the deblocking filter 21 performs filtering of the image output from the computing unit 20. Accordingly, block noise is removed. In step S20, the frame memory 22 stores the filtered image. Note that the image not subjected to filter processing by the deblocking filter 21 is also supplied to the frame memory 22 from the computing unit 20, and stored.

In step S21, the intra prediction unit 24, intra TP motion prediction/compensation unit 25, motion prediction/compensation unit 26, and inter TP motion prediction/compensation unit 27 perform their respective image prediction processing. That is to say, in step S21, the intra prediction unit 24 performs intra prediction processing in the intra prediction mode, and the intra TP motion prediction/compensation unit 25 performs motion prediction/compensation processing in the intra template prediction mode. Also, the motion prediction/compensation unit 26 performs motion prediction/compensation processing in the inter prediction mode, and the and inter TP motion prediction/compensation unit 27 performs motion prediction/compensation processing in the inter template prediction mode. Note that at this time, with the intra TP motion prediction/compensation unit 25 and the inter TP motion prediction/compensation unit 27, templates set by the template pixel setting unit 28 are used.

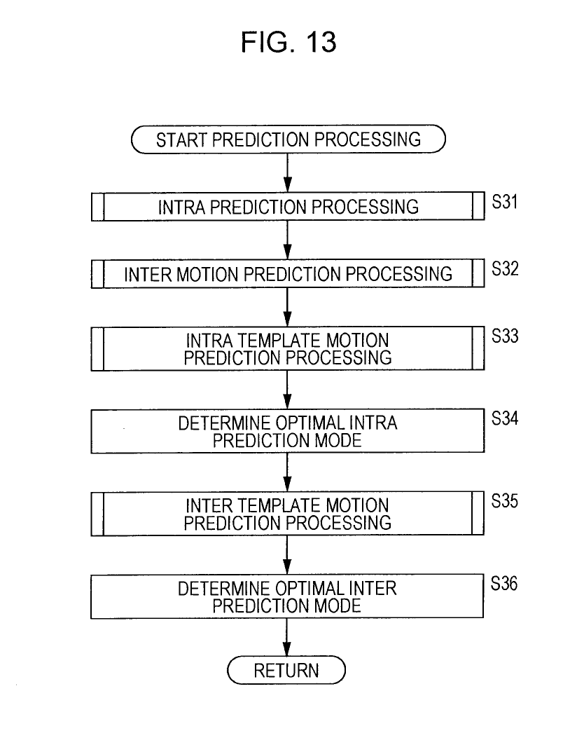

While the details of the prediction processing in step S21 will be described later in detail with reference to FIG. 13, with this processing, prediction processing is performed in each of all candidate prediction modes, and cost function values are each calculated in all candidate prediction modes. An optimal intra prediction mode is then selected based on the calculated cost function value, and the predicted image generated by the intra prediction in the optimal intra prediction mode and the cost function value are supplied to the predicted image selecting unit 29. Also, an optimal inter prediction mode is determined from the inter prediction mode and inter template prediction mode based on the calculated cost function value, and the predicted image generated with the optimal inter prediction mode and the cost function value thereof are supplied to the predicted image selecting unit 29.

In step S22, the predicted image selecting unit 29 determines one of the optimal intra prediction mode and optimal inter prediction mode as the optimal prediction mode, based on the respective cost function values output from the intra prediction unit 24 and the motion prediction/compensation unit 26. The predicted image selecting unit 29 then selects the predicted image of the determined optimal prediction mode, and supplies this to the computing units 13 and 20. The predicted image is used for computation in steps S13 and S18, as described above.

Note that the selection information of the predicted image is supplied to the intra prediction unit 24 or motion prediction/compensation unit 26. In the event that the predicted image of the optimal intra prediction mode is selected, the intra prediction unit 24 supplies information relating to the optimal intra prediction mode (i.e., intra mode information or intra template prediction mode information) to the lossless encoding unit 16.

In the event that the predicted image of the optimal inter prediction mode is selected, the motion prediction/compensation unit 26 outputs information relating to the optimal inter prediction mode, and information corresponding to the optimal inter prediction mode as necessary, to the lossless encoding unit 16. Examples of information corresponding to the optimal inter prediction mode include motion vector information, flag information, reference frame information, etc. More specifically, in the event that the predicted image with the inter prediction mode is selected as the optimal inter prediction mode, the motion prediction/compensation unit 26 outputs inter prediction mode information, motion vector information, and reference frame information, to the lossless encoding unit 16.

On the other hand, in the event that a prediction image with the inter template prediction mode is selected as the optimal inter prediction mode, the motion prediction/compensation unit 26 outputs inter template prediction mode information to the lossless encoding unit 16. That is to say, in the case of encoding with inter template prediction mode information, motion vector information and the like does not have to be sent to the decoding side, and accordingly is not output to the lossless encoding unit 16. Accordingly, the motion vector information in the compressed image can be reduced.

In step S23, the lossless encoding unit 16 encodes the quantized transform coefficients output from the quantization unit 15. That is to say, the difference image is subjected to lossless encoding such as variable-length encoding, arithmetic encoding, or the like, and compressed. At this time, the information relating to the optimal intra prediction mode from the intra prediction unit 24 or the information relating to the optimal inter prediction mode form the motion prediction/compensation unit 26 and so forth, input to the lossless encoding unit 16 in step S22, also is encoded and added to the header information.

In step S24, the accumulation buffer 17 accumulates the difference image as a compressed image. The compressed image accumulated in the accumulation buffer 17 is read out as appropriate, and transmitted to the decoding side via the transmission path.

In step S25, the rate control unit 30 controls the rate of quantization operations of the quantization unit 15 so that overflow or underflow does not occur, based on the compressed images accumulated in the accumulation buffer 17.

### [Description of Prediction Processing]

Next, the prediction processing in step S21 of FIG. 12 will be described with reference to the flowchart in FIG. 13.

In the event that the image to be processed that is supplied from the screen rearranging buffer 12 is a block image for intra processing, a decoded image to be referenced is read out from the frame memory 22, and supplied to the intra prediction unit 24 via the switch 23. Based on these images, in step S31 the intra prediction unit 24 performs intra prediction of pixels of the block to be processed for all candidate prediction modes. Note that for decoded pixels to be referenced, pixels not subjected to deblocking filtering by the deblocking filter 21 are used.

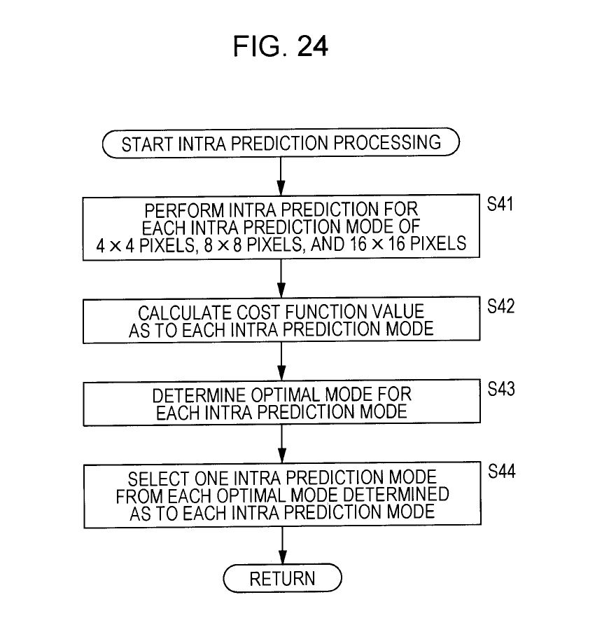

While the details of the intra prediction processing in step S31 will be described later with reference to FIG. 24, due to this processing, intra prediction is performed in all candidate intra prediction modes, and cost function values are calculated for all candidate intra prediction modes. One intra prediction mode is then selected from all intra prediction modes as the optimal one, based on the calculated cost function values.

In the event that the image to be processed that is supplied from the screen rearranging buffer 12 is an image for inter processing, the image to be referenced is read out from the frame memory 22, and supplied to the motion prediction/compensation unit 26 via the switch 23. In step S32, the motion prediction/compensation unit 26 performs motion prediction/compensation processing based on these images. That is to say, the motion prediction/compensation unit 26 references the image supplied from the frame memory 22 and performs motion prediction processing for all candidate inter prediction modes.

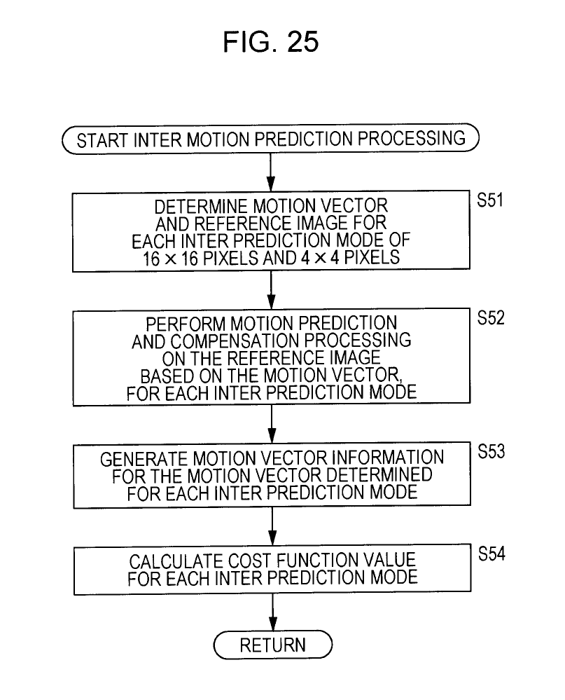

While details of the inter motion prediction processing in step S32 will be described later with reference to FIG. 25, due to this processing, prediction processing is performed for all candidate inter prediction modes, and cost function values are calculated for all candidate inter prediction modes.

Also, in the event that the image to be processed that is supplied from the screen rearranging buffer 12 is a block image for inter processing, the image to be referenced is read out from the frame memory 22, and also supplied to the intra TP motion prediction/compensation unit 25 via the intra prediction unit 24. In step S33, the intra TP motion prediction/compensation unit 25 performs intra template motion prediction processing in the intra template prediction mode.

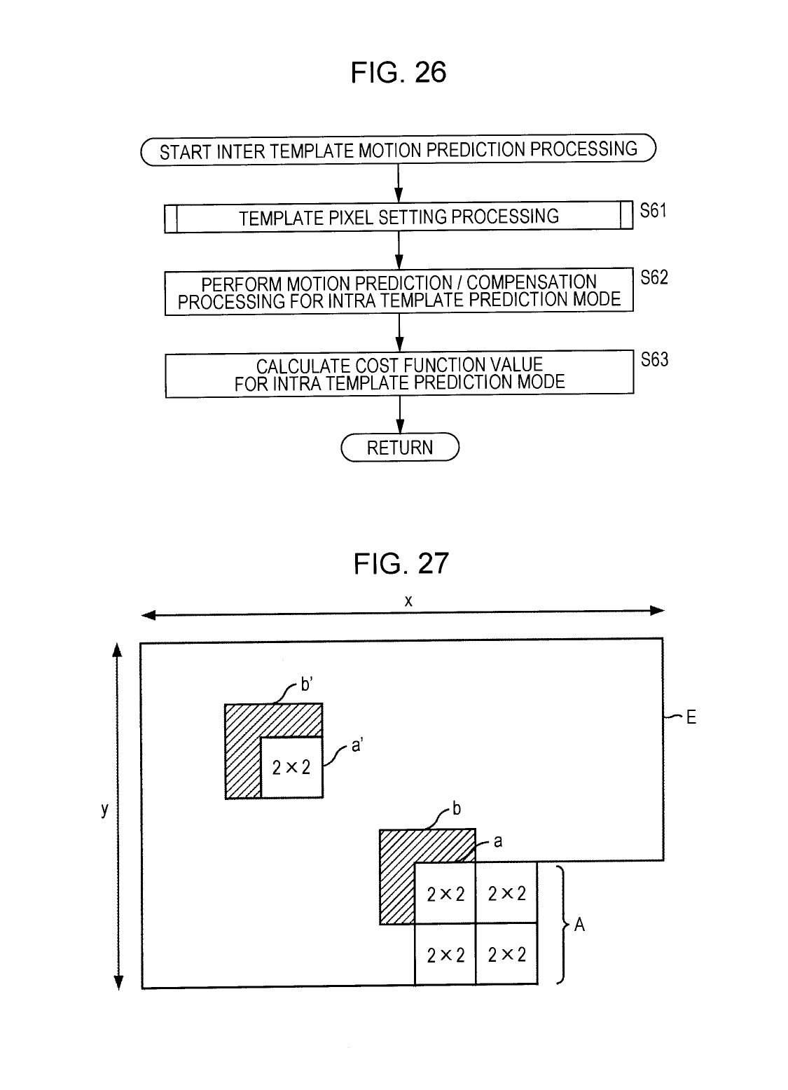

While the details of the intra template motion prediction processing in step S33 will be described later with reference to FIG. 26, due to this processing, motion prediction processing is performed in the intra template prediction mode, and cost function values are calculated as to the intra template prediction mode. The predicted image generated by the motion prediction processing for the intra template prediction mode, and the cost function value thereof are then supplied to the intra prediction unit 24.

In step S34, the intra prediction unit 24 compares the cost function value as to the intra prediction mode selected in step S31 and the cost function value as to the intra template prediction mode selected in step S33. The intra prediction unit 24 then determines the prediction mode which gives the smallest value to be the optimal intra prediction mode, and supplies the predicted image generated in the optimal intra prediction mode and the cost function value thereof to the predicted image selecting unit 29.

Further, in the event that the image to be processed that is supplied from the screen rearranging buffer 12 is an image for inter processing, the image to be referenced is read out from the frame memory 22, and supplied to the inter TP motion prediction/compensation unit 27 via the switch 23 and the motion prediction/compensation unit 26. Based on these images, the inter TP motion prediction/compensation unit 27 performs inter template motion prediction processing in the inter template prediction mode in step S35.

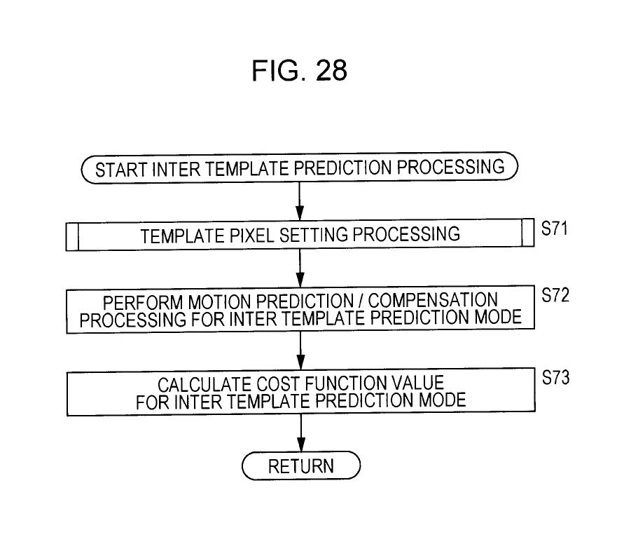

While details of the inter template motion prediction processing in step S35 will be described later with reference to FIG. 28, due to this processing, motion prediction processing is performed in the inter template prediction mode, and cost function values as to the inter template prediction mode are calculated. The predicted image generated by the motion prediction processing in the inter template prediction mode and the cost function value thereof are then supplied to the motion prediction/compensation unit 26.

In step S36, the motion prediction/compensation unit 26 compares the cost function value as to the optimal inter prediction mode selected in step S32 with the cost function value calculated as to the inter template prediction mode in step S35. The motion prediction/compensation unit 26 then determines the prediction mode which gives the smallest value to be the optimal inter prediction mode, and the motion prediction/compensation unit 26 supplies the predicted image generated in the optimal inter prediction mode and the cost function value thereof to the predicted image selecting unit 29.

[Description of Intra Prediction Processing with H.264/AVC Format]

Next, the modes for intra prediction that are stipulated in the H.264/AVC format will be described.

First, the intra prediction modes as to luminance signals will be described. The luminance signal intra prediction mode include nine types of prediction modes in increments of 4×4 pixels, and four types of prediction modes in macro block increments of 16×16 pixels.

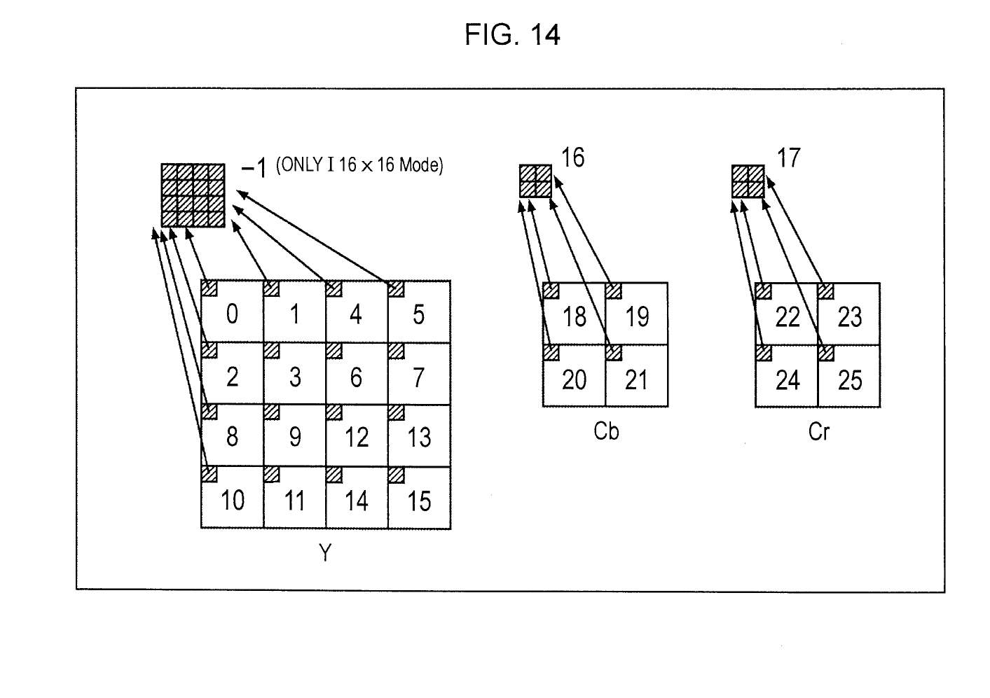

In the example in FIG. 14, the numerals −1 through 25 given to each block represent the order of each block in the bit stream (processing order at the decoding side). With regard to luminance signals, a macro block is divided into 4×4 pixels, and DCT is performed for the 4×4 pixels. Additionally, in the case of the intra prediction mode of 16×16 pixels, the direct current component of each block is gathered and a 4×4 matrix is generated, and this is further subjected to orthogonal transform, as indicated with the block −1.

Now, with regard to color difference signals, a macro block is divided into 4×4 pixels, and DCT is performed for the 4×4 pixels, following which the direct current component of each block is gathered and a 2×2 matrix is generated, and this is further subjected to orthogonal transform as indicated with the blocks 16 and 17.

Also, as for High Profile, a prediction mode in 8×8 pixel block increments is stipulated as to 8'th order DCT blocks, this method being pursuant to the 4×4 pixel intra prediction mode method described next.

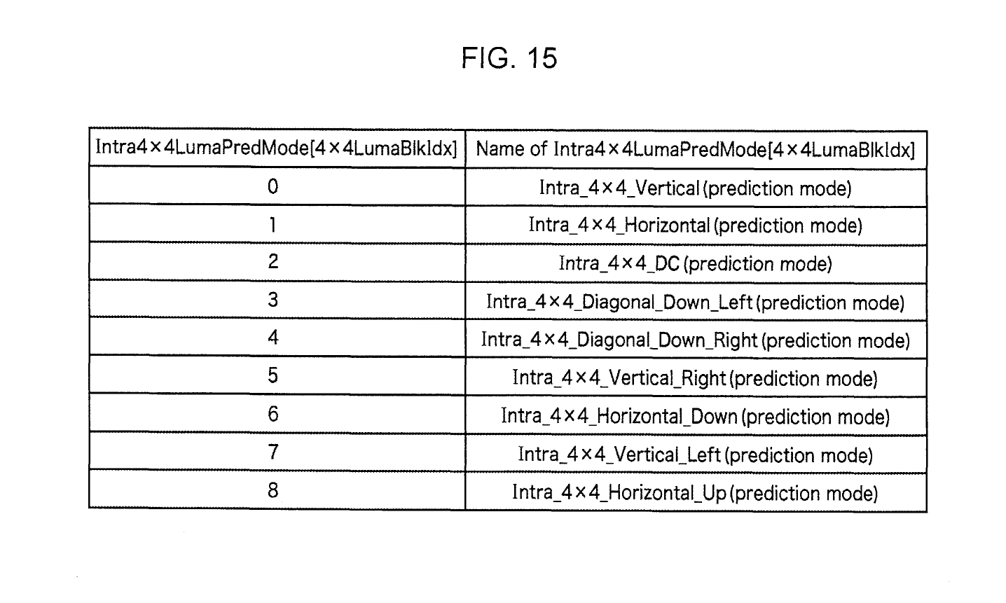

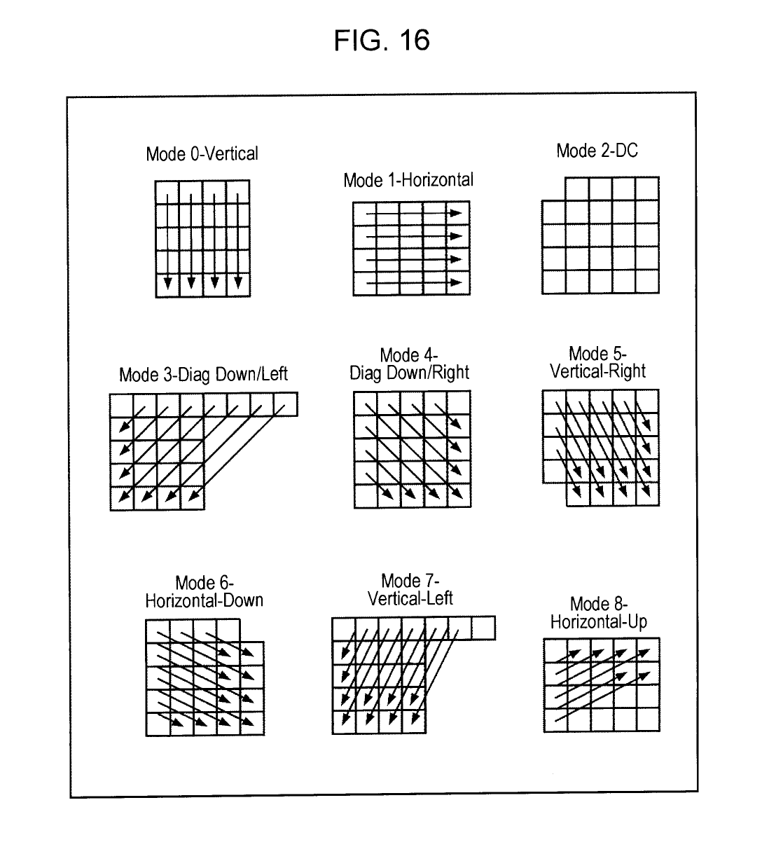

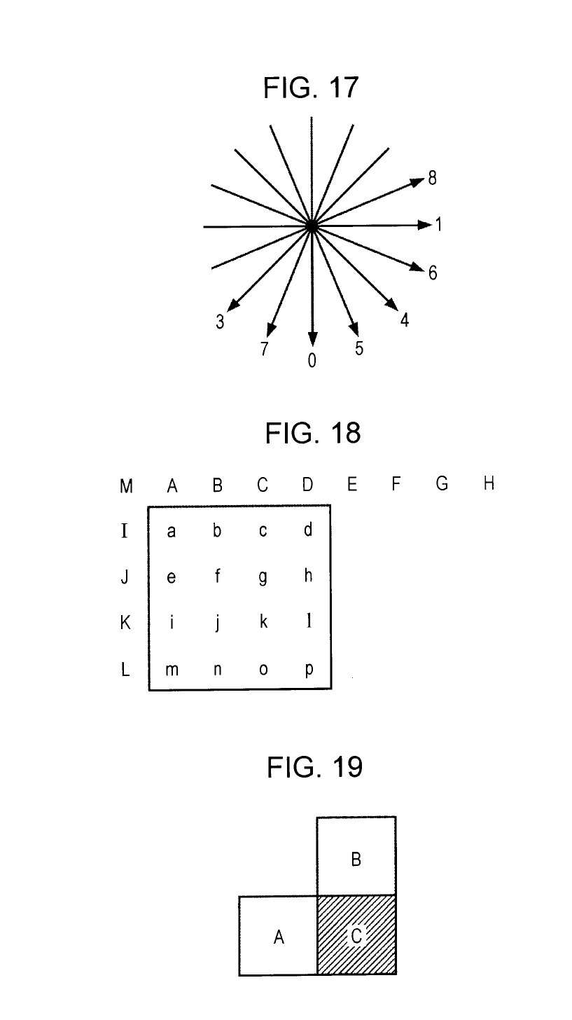

FIG. 15 and FIG. 16 are diagrams illustrating the nine types of luminance signal 4×4 pixel intra prediction modes (Intra_{—}4×4_pred_mode). The eight types of modes other than mode 2 which indicates average value (DC) prediction are each corresponding to the directions indicated by 0, 1, and 3 through 8, in FIG. 17.

The nine types of Intra_{—}4×4_pred_mode will be described with reference to FIG. 18. In the example in FIG. 18, the pixels a through p represent the object blocks to be subjected to intra processing, and the pixel values A through M represent the pixel values of pixels belonging to adjacent blocks. That is to say, the pixels a through p are the image to be processed that has been read out from the screen rearranging buffer 12, and the pixel values A through M are pixels values of the decoded image to be referenced that has been read out from the frame memory 22.

In the case of each intra prediction mode in FIG. 15 and FIG. 16, the predicted pixel values of pixels a through p are generated as follows using the pixel values A through M of pixels belonging to adjacent blocks. Note that in the event that the pixel value is “available”, this represents that the pixel is available with no reason such as being at the edge of the image frame or not being encoded yet, and in the event that the pixel value is “unavailable”, this represents that the pixel is unavailable due to a reason such as being at the edge of the image frame or not being encoded yet.

Mode 0 is a Vertical Prediction mode, and is applied only in the event that pixel values A through D are “available”. In this case, the prediction values of pixels a through p are generated as in the following Expression (7).

Prediction pixel value of pixels a, e, i, m=A

Prediction pixel value of pixels b, f, j, n=B

Prediction pixel value of pixels c, g, k, o=C

Prediction pixel value of pixels d, h, l, p=D (7)

Mode 1 is a Horizontal Prediction mode, and is applied only in the event that pixel values I through L are “available”. In this case, the prediction values of pixels a through p are generated as in the following Expression (8).

Prediction pixel value of pixels a, b, c, d=I

Prediction pixel value of pixels e, f, g, h=J

Prediction pixel value of pixels i, j, k, l=K

Prediction pixel value of pixels m, n, o, p=L (8)

Mode 2 is a DC Prediction mode, and prediction pixel values are generated as in the following Expression (9) in the event that pixel values A, B, C, D, I, J, K, L are all “available”.

(A+B+C+D+I+J+K+L+4) [symbol] 3 (9)

Also, prediction pixel values are generated as in the following Expression (10) in the event that pixel values A, B, C, D are all “unavailable”.

(I+J+K+L+2) [symbol] 2 (10)

Also, prediction pixel values are generated as in the following Expression (11) in the event that pixel values I, J, K, L are all “unavailable”.

(A+B+C+D+2) [symbol] 2 (11)

Also, the event that pixel values A, B, C, D, I, J, K, L are all “unavailable”, 128 is generated as a prediction pixel value.

Mode 3 is a Diagonal_Down_Left Prediction mode, and prediction pixel values are generated only in the event that pixel values A, B, C, D, I, J, K, L, M are “available”. In this case, the prediction pixel values of the pixels a through p are generated as in the following Expression (12).

Prediction pixel value of pixel a=(A+2B+C+2) [symbol] 2

Prediction pixel value of pixels b, e=(B+2C+D+2) [symbol] 2

Prediction pixel value of pixels c, f, i=(C+2D+E+2) [symbol] 2

Prediction pixel value of pixels d, g, j, m=(D+2E+F+2) [symbol] 2

Prediction pixel value of pixels h, k, n=(E+2F+G+2) [symbol] 2

Prediction pixel value of pixels l, o=(F+2G+H+2) [symbol] 2

Prediction pixel value of pixel p=(G+3H+2) [symbol] 2 (12)

Mode 4 is a Diagonal_Down_Right Prediction mode, and prediction pixel values are generated only in the event that pixel values A, B, C, D, I, J, K, L, M are “available”. In this case, the prediction pixel values of the pixels a through p are generated as in the following Expression (13).

Prediction pixel value of pixel m=(J+2K+L+2) [symbol] 2

Prediction pixel value of pixels i, n=(I+2J+K+2) [symbol] 2

Prediction pixel value of pixels e, j, o=(M+2I+J+2) [symbol] 2

Prediction pixel value of pixels a, f, k, p=(A+2M+I+2) [symbol] 2

Prediction pixel value of pixels b, g, l=(M+2A+B+2) [symbol] 2

Prediction pixel value of pixels c, h=(A+2B+C+2) [symbol] 2

Prediction pixel value of pixel d=(B+2C+D+2) [symbol] 2 (13)

Mode 5 is a Diagonal_Vertical_Right Prediction mode, and prediction pixel values are generated only in the event that pixel values A, B, C, D, I, J, K, L, M are “available”. In this case, the pixel values of the pixels a through p are generated as in the following Expression (14).

Prediction pixel value of pixels a, j=(M+A+1) [symbol] 1

Prediction pixel value of pixels b, k=(A+B+1) [symbol] 1

Prediction pixel value of pixels c, l=(B+C+1) [symbol] 1

Prediction pixel value of pixel d=(C+D+1) [symbol] 1

Prediction pixel value of pixels e, n=(I+2M+A+2) [symbol] 2

Prediction pixel value of pixels f, o=(M+2A+B+2) [symbol] 2

Prediction pixel value of pixels g, p=(A+2B+C+2) [symbol] 2

Prediction pixel value of pixel h=(B+2C+D+2) [symbol] 2

Prediction pixel value of pixel i=(M+2I+J+2) [symbol] 2

Prediction pixel value of pixel m=(I+2J+K+2) [symbol] 2 (14)

Mode 6 is a Horizontal_Down Prediction mode, and prediction pixel values are generated only in the event that pixel values A, B, C, D, I, J, K, L, M are “available”. In this case, the pixel values of the pixels a through p are generated as in the following Expression (15).

Prediction pixel value of pixels a, g=(M+I+1) [symbol] 1

Prediction pixel value of pixels b, h=(I+2M+A+2) [symbol] 2

Prediction pixel value of pixel c=(M+2A+B+2) [symbol] 2

Prediction pixel value of pixel d=(A+2B+C+2) [symbol] 2

Prediction pixel value of pixels e, k=(I+J+1) [symbol] 1

Prediction pixel value of pixels f, l=(M+2I+J+2) [symbol] 2

Prediction pixel value of pixels i, o=(J+K+1) [symbol] 1

Prediction pixel value of pixels j, p=(I+2J+K+2) [symbol] 2

Prediction pixel value of pixel m=(K+L+1) [symbol] 1

Prediction pixel value of pixel n=(J+2K+L+2) [symbol] 2 (15)

Mode 7 is a Vertical_Left Prediction mode, and prediction pixel values are generated only in the event that pixel values A, B, C, D, I, J, K, L, M are “available”. In this case, the pixel values of the pixels a through p are generated as in the following Expression (16).

Prediction pixel value of pixel a=(A+B+1) [symbol] 1

Prediction pixel value of pixels b, i=(B+C+1) [symbol] 1

Prediction pixel value of pixels c, j=(C+D+1) [symbol] 1

Prediction pixel value of pixels d, k=(D+E+1) [symbol] 1

Prediction pixel value of pixel l=(E+F+1) [symbol] 1

Prediction pixel value of pixel e=(A+2B+C+2) [symbol] 2

Prediction pixel value of pixels f, m=(B+2C+D+2) [symbol] 2

Prediction pixel value of pixels g, n=(C+2D+E+2) [symbol] 2

Prediction pixel value of pixels h, o=(D+2E+F+2) [symbol] 2

Prediction pixel value of pixel p=(E+2F+G+2) [symbol] 2 (16)

Mode 8 is a Horizontal_Up Prediction mode, and prediction pixel values are generated only in the event that pixel values A, B, C, D, I, J, K, L, M are “available”. In this case, the pixel values of the pixels a through p are generated as in the following Expression (17).

Prediction pixel value of pixel a=(I+J+1) [symbol] 1

Prediction pixel value of pixels b=(I+2J+K+2) [symbol] 2

Prediction pixel value of pixels c, e=(J+K+1) [symbol] 1

Prediction pixel value of pixels d, f=(J+2K+L+2) [symbol] 2

Prediction pixel value of pixels g, i=(K+L+1) [symbol] 1

Prediction pixel value of pixels h, j=(K+3L+2) [symbol] 2

Prediction pixel value of pixels k, l, m, n, o, p=L (17)

Next, the intra prediction mode (Intra_{—}4×4_pred_mode) encoding method for 4×4 pixel luminance signals will be described with reference to FIG. 19. In the example in FIG. 19, an object block C to be encoded which is made up of 4×4 pixels is shown, and a block A and block B which are made up of 4×4 pixel and are adjacent to the object block C are shown.

In this case, the Intra_{—}4×4_pred_mode in the object block C and the Intra_{—}4×4_pred_mode in the block A and block B are thought to have high correlation. Performing the following encoding processing using this correlation allows higher encoding efficiency to be realized.

That is to say, in the example in FIG. 19, with the Intra_{—}4×4_pred_mode in the block A and block B as Intra_{—}4×4_pred_modeA and Intra_{—}4×4_pred_modeB respectively, the MostProbableMode is defined as the following Expression (18).

MostProbableMode=Min(Intra_{—}4×4_pred_modeA, Intra_{—}4×4_pred_modeB) (18)

That is to say, of the block A and block B, that with the smaller mode_number allocated thereto is taken as the MostProbableMode.

There are two values of prev_intra4×4_pred_mode_flag[luma4×4BlkIdx] and rem_intra4×4_pred_mode[luma4×4BlkIdx] defined as parameters as to the object block C in the bit stream, with decoding processing being performed by processing based on the pseudocode shown in the following Expression (19), so the values of Intra_{—}4×4_pred_mode, Intra4×4PredMode[luma4×4BlkIdx] as to the object block C can be obtained.

```
      if(prev_intra4×4_pred_mode_flag[luma4×4BlkIdx])
                    Intra4×4PredMode[luma4×4BlkIdx] =
MostProbableMode
      else
          if(rem_intra4×4_pred_mode[luma4×4BlkIdx] <
MostProbableMode)
              Intra4×4PredMode[luma4×4BlkIdx] =
rem_intra4×4_pred_mode[luma4×4BlkIdx]
      else
              Intra4×4PredMode[luma4×4BlkIdx] =
rem_intra4×4_pred_mode[luma4×4BlkIdx] + 1
      ...(19)
```

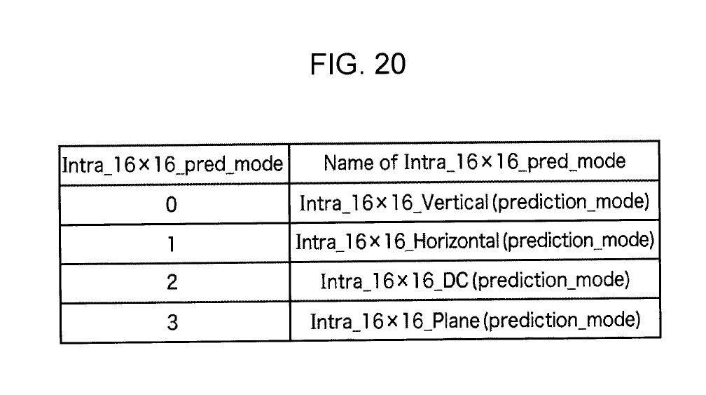

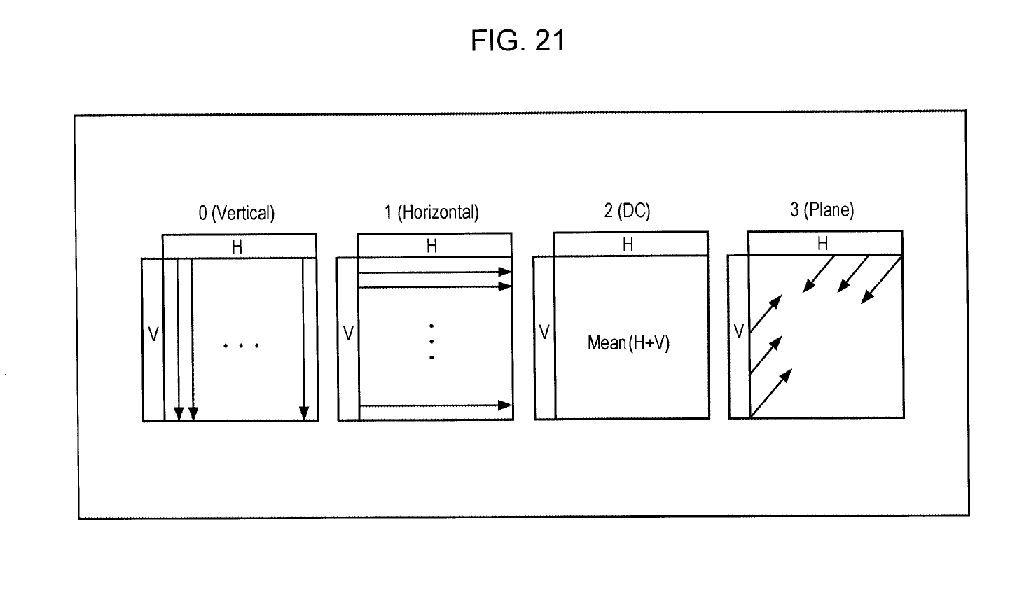

Next, description will be made regarding the 16×16 pixel intra prediction mode. FIG. 20 and FIG. 21 are diagrams illustrating the four types of 16×16 pixel luminance signal intra prediction modes (Intra_{—}16×16_pred_mode).

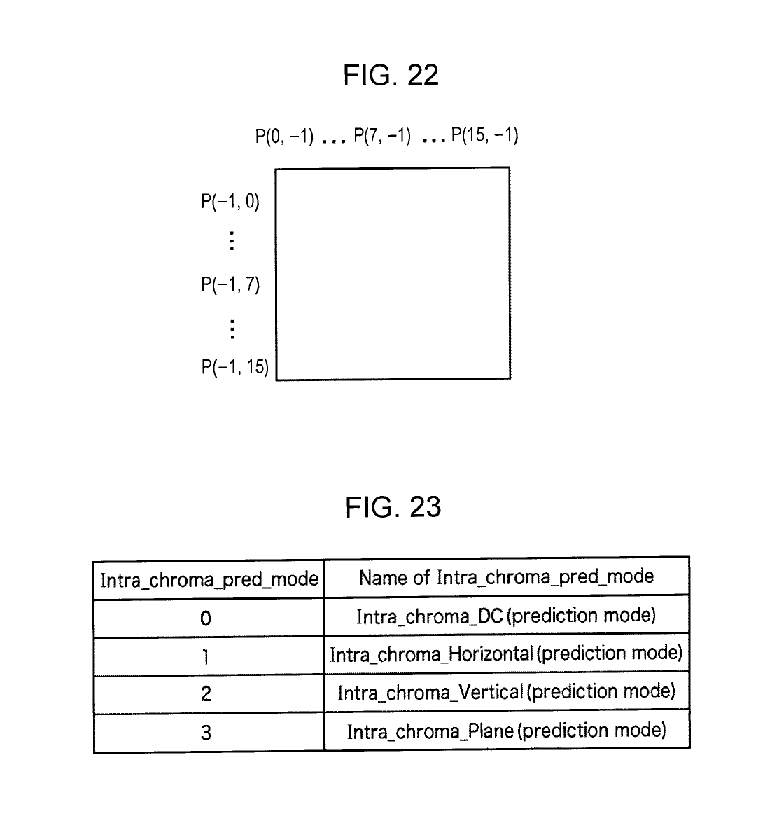

The four types of intra prediction modes will be described with reference to FIG. 22. In the example in FIG. 22, an object macro block A to be subjected to intra processing is shown, and P(x,y);x,y=−1, 0, . . . , 15 represents the pixel values of the pixels adjacent to the object macro block A.

Mode 0 is the Vertical Prediction mode, and is applied only in the event that P(x,−1); x,y=−1, 0, . . . , 15 is “available”. In this case, the prediction value Pred(x,y) of each of the pixels in the object macro block A is generated as in the following Expression (20).

Pred(x,y)=P(x,−1);x,y=0, . . . , 15 (20)

Mode 1 is the Horizontal Prediction mode, and is applied only in the event that P(−1,y); x,y=−1, 0, . . . , 15 is “available”. In this case, the prediction value Pred(x,y) of each of the pixels in the object macro block A is generated as in the following Expression (21).

Pred(x,y)=P(−1,y);x,y=0, . . . , 15 (21)

Mode 2 is the DC Prediction mode, and in the event that P(x,−1) and P(−1,y); x,y=−1, 0, . . . , 15 are all “available”, the prediction value Pred(x,y) of each of the pixels in the object macro block A is generated as in the following Expression (22).

$$\begin{matrix}[ Math . 5 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 22 )\end{matrix}$$

Also, in the event that P(x,−1); x,y=−1, 0, . . . , 15 is “unavailable”, the prediction value Pred(x,y) of each of the pixels in the object macro block A is generated as in the following Expression (23).

$$\begin{matrix}[ Math . 6 ] & \\ Pred ( x , y ) = [ {\sum }_{{y}^{′} = 0}^{15} P ( - 1 , {y}^{′} ) + 8 ] >> 4 with x , y = 0 , … , 15 & ( 23 )\end{matrix}$$

In the event that P(−1,y); x,y=−1, 0, . . . , 15 is “unavailable”, the prediction value Pred(x,y) of each of the pixels in the object macro block A is generated as in the following Expression (24).

$$\begin{matrix}[ Math . 7 ] & \\ Pred ( x , y ) = [ {\sum }_{{y}^{′} = 0}^{15} P ( {x}^{′} , - 1 ) + 8 ] >> 4 with x , y = 0 , … , 15 & ( 24 )\end{matrix}$$

In the event that P(x,−1) and P(−1,y); x,y=−1, 0, . . . , 15 as all “unavailable”, 128 is used as a prediction pixel value.

Mode 3 is the Plane Prediction mode, and is applied only in the event that P(x,−1 and P(−1,y); x,y=−1, 0, . . . , 15 are all “available”. In this case, the prediction value Pred(x,y) of each of the pixels in the object macro block A is generated as in the following Expression (25).

$$\begin{matrix}[ Math . 8 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 25 )\end{matrix}$$

Next, the intra prediction modes as to color difference signals will be described. FIG. 23 is a diagram illustrating the four types of color difference signal intra prediction modes (Intra_chroma_pred_mode). The color difference signal intra prediction mode can be set independently from the luminance signal intra prediction mode. The intra prediction mode for color difference signals conforms to the above-described luminance signal 16×16 pixel intra prediction mode.

Note however, that while the luminance signal 16×16 pixel intra prediction mode handles 16×16 pixel blocks, the intra prediction mode for color difference signals handles 8×8 pixel blocks. Further, the node Nos. do not correspond between the two, as can be seen in FIG. 20 and FIG. 23 described above.

In accordance with the definition of pixel values of the macro block which the object of the luminance signal 16×16 pixel intra prediction mode and the adjacent pixel values described above with reference to FIG. 22, the pixel values adjacent to the macro block A for intra processing (8×8 pixels in the case of color difference signals) will be taken as P(x,y);x,y=−1, 0, . . . , 7.

Mode 0 is the DC Prediction mode, and in the event that P(x,−1) and P(−1,y); x,y=−1, 0, . . . , 7 are all “available”, the prediction pixel value Pred(x,y) of each of the pixels of the object macro block A is generated as in the following Expression (26).

$$\begin{matrix}[ Math . 9 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 26 )\end{matrix}$$

Also, in the event that P(−1,y); x,y=−1, 0, . . . , 7 is “unavailable”, the prediction pixel value Pred(x,y) of each of the pixels of object macro block A is generated as in the following Expression (27).

$$\begin{matrix}[ Math . 10 ] & \\ Pred ( x , y ) = [ ( {\sum }_{n = 0}^{7} P ( n , - 1 ) ) + 4 ] >> 3 with x , y = 0 , … , 7 & ( 27 )\end{matrix}$$

Also, in the event that P(x,−1); x,y=−1, 0, . . . , 7 is “unavailable”, the prediction pixel value Pred(x,y) of each of the pixels of object macro block A is generated as in the following Expression (65).

$$\begin{matrix}[ Math . 11 ] & \\ Pred ( x , y ) = [ ( {\sum }_{n = 0}^{7} P ( - 1 , n ) ) + 4 ] >> 3 with x , y = 0 , … , 7 & ( 28 )\end{matrix}$$

Mode 1 is the Horizontal Prediction mode, and is applied only in the event that P(−1,y); x,y=−1, 0, . . . , 7 is “available”. In this case, the prediction pixel value Pred(x,y) of each of the pixels of object macro block A is generated as in the following Expression (29).

Pred(x,y)=P(−1,y);x,y=0, . . . , 7 (29)

Mode 2 is the Vertical Prediction mode, and is applied only in the event that P(x,−1); x,y=−1, 0, . . . , 7 is “available”. In this case, the prediction pixel value Pred(x,y) of each of the pixels of object macro block A is generated as in the following Expression (28).

Pred(x,y)=P(x,−1);x,y=0, . . . , 7 (30)

Mode 3 is the Plane Prediction mode, and is applied only in the event that P(x,−1) and P(−1,y); x,y=−1, 0, . . . , 7 are “available” In this case, the prediction pixel value Pred(x,y) of each of the pixels of object macro block A is generated as in the following Expression (31).

$$\begin{matrix}[ Math . 12 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 32 ) >> 6 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 31 )\end{matrix}$$

As described above, there are nine types of 4×4 pixel and 8×8 pixel block-increment and four types of 16×16 pixel macro block-increment prediction modes for luminance signal intra prediction modes. Also, there are four types of 8×8 pixel block-increment prediction modes for color difference signal intra prediction modes. The color difference intra prediction mode can be set separately from the luminance signal intra prediction mode.

For the luminance signal 4×4 pixel and 8×8 pixel intra prediction modes, one intra prediction mode is defined for each 4×4 pixel and 8×8 pixel luminance signal block. For luminance signal 16×16 pixel intra prediction modes and color difference intra prediction modes, one prediction mode is defined for each macro block.

Note that the types of prediction modes correspond to the directions indicated by the Nos. 0, 1, 3 through 8, in FIG. 17 described above. Prediction mode 2 is an average value prediction.

### [Description of Intra Prediction Processing]

Next, the intra prediction processing in step S31 of FIG. 13, which is processing performed as to these intra prediction modes, will be described with reference to the flowchart in FIG. 24. Note that in the example in FIG. 24, the case of luminance signals will be described as an example.

In step S41, the intra prediction unit 24 performs intra prediction as to each intra prediction mode of 4×4 pixels, 8×8 pixels, and 16×16 pixels, for luminance signals, described above.

For example, the case of 4×4 pixel intra prediction mode will be described with reference to FIG. 18 described above. In the event that the image to be processed that has been read out from the screen rearranging buffer 12 (e.g., pixels a through p), is a block image to be subjected to intra processing, a decoded image to be reference (pixels indicated by pixel values A through M) is read out from the frame memory 22, and supplied to the intra prediction unit 24 via the switch 23.

Based on these images, the intra prediction unit 24 performs intra prediction of the pixels of the block to be processed. Performing this intra prediction processing in each intra prediction mode results in a prediction image being generated in each intra prediction mode. Note that pixels not subject to deblocking filtering by the deblocking filter 21 are used as the decoded signals to be referenced (pixels indicated by pixel values A through M).

In step S42, the intra prediction unit 24 calculates cost function values for each intra prediction mode of 4×4 pixels, 8×8 pixels, and 16×16 pixels. Now, one technique of either a High Complexity mode or a Low Complexity mode is used for calculation of cost function values, as stipulated in JM (Joint Model) which is reference software in the H.264/AVC format.

That is to say, with the High Complexity mode, as far as temporary encoding processing is performed for all candidate prediction modes as the processing of step S41. A cost function value is then calculated for each prediction mode as shown in the following Expression (32), and the prediction mode which yields the smallest value is selected as the optimal prediction mode.

Cost(Mode)=D+λ·R (32)

D is difference (noise) between the original image and decoded image, R is generated code amount including orthogonal transform coefficients, and λ is a Lagrange multiplier given as a function of a quantization parameter QP.

On the other hand, in the Low Complexity mode, as for the processing of step S41, prediction images are generated and calculation is performed as far as the header bits such as motion vector information and prediction mode information, for all candidates prediction modes. A cost function value shown in the following Expression (33) is then calculated for each prediction mode, and the prediction mode yielding the smallest value is selected as the optimal prediction mode.

Cost(Mode)=D+QPtoQuant(QP)·Header_Bit (33)

D is difference (noise) between the original image and decoded image, Header_Bit is header bits for the prediction mode, and QPtoQuant is a function given as a function of a quantization parameter QP.

In the Low Complexity mode, just a prediction image is generated for all prediction modes, and there is no need to perform encoding processing and decoding processing, so the amount of computation that has to be performed is small.

In step S43, the intra prediction unit 24 determines an optimal mode for each intra prediction mode of 4×4 pixels, 8×8 pixels, and 16×16 pixels. That is to say, as described above, there are nine types of prediction modes in the case of intra 4×4 pixel prediction mode and intra 8×8 pixel prediction mode, and there are four types of prediction modes in the case of intra 16×16 pixel prediction mode. Accordingly, the intra prediction unit 24 determines from these an optimal intra 4×4 pixel prediction mode, an optimal intra 8×8 pixel prediction mode, and an optimal intra 16×16 pixel prediction mode, based on the cost function value calculated in step S42.

In step S44, the intra prediction unit 24 selects one intra prediction mode from the optimal modes selected for each intra prediction mode of 4×4 pixels, 8×8 pixels, and 16×16 pixels, based on the cost function value calculated in step S42. That is to say, the intra prediction mode of which the cost function value is the smallest is selected from the optimal modes decided for each intra prediction mode of 4×4 pixels, 8×8 pixels, and 16×16 pixels.

### [Description of Inter Motion Prediction Processing]

Next, the inter motion prediction processing in step S32 in FIG. 13 will be described with reference to the flowchart in FIG. 25.

In step S51, the motion prediction/compensation unit 26 determines a motion vector and reference information for each of the eight types of inter prediction modes made up of 16×16 pixels through 4×4 pixels, described above with reference to FIG. 3. That is to say, a motion vector and reference image is determined for a block to be processed with each inter prediction mode.

In step S52, the motion prediction/compensation unit 26 performs motion prediction and compensation processing for the reference image, based on the motion vector determined in step S51, for each of the eight types of inter prediction modes made up of 16×16 pixels through 4×4 pixels. As a result of this motion prediction and compensation processing, a prediction image is generated in each inter prediction mode.

In step S53, the motion prediction/compensation unit 26 generates motion vector image to be added to a compressed image, based on the motion vector determined as to the eight types of inter prediction modes made up of 16×16 pixels through 4×4 pixels. At this time, the motion vector generating method described above with reference to FIG. 6 is used to generate motion vector information.

The generated motion vector information is also used for calculating cost function values in the following step S54, and in the event that a corresponding prediction image is ultimately selected by the predicted image selecting unit 29, this is output to the lossless encoding unit 16 along with the mode information and reference frame information.

In step S54 the motion prediction/compensation unit 26 calculates the cost function values shown in Expression (32) or Expression (33) described above, for each inter prediction mode of the eight types of inter prediction modes made up of 16×16 pixels through 4×4 pixels. The cost function values calculated here are used at the time of determining the optimal inter prediction mode in step S36 in FIG. 13 described above.

### [Description of Intra Template Motion Prediction Processing]

Next, the intra template prediction processing in step S33 of FIG. 13 will be described with reference to the flowchart in FIG. 26.

The block address calculating unit 41 calculates, for an object block to be encoded, addresses within a macro block thereof, and supplies the calculated address information to the template pixel setting unit 28.

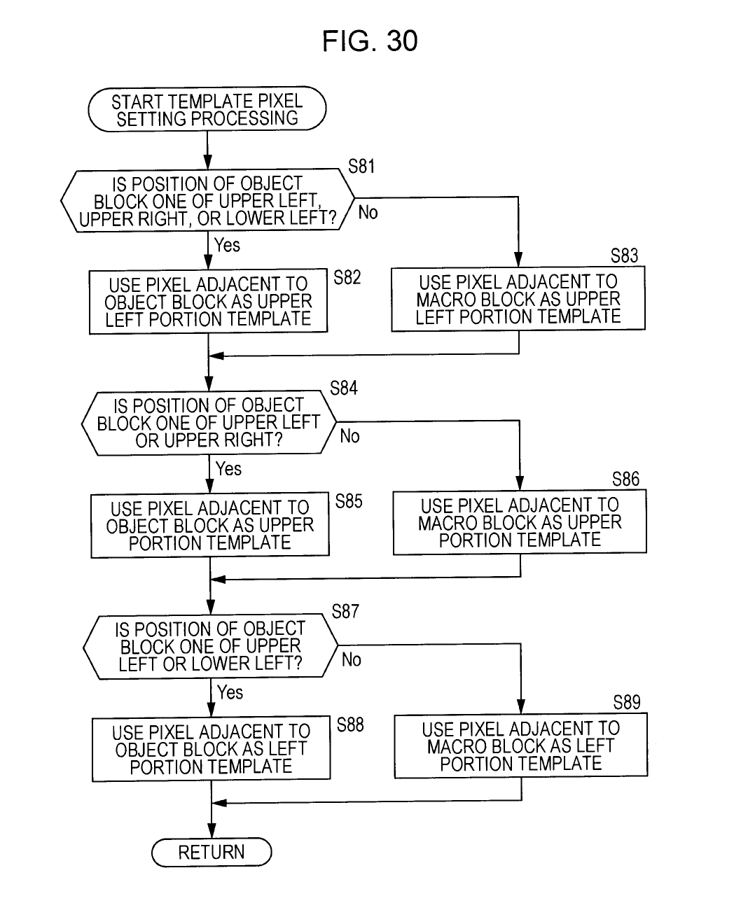

In step S61, the template pixel setting unit 28 performs template pixel setting processing as to the object block of the intra template prediction mode, based on the address information from the block address calculating unit 41. Details of this template pixel setting processing will be described later with reference to FIG. 30. Due to this processing, pixels configuring a template for the object block of the intra template prediction mode are set.

In step S62, the motion prediction unit 42 and motion compensation unit 43 perform prediction and compensation processing of the intra template prediction mode. That is to say, the motion prediction unit 42 is input with images for intra prediction read out from the screen rearranging buffer 12 and reference images supplied from the frame memory 22. The motion prediction unit 42 is also input with object block and reference block template information, set by the object block TP setting unit 62 and reference block TP setting unit 63.

The motion prediction unit 42 uses the images for intra prediction and reference images to perform intra template prediction mode motion prediction, using the object block and reference block template pixel values set by the processing in step S61. At this time, the calculated motion vectors and reference images are supplied to the motion compensation unit 43. The motion compensation unit 43 uses the motion vectors and reference images calculated by the motion prediction unit 42 to perform motion compensation processing and generate a predicted image.

Subsequently, in step S63 the motion compensation unit 43 calculates a cost function value shown in the above-described Expression (32) or Expression (33), for the intra template prediction mode. The motion compensation unit 43 supplies the generated predicted image and calculated cost function value to the intra prediction unit 24. This cost function value is used for determining the optimal intra prediction mode in step S34 in FIG. 13 described above.

### [Description of Intra Template Matching Method]

FIG. 27 is a diagram for describing the intra template matching method. In the example in FIG. 27, a block A of 4×4 pixels, and a predetermined search range E configured of already-encoded pixels within a range made up of X×Y (=vertical×horizontal) pixels, are shown on an unshown object frame to be encoded.

An object sub-block a which is to be encoded from now is shown in the predetermined block A. The predetermined block A is a macro block, sub-macro block, or the like, for example. This object sub-block a is the sub-block at the upper left of the 2×2 pixel sub-blocks making up the block A. A template region b, which is made up of pixels that have already been encoded, is adjacent to the object sub-block a. For example, in the event of performing encoding processing in raster scan order, the template region b is a region situated at the left and upper side of the object sub-block a as shown in FIG. 27, and is a region regarding which the decoded image is accumulated in the frame memory 22.

The intra TP motion prediction/compensation unit 25 performs template matching processing with SAD (Sum of Absolute Difference) or the like for example, as the cost function value, within a predetermined search range E on the object frame, and searches for a region b′ wherein the correlation with the pixel values of the template region b is the highest. The intra TP motion prediction/compensation unit 25 then takes a block a′ corresponding to the found region b′ as a prediction image as to the object block a, and searches for a motion vector corresponding to the object block a.

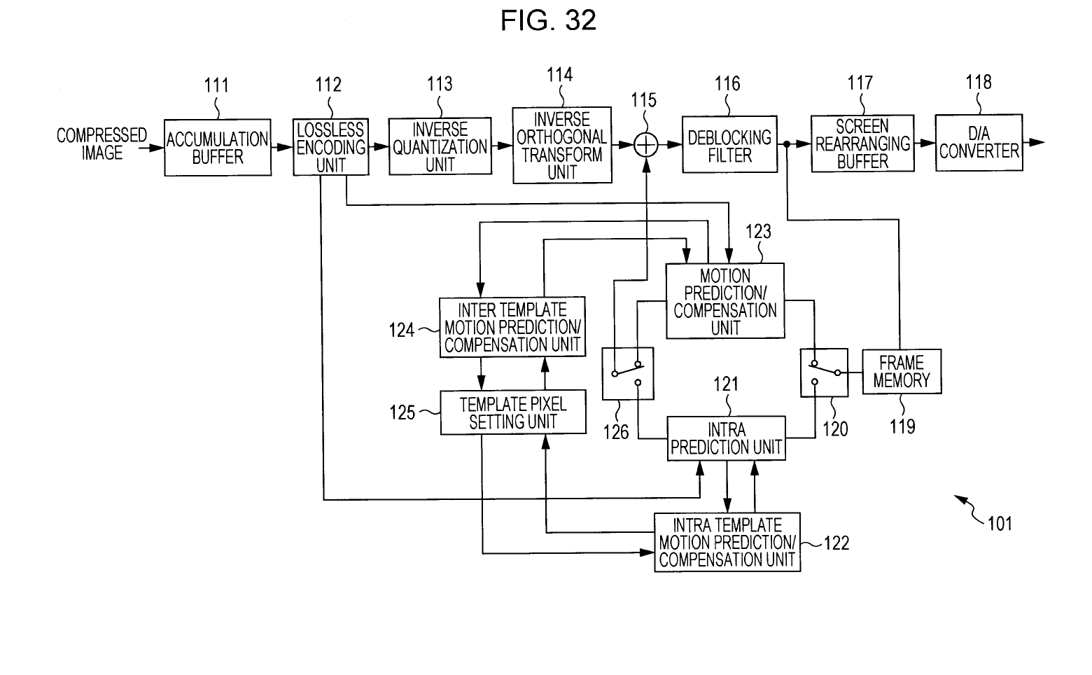

Thus, with the motion vector search processing using the intra template matching method, a decoded image is used for the template matching processing. Accordingly, the same processing can be performed with the image encoding device 1 and a later-described image decoding device 101 in FIG. 32 by setting a predetermined search range E beforehand. That is to say, with the image decoding device 101 as well, configuring an intra TP motion prediction/compensation unit 122 does away with the need to send motion vector information regarding the object sub-block to the image decoding device 101, so motion vector information in the compressed image can be reduced.

Further, with the image encoding device 1 and image decoding device 101, the template region b of the object block a is set from adjacent pixels of the predetermined block A, in accordance with the position (address) within the predetermined block A, as described above with reference to A in FIG. 8 through D in FIG. 8 and so forth. That is to say, the template region b of the object block a is not configured of adjacent pixels of the object block a, but is configured of pixels set from the adjacent pixels of the predetermined block A in accordance with the position (address) of the object block a within the predetermined block A.

For example, as shown in FIG. 27, in the event that the object block a is situated at the upper left of the predetermined block A, pixels adjacent to the object block a are used as the template region b, the same as with the conventional art.

On the other hand, in the event that the object block a is situated at the upper right, lower left, or lower right in the predetermined block A, there may be cases where pixels of one of the blocks making up the predetermined block A are included in the conventional template region b. In this case, adjacent pixels of the predetermined block A are set as part of the template region b instead of the pixels of the adjacent pixels of the object block a included in one of the blocks making up the predetermined block A. Accordingly, processing of each block within the predetermined block A can be realized by pipeline processing or parallel processing, and processing efficiency can be improved.

While a case of an object sub-block of 2×2 pixels has been described in FIG. 27, this is not restrictive, rather, sub-blocks of optional sizes can be applied, and the size of blocks and templates in the intra template prediction mode are optional. That is to say, as with the case of the intra prediction unit 24, the intra template prediction mode can be carried out with block sizes of each intra prediction mode as candidates, or can be carried out fixed to one prediction mode block size. The template size may be variable or may be fixed as to the object block size.

### [Description of Inter Template Motion Prediction Processing]

Next, the inter template prediction processing in step S35 in FIG. 13 will be described with reference to the flowchart in FIG. 28.

The block address calculating unit 51 calculates the address of the object block to be encoded within the macro block thereof, and supplies the calculated address information to the template pixel setting unit 28.

In step S71, the template pixel setting unit 28 performs template pixel setting processing on the object block of the inter template prediction mode, based on the address information from the block address calculating unit 51. Details of this template pixel setting processing will be described later with reference to FIG. 30. Due to this processing, pixels configuring a template as to the object block of the inter template prediction mode are set.

In step S72, the motion prediction unit 52 and the motion compensation unit 53 perform motion prediction and compensation processing for the inter template prediction mode. That is to say, the motion prediction unit 52 is input with images for intra prediction read out from the screen rearranging buffer 12 and reference images supplied from the frame memory 22. The motion prediction unit 52 is also input with object block and reference block template information, set by the object block TP setting unit 62 and reference block TP setting unit 63.

The motion prediction unit 52 uses the images for inter prediction and reference images to perform inter template prediction mode motion prediction, using the object block and reference block template pixel values set by the processing in step S71. At this time, the calculated motion vectors and reference images are supplied to the motion compensation unit 53. The motion compensation unit 53 uses the motion vectors and reference images calculated by the motion prediction unit 52 to perform motion compensation processing and generate a predicted image.

Also, in step S73 the motion compensation unit 53 calculates a cost function value shown in the above-described Expression (32) or Expression (33), for the inter template prediction mode. The motion compensation unit 53 supplies the generated predicted image and calculated cost function value to the motion prediction/compensation unit 26. This cost function value is used for determining the optimal intra prediction mode in step S36 in FIG. 13 described above.

### [Description of Inter Template Matching Method]

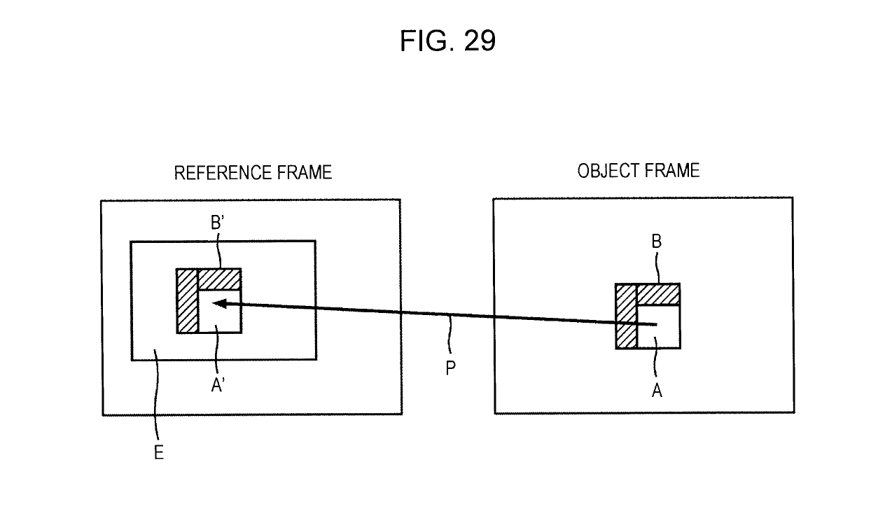

FIG. 29 is a diagram for describing the inter template matching method.

In the example in FIG. 29, an object frame (picture) to be encoded, and a reference frame referenced at the time of searching for a motion vector, are shown. In the object frame are shown an object block A which is to be encoded from now, and a template region B which is adjacent to the object block A and is made up of already-encoded pixels. For example, the template region B is a region to the left and the upper side of the object block A when performing encoding in raster scan order, as shown in FIG. 29, and is a region where the decoded image is accumulated in the frame memory 22.

The inter TP motion prediction/compensation unit 27 performs template matching processing with SAD or the like for example, as the cost function value, within a predetermined search range E on the reference frame, and searches for a region B′ wherein the correlation with the pixel values of the template region B is the highest. The inter TP motion prediction/compensation unit 27 then takes a block A′ corresponding to the found region B′ as a prediction image as to the object block A, and searches for a motion vector P corresponding to the object block A.

As described here, with the motion vector search processing using the inter template matching method, a decoded image is used for the template matching processing. Accordingly, the same processing can be performed with the image encoding device 1 and the image decoding device 101 by setting a predetermined search range E beforehand. That is to say, with the image decoding device 101 as well, configuring an inter TP motion prediction/compensation unit 124 does away with the need to send motion vector P information regarding the object block A to the image decoding device, so motion vector information in the compressed image can be reduced.

Further, with the image encoding device 1 and image decoding device 101, in the event that the object block A is a block configuring the predetermined block, this template region B is set from adjacent pixels of the predetermined block, in accordance with the position (address) within the predetermined block. Note that a predetermined block is, for example, a macro block, sub-macro block, or the like.

As described above with reference to A in FIG. 8 through D in FIG. 8 and so forth, for example, in the event that the object block A is situated at the upper left of the predetermined block, pixels adjacent to the object block A are used as the template region B, the same as with the conventional art.

On the other hand, in the event that the object block A is situated at the upper right, lower left, or lower right in the predetermined block A, there may be cases where pixels of one of the blocks making up the predetermined block are included in the conventional template region B. In this case, adjacent pixels of the predetermined block are set as part of the template region B instead of the pixels of the adjacent pixels of the object block A included in one of the blocks making up the predetermined block. Accordingly, processing of each block within the predetermined block can be realized by pipeline processing or parallel processing, and processing efficiency can be improved.

Note that the size of blocks and templates in the inter template prediction mode is optional. That is to say, as with the case of the motion prediction/compensation unit 26, this can be performed fixed on one block size of the eight types of block sizes made up of 16×16 through 4×4 pixels described above with reference to FIG. 3, or all block sizes may be candidates. The template size may be variable or may be fixed as to the object block size.

### [Description of Template Pixel Setting Processing]

Next, the template pixel setting processing in step S61 in FIG. 26 or step S71 in FIG. 28 will be described with reference to the flowchart in FIG. 30. This processing is processing executed on object blocks and reference blocks by the object block TP setting unit 62 and reference block TP setting unit 63, respectively, but with the example in FIG. 30, the case of the object block TP setting unit 62 will be described.

Note that with the example in FIG. 30, description will be made with the template divided into an upper portion template, upper left portion template, and left portion template. The upper portion template is a portion of the templates which is adjacent above to a block or macro block or the like. The upper left portion template is a portion of the templates which is adjacent to a block or macro block or the like at the upper left. The left portion template is a portion of the templates which is adjacent to a block or macro block or the like at the left.

Address information of an object block to be encoded within the macro block thereof is supplied from the block address calculating unit 41 or block address calculating unit 51 to the block classifying unit 61.

The block classifying unit 61 classifies which of an upper left block, upper right block, lower left block, or lower right block, within the macro block, the object block is. That is to say, this classifies which of the block B0, block B1, block B2, and block B3 in A in FIG. 8 through D in FIG. 8 the object block is. The block classifying unit 61 then supplies the information of which block the object block is, to the object block TP setting unit 62.

Based on the information from the block classifying unit 61, in step S81 the object block TP setting unit 62 determines whether or not the position of the object block within the macro block is one of the upper left, upper right, and lower left. In step S81, in the event that determination is made that the position of the object block within the macro block is one of the upper left, upper right, and lower left, in step S82 the object block TP setting unit 62 uses pixels adjacent to the object block as the upper left portion template.

That is to say, in the event that the position of the object block within the macro block is at the upper left (block B0 in A in FIG. 8), the pixel LUB0 adjacent to the upper left portion of the block B0 is used as the upper left portion template. In the event that the position of the object block within the macro block is at the upper right (block B1 in B in FIG. 8), the pixel LUB1 adjacent to the upper left portion of the block B1 is used as the upper left portion template. In the event that the position of the object block within the macro block is at the lower left (block B2 in C in FIG. 8), the pixel LUB2 adjacent to the upper left portion of the block B2 is used as the upper left portion template.

In the event that determination is made in step S81 that the position of the object block within the macro block is none of the upper left, upper right, or lower left, in step S83 the object block TP setting unit 62 uses a pixel adjacent to the macro block. That is to say, in the event that the position of the object block within the macro block is the lower right (block B3 in D in FIG. 8), the pixel LUB0 adjacent to the macro block (specifically, a portion to the upper left of the block B1 in D in FIG. 8) is used as the upper left portion template.

Next, in step S84 the object block TP setting unit 62 determines whether or not the position of the object block within the macro block is one of the upper left and upper right. In step S84, in the event that determination is made that the position of the object block within the macro block is one of the upper left and upper right, in step S85 the object block TP setting unit 62 uses pixels adjacent to the object block as the upper portion template.

That is to say, in the event that the position of the object block within the macro block is at the upper left (block B0 in A in FIG. 8), the pixels UB0 adjacent to the upper left portion of the block B0 are used as the upper portion template. In the event that the position of the object block within the macro block is at the upper right (block B1 in B in FIG. 8), the pixels UB1 adjacent to the upper portion of the block B1 are used as the upper portion template.

In the event that determination is made in step S84 that the position of the object block within the macro block is neither the upper left nor upper right, in step S86 the object block TP setting unit 62 uses pixels adjacent to the macro block as the upper portion template.

That is to say, in the event that the position of the object block within the macro block is the lower left (block B2 in C in FIG. 8), the pixels UB0 adjacent to the macro block (specifically, a portion above the block B0 in A in FIG. 8) are used as the upper portion template. In the event that the position of the object block within the macro block is the lower right (block B3 in D in FIG. 8), the pixels UB1 adjacent to the macro block (specifically, a portion above the block B1 in D in FIG. 8) are used as the upper portion template.

In step S87 the object block TP setting unit 62 determines whether or not the position of the object block within the macro block is one of the upper left and lower left. In step S87, in the event that determination is made that the position of the object block within the macro block is one of the upper left and lower left, in step S88 the object block TP setting unit 62 uses pixels adjacent to the object block as the left portion template.

That is to say, in the event that the position of the object block within the macro block is at the upper left (block B0 in A in FIG. 8), the pixels LB0 adjacent to the left portion of the block B0 are used as the left portion template. In the event that the position of the object block within the macro block is at the lower left (block B2 in C in FIG. 8), the pixels LB2 adjacent to the left portion of the block B2 are used as the upper portion template.

In the event that determination is made in step S87 that the position of the object block within the macro block is neither the upper left nor lower left, in step S89 the object block TP setting unit 62 uses pixels adjacent to the macro block as the left portion template.

That is to say, in the event that the position of the object block within the macro block is the upper right (block B1 in B in FIG. 8), the pixels LB0 adjacent to the macro block (specifically, a portion to the left of the block B0) are used as the left portion template. In the event that the position of the object block within the macro block is the lower right (block B3 in D in FIG. 8), the pixels LB2 adjacent to the macro block (specifically, a portion to the left of the block B2) are used as the left portion template.

As described above, whether to use pixels adjacent to the object block or to use pixels adjacent to the macro block thereof as pixels configuring the template is set in accordance to the position of the object block within the macro block. Accordingly, pixels adjacent to the macro block of the object block are constantly used as the template, so processing of blocks within macro block can be realized by parallel processing or pipeline processing.

### Example of Advantages of Template Pixel Setting

Advantages of the above-described template pixel setting will be described with the timing charts in A in FIG. 31 through C in FIG. 31. In the example in A in FIG. 31 through C in FIG. 31, an example is shown in which <memory readout>, <motion prediction>, <motion compensation>, and <decoding processing> is performed in order for each block.

A in FIG. 31 illustrates a timing chart of processing in the case of using a conventional template. B in FIG. 31 illustrates a timing chart of pipeline processing which is enabled in the case of using a template set by the template pixel setting unit 28. C in FIG. 31 illustrates a timing chart of parallel processing which is enabled in the case of using a template set by the template pixel setting unit 28.

With a device using the conventional template, when performing processing of the block B1 in B in FIG. 8 described above, the pixel value of decoded pixels of the block B0 are used as a part of the template, so generating of the pixel values thereof has to be awaited.

Accordingly, as shown in A in FIG. 31, <memory readout> of the block B1 cannot be performed until <memory readout>, <motion prediction>, <motion compensation>, and <decoding processing> is performed in order for block B0, and the decoded pixels are written to the memory. That is, conventionally, it was difficult to perform processing of block B0 and block B1 by pipeline processing or parallel processing.

In contrast, in the case of using a template set by the template pixel setting unit 28, the pixels LB0 adjacent to the left portion of the block B0 (macro block MB) is used as the template of the block B1 instead of the decoded pixels of the block B0.

Accordingly, there is no need to await generating of the decoded pixels of the block B0 when performing processing of the block B1. Accordingly, as shown in B in FIG. 31 for example, <memory readout> of the block B1 can be performed in parallel with the <decoding processing> to the block B0 after <memory readout>, <motion prediction>, and <motion compensation> has been performed in order to the block B0. That is to say, processing of the block B0 and the block B1 can be performed by pipeline processing.

Alternatively, as shown in C in FIG. 31, <memory readout> as to the block B1 can be performed in parallel with the <memory readout> of the block B0, <motion prediction> as to the block B1 can be performed in parallel with the <motion prediction> as to the block B0, <motion compensation> as to the block B1 can be performed in parallel with the <motion compensation> as to the block B0, and <decoding processing> as to the block B1 can be performed in parallel with the <decoding processing> as to the block B0. That is to say, processing of the block B0 and the block B1 can be performed by parallel processing.

By the above, the processing efficiency within the macro block can be improved. Note that while an example of performing parallel or pipeline processing with two blocks has been described with the example in A in FIG. 31 through C in FIG. 31, parallel or pipeline processing can be performed in the same way with three blocks, or four blocks, as a matter of course.

The compressed image that has been encoded is transferred via a predetermined transfer path, and is decoded by an image decoding device.

### Configuration Example of Image Decoding Device

FIG. 32 illustrates the configuration of an embodiment of an image decoding device serving as an image processing device to which the present invention has been applied.

The image decoding device 101 is configured of an accumulation buffer 111, a lossless decoding unit 112, an inverse quantization unit 113, an inverse orthogonal transform unit 114, a computing unit 115, a deblocking filter 116, a screen rearranging buffer 117, a D/A converter 118, frame memory 119, a switch 120, an intra prediction unit 121, an intra template motion prediction/compensation unit 122, a motion prediction/compensation unit 123, an inter template motion prediction/compensation unit 124, a template pixel setting unit 125, and a switch 126.

Note that in the following, the intra template motion prediction/compensation unit 122 and inter template motion prediction/compensation unit 124 will be referred to as inter TP motion prediction/compensation unit 122 and inter TP motion prediction/compensation unit 124, respectively.

The accumulation buffer 111 accumulates compressed images transmitted thereto. The lossless decoding unit 112 decodes information encoded by the lossless encoding unit 66 in FIG. 2 that has been supplied from the accumulation buffer 111, with a format corresponding to the encoding format of the lossless encoding unit 16. The inverse quantization unit 113 performs inverse quantization of the image decoded by the lossless decoding unit 112, with a format corresponding to the quantization format of the quantization unit 15 in FIG. 2. The inverse orthogonal transform unit 114 performs inverse orthogonal transform of the output of the inverse quantization unit 113, with a format corresponding to the orthogonal transform format of the orthogonal transform unit 14 in FIG. 2.

The output of inverse orthogonal transform is added by the computing unit 115 with a prediction image supplied from the switch 126 and decoded. The deblocking filter 116 removes block noise in the decoded image, supplies to the frame memory 119 so as to be accumulated, and outputs to the screen rearranging buffer 117.

The screen rearranging buffer 117 performs rearranging of images. That is to say, the order of frames rearranged by the screen rearranging buffer 12 in FIG. 2 in the order for encoding, is rearranged to the original display order. The D/A converter 118 performs D/A conversion of images supplied from the screen rearranging buffer 117, and outputs to an unshown display for display.

The switch 120 reads out the image to be subjected to inter encoding and the image to be referenced from the frame memory 119, and outputs to the motion prediction/compensation unit 123, and also reads out, from the frame memory 119, the image to be used for intra prediction, and supplies to the intra prediction unit 121.

Information relating to the intra prediction mode or intra template prediction mode obtained by decoding header information is supplied to the intra prediction unit 121 from the lossless decoding unit 112. In the event that information is supplied indicating the intra prediction mode, the intra prediction unit 121 generates a prediction image based on this information. In the event that information is supplied indicating the intra template prediction mode, the intra prediction unit 121 supplies the image to be used for intra prediction to the intra TP motion prediction/compensation unit 122, so that motion prediction/compensation processing in the intra template prediction mode is performed.

The intra prediction unit 121 outputs the generated prediction image or the prediction image generated by the inter TP motion prediction/compensation unit 122 to the switch 126.

The inter TP motion prediction/compensation unit 122 performs motion prediction and compensation processing for the intra template prediction mode, the same as with the intra TP motion prediction/compensation unit 25 in FIG. 2. That is to say, the intra TP motion prediction/compensation unit 122 uses images from the frame memory 119 to perform motion prediction and compensation processing for the intra template prediction mode, and generates a prediction image. At this time, the intra TP motion prediction/compensation unit 122 uses a template made up of pixels set by the template pixel setting unit 125 as the template.

The prediction image generated by the motion prediction and compensation processing for the intra template prediction mode is supplied to the intra prediction unit 121.

Information obtained by decoding the header information (prediction mode, motion vector information, reference frame information) is supplied from the lossless decoding unit 112 to the motion prediction/compensation unit 123. In the event that information which is the inter prediction mode is supplied, the motion prediction/compensation unit 123 subjects the image to motion prediction and compensation processing based on the motion vector information and reference frame information, and generates a prediction image. In the event that information is supplied which is the inter template prediction mode, the motion prediction/compensation unit 123 supplies the image to which inter encoding is to be performed that has been read out from the frame memory 119 and the image to be referenced, to the inter TP motion prediction/compensation unit 124.

The inter TP motion prediction/compensation unit 124 performs motion prediction and compensation processing in the inter template prediction mode, the same as the inter TP motion prediction/compensation unit 27 in FIG. 2. That is to say, the inter TP motion prediction/compensation unit 124 performs motion prediction and compensation processing in the inter template prediction mode based on the image to which inter encoding is to be performed that has been read out from the frame memory 119 and the image to be referenced, and generates a prediction image. At this time, inter TP motion prediction/compensation unit 124 uses a template made up of pixels set by the template pixel setting unit 125 as a template.

The prediction image generated by the motion prediction/compensation processing in the inter template prediction mode is supplied to the motion prediction/compensation unit 123.

The template pixel setting unit 125 sets pixels of a template for calculating the motion vectors of an object block in the intra or inter template prediction mode, in accordance with an address within the macro block (or sub-macro block) of the object block. The pixel information of the template that is set is supplied to the intra TP motion prediction/compensation unit 122 or inter TP motion prediction/compensation unit 124.

Note that the intra TP motion prediction/compensation unit 122, inter TP motion prediction/compensation unit 124, and template pixel setting unit 125, which perform the processing relating to the intra or inter template prediction mode are configured basically the same as with the intra TP motion prediction/compensation unit 25, inter TP motion prediction/compensation unit 27, and template pixel setting unit 28 in FIG. 2. Accordingly, the functional block shown in FIG. 7 described above is also used for description of the intra TP motion prediction/compensation unit 122, inter TP motion prediction/compensation unit 124, and template pixel setting unit 125.

That is to say, the intra TP motion prediction/compensation unit 122 is configured of the block address calculating unit 41, motion prediction unit 42, and motion compensation unit 43, the same as with the intra TP motion prediction/compensation unit 25. The inter TP motion prediction/compensation unit 124 is configured of the block address calculating unit 51, motion prediction unit 52, and motion compensation unit 53, in the same way as with the inter TP motion prediction/compensation unit 27. The template pixel setting unit 125 is configured of the block classifying unit 61, object block TP setting unit 62, and reference block TP setting unit 63, the same as with the template pixel setting unit 28.

The switch 126 selects a prediction image generated by the motion prediction/compensation unit 123 or the intra prediction unit 121, and supplies this to the computing unit 115.

### [Description of Decoding Processing by Image Decoding Device]

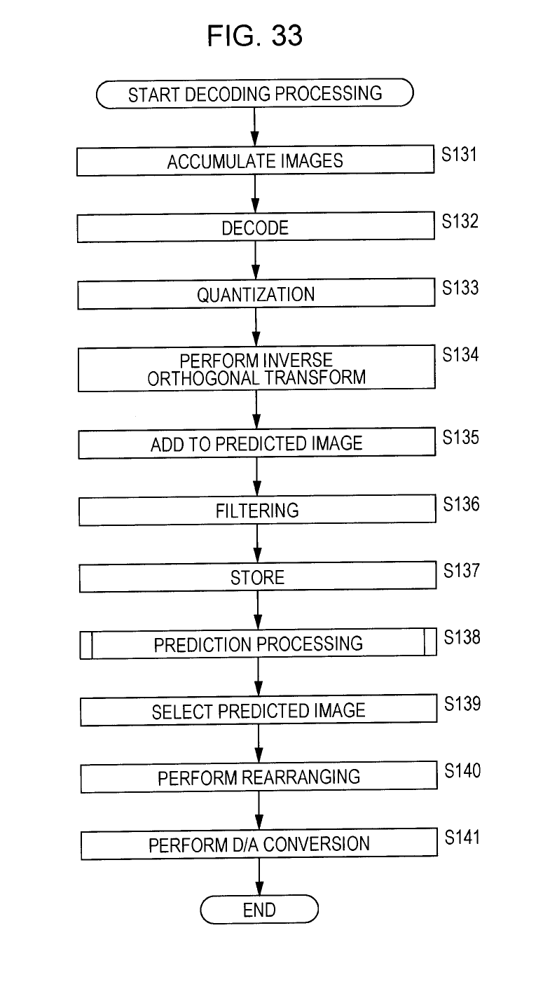

Next, the decoding processing which the image decoding device 101 executes will be described with reference to the flowchart in FIG. 33.

In step S131, the accumulation buffer 111 accumulates images transmitted thereto. In step S132, the lossless decoding unit 112 decodes compressed images supplied from the accumulation buffer 111. That is to say, the I picture, P pictures, and B pictures, encoded by the lossless encoding unit 16 in FIG. 2, are decoded.

At this time, motion vector information and prediction mode information (information representing intra prediction mode, inter prediction mode, or inter template prediction mode) is also decoded.

That is to say, in the event that the prediction mode information is intra prediction mode information or inter template prediction mode information, the prediction mode information is supplied to the intra prediction unit 121. In the event that the prediction mode information is the inter prediction mode or inter template prediction mode, the prediction mode information is supplied to the motion prediction/compensation unit 123. At this time, in the event that there is corresponding motion vector information or reference frame information, that is also supplied to the motion prediction/compensation unit 123.

In step S133, the inverse quantization unit 113 performs inverse quantization of the transform coefficients decoded at the lossless decoding unit 112, with properties corresponding to the properties of the quantization unit 15 in FIG. 2. In step S134, the inverse orthogonal transform unit 114 performs inverse orthogonal transform of the transform coefficients subjected to inverse quantization at the inverse quantization unit 113, with properties corresponding to the properties of the orthogonal transform unit 14 in FIG. 2. Thus, difference information corresponding to the input of the orthogonal transform unit (output of the computing unit 13) in FIG. 2 has been decoded.

In step S135, the computing unit 115 adds to the difference information, a prediction image selected in later-described processing of step S141 and input via the switch 126. Thus, the original image is decoded. In step S136, the deblocking filter 116 performs filtering of the image output from the computing unit 115. Thus, block noise is eliminated. In step S137, the frame memory 119 stores the filtered image.

In step S138, the intra prediction unit 121, intra TP motion prediction/compensation unit 122, motion prediction/compensation unit 123, or inter TP motion prediction/compensation unit 124, each perform image prediction processing in accordance with the prediction mode information supplied from the lossless decoding unit 112.

That is to say, in the event that intra prediction mode information is supplied from the lossless decoding unit 112, the intra prediction unit 121 performs intra prediction processing in the intra prediction mode. In the event that intra template prediction mode information is supplied from the lossless decoding unit 112, the intra TP motion prediction/compensation unit 122 performs motion prediction/compensation processing in the inter template prediction mode. Also, in the event that inter prediction mode information is supplied from the lossless decoding unit 112, the motion prediction/compensation unit 123 performs motion prediction/compensation processing in the inter prediction mode. In the event that inter template prediction mode information is supplied from the lossless decoding unit 112, the inter TP motion prediction/compensation unit 124 performs motion prediction/compensation processing in the inter template prediction mode.

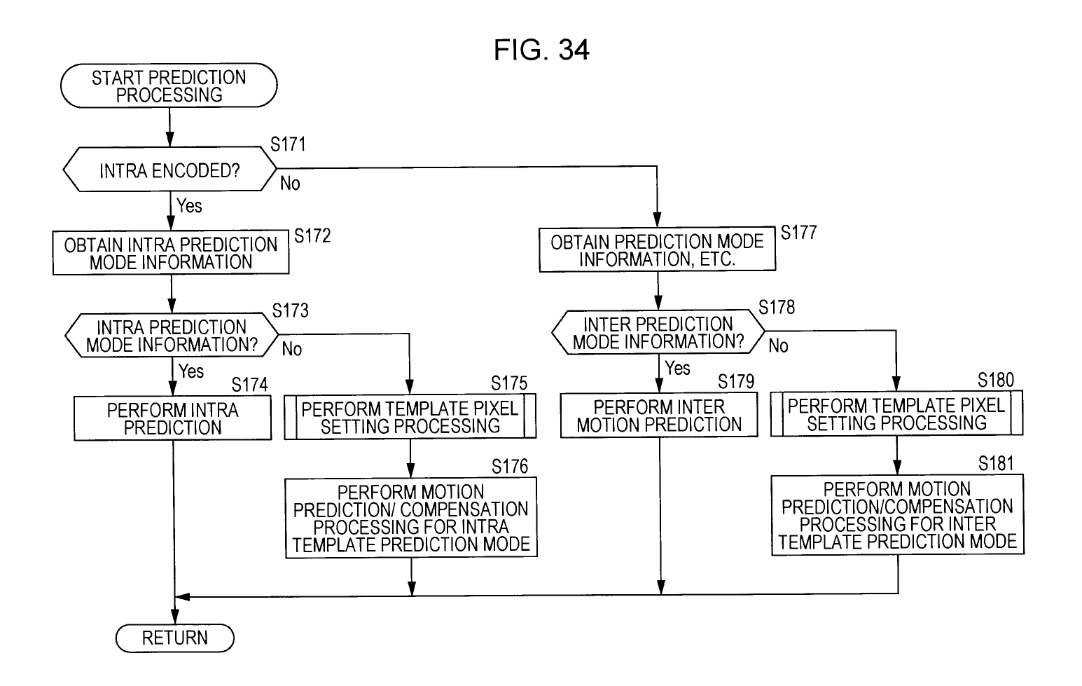

Details of the prediction processing in step S138 will be described later with reference to FIG. 34. Due to this processing, a prediction image generated by the intra prediction unit 121, a prediction image generated by the intra TP motion prediction/compensation unit 122, a prediction image generated by the motion prediction/compensation unit 123, or a prediction image generated by the inter TP motion prediction/compensation unit 124, is supplied to the switch 126.

In step S139, the switch 126 selects a prediction image. That is to say, a prediction image generated by the intra prediction unit 121, a prediction image generated by the intra TP motion prediction/compensation unit 122, a prediction image generated by the motion prediction/compensation unit 123, or a prediction image generated by the inter TP motion prediction/compensation unit 124, is supplied. Accordingly, the supplied prediction image is selected and supplied to the computing unit 115, and added to the output of the inverse orthogonal transform unit 114 in step S134 as described above.

In step S140, the screen rearranging buffer 117 performs rearranging. That is to say, the order for frames rearranged for encoding by the screen rearranging buffer 12 of the image encoding device 1 is rearranged in the original display order.

In step S141, the D/A converter 118 performs D/A conversion of the image from the screen rearranging buffer 117. This image is output to an unshown display, and the image is displayed.

### [Description of Prediction Processing by Image Decoding Device]

Next, the prediction processing of step S138 in FIG. 33 will be described with reference to the flowchart in FIG. 34.

In step S171, the intra prediction unit 121 determines whether or not the object block has been subjected to intra encoding. Intra prediction mode information or intra template prediction mode information is supplied from the lossless decoding unit 112 to the intra prediction unit 121. In accordance therewith, the intra prediction unit 121 determines in step 171 that the object block has been intra encoded, and the processing proceeds to step S172.

In step S172, the intra prediction unit 121 obtains the intra prediction mode information or intra template prediction mode information, and in step S173 determines whether or not the intra prediction mode. In the event that determination is made in step S173 that the intra prediction mode, the intra prediction unit 121 performs intra prediction in step S174.

That is to say, in the event that the object of processing is an image to be subjected to intra processing, necessary images are read out from the frame memory 119, and supplied to the intra prediction unit 121 via the switch 120. In step S174, the intra prediction unit 121 performs intra prediction following the intra prediction mode information obtained in step S172, and generates a prediction image. The generated prediction image is output to the switch 126.

In the other hand, in the event that intra template prediction mode information is obtained in step S172, determination is made in step S173 that this is not intra prediction mode information, and the processing advances to step S175.

In the event that the image to be processed is an image to be subjected to intra template prediction processing, the necessary images are read out from the frame memory 119, and supplied to the intra TP motion prediction/compensation unit 122 via the switch 120 and intra prediction unit 121. Also, the block address calculating unit 41 calculates the address of the object block which is the object of encoded within the macro block thereof, and supplies the information of the calculated address to the template pixel setting unit 125.

Based on the address information from the block address calculating unit 41, in step S175 the template pixel setting unit 125 performs template pixel setting processing as to the object block in the intra template prediction mode. Details of this template pixel setting processing are basically the same as the processing described above with reference to FIG. 30, so description thereof will be omitted. Due to this processing, pixels configuring a template as to an object block in the intra template prediction mode are set.

In step S176, the motion prediction unit 42 and motion compensation unit 43 perform motion prediction and compensation processing in the intra template prediction mode. That is to say, necessary images are input to the motion prediction unit 42 from the frame memory 119. Also, motion prediction unit 42 is input with the object block and reference block template information, set by the object block TP setting unit 62 and reference block TP setting unit 63.

The motion prediction unit 42 uses the images from the frame memory 119 to perform intra template prediction mode motion prediction, using the object block and reference block template pixel values set by the processing in step S175. At this time, the calculated motion vectors and reference images are supplied to the motion compensation unit 43. The motion compensation unit 43 uses the motion vectors calculated by the motion prediction unit 42 and reference images to perform motion compensation processing and generate a predicted image. The generated prediction image is output to the switch 126 via the intra prediction unit 121.

On the other hand, in the event that determination is made in step S171 that this is not intra encoded, the processing advances to step S177. In step S177, the motion prediction/compensation unit 123 obtains prediction mode information and the like from the lossless decoding unit 112.

In the event that the image which is an object processing is an image to be subjected to inter processing, the inter prediction mode information, reference frame information, and motion vector information, from the lossless decoding unit 112, is input to the motion prediction/compensation unit 123. In this case, in step S177 the motion prediction/compensation unit 123 obtains the inter prediction mode information, reference frame information, and motion vector information.

Then, in step S178, the motion prediction/compensation unit 123 determines whether or not the prediction mode information from the lossless decoding unit 112 is inter prediction mode information. In the event that determination is made in step S178 that inter prediction mode information, the processing advances to step S179.

In step S179, the motion prediction/compensation unit 123 performs inter motion prediction. That is to say, in the event that the image which is an object of processing is an image which is to be subjected to inter prediction processing, the necessary images are read out from the frame memory 119 and supplied to the motion prediction/compensation unit 123 via the switch 120. In step S179, the motion prediction/compensation unit 123 performs motion prediction in the inter prediction mode based on the motion vector obtained in step S177, and generates a prediction image. The generated prediction image is output to the switch 126.

On the other hand, in the event that inter template prediction mode information is obtained in step S177, in step S178 determination is made that this is not inter prediction mode information, and the processing advances to step S180.

In the event that the image which is an object of processing is an image to be subjected to inter template prediction processing, the necessary images are read out from the frame memory 119 and supplied to the inter TP motion prediction/compensation unit 124 via the switch 120 and motion prediction/compensation unit 123. The block address calculating unit 51 calculates the address of the object block which is the object of encoded within the macro block thereof, and supplies the information of the calculated address to the template pixel setting unit 125.

Based on the address information from the block address calculating unit 51, in step S180 the template pixel setting unit 125 performs template pixel setting processing as to the object block in the inter template prediction mode. Details of this template pixel setting processing are basically the same as the processing described above with reference to FIG. 30, so description thereof will be omitted. Due to this processing, pixels configuring a template as to an object block in the inter template prediction mode are set.

In step S181, the motion prediction unit 52 and motion compensation unit 53 perform motion prediction and compensation processing in the intra template prediction mode. That is to say, necessary images are input to the motion prediction unit 52 from the frame memory. Also, motion prediction unit 52 is input with the object block and reference block template information, set by the object block TP setting unit 62 and reference block TP setting unit 63.

The motion prediction unit 52 uses the input images to perform inter template prediction mode motion prediction, using the object block and reference block template pixel values set by the processing in step S180. At this time, the calculated motion vectors and reference images are supplied to the motion compensation unit 53. The motion compensation unit 53 uses the motion vectors calculated by the motion prediction unit 52 and reference images to perform motion compensation processing and generate a predicted image. The generated prediction image is output to the switch 126 via the motion prediction/compensation unit 123.

As described above, pixels adjacent to the macro block (sub-macro block) of the object block are constantly used as pixels configuring the template. Thus, processing for each block within the macro block (sub-macro block) can be realized by parallel processing or pipeline processing. Accordingly, the prediction efficiency in the template prediction mode can be improved.

While description has been made in the above description regarding a case where the block size of the object of processing in the template prediction mode is 8×8 pixels and a case of 4×4 pixels, but the scope of application of the present invention is not restricted to this.

That is to say, with regard to a case where the block size is 16×8 pixels or 8×16 pixels, parallel processing or pipeline processing can be performed within the macro block by performing processing the same as the example described above with reference to A in FIG. 8 through D in FIG. 8. Also, with regard to a case where the block size is 8×4 pixels or 4×8 pixels, parallel processing or pipeline processing can be performed within the macro block by performing processing the same as the example described above with reference to A in FIG. 10 through E in FIG. 10. Further, with regard to a case where the block size is 2×2 pixels, 2×4 pixels, or 4×2 pixels, parallel processing or pipeline processing can be performed within the 4×4 pixel block by performing processing the same as within a 4×4 pixel block.

Note that in all cases described above, the template used in the reference block is one at the same relative position as that in the object block. Also, the present invention is not restricted to luminance signals and can also be applied to color difference signals.

Further, while an example of processing within the macro block in raster scan order has been described in the above description, but the order of processing within the macro block may be other than in raster scan order.

Note that while description has been made in the above description regarding a case in which the size of a macro block is 16×16 pixels, the present invention is applicable to extended macro block sizes described in “Video Coding Using Extended Block Sizes”, VCEG-AD09, ITU-Telecommunications Standardization Sector STUDY GROUP Question 16-Contribution 123, January 2009.

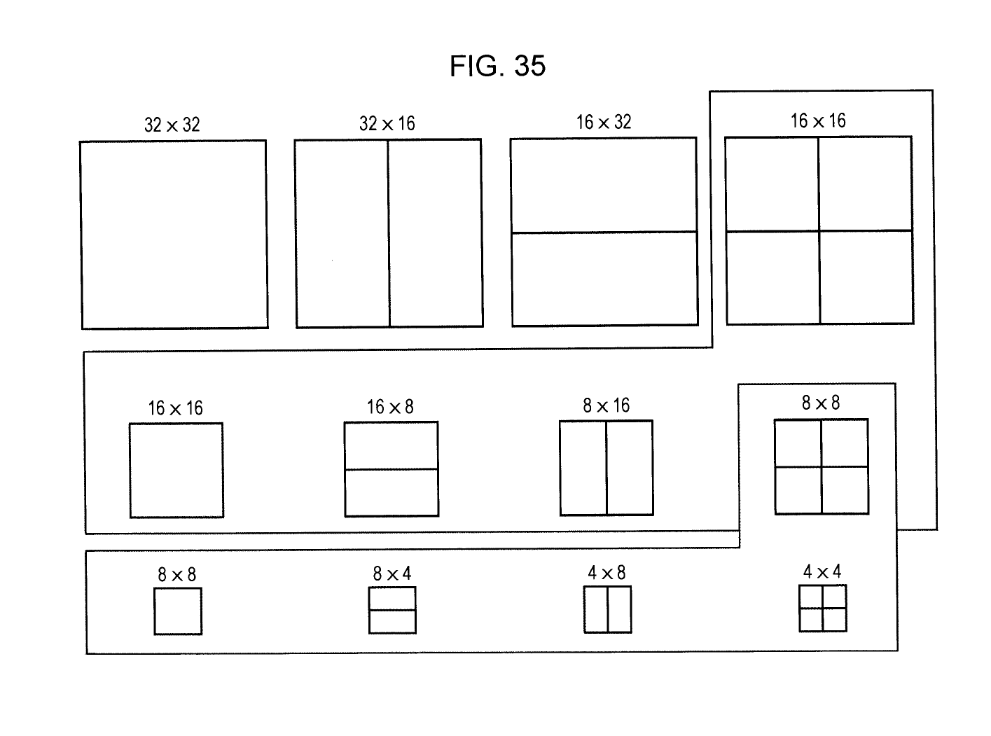

FIG. 35 is a diagram illustrating an example of extended macro block sizes. With the above description, the macro block size is extended to 32×32 pixels.

Shown in order at the upper tier in FIG. 35 are macro blocks configured of 32×32 pixels that have been divided into blocks (partitions) of, from the left, 32×32 pixels, 32×16 pixels, 16×32 pixels, and 16×16 pixels. Shown at the middle tier in FIG. 35 are macro blocks configured of 16×16 pixels that have been divided into blocks (partitions) of, from the left, 16×16 pixels, 16×8 pixels, 8×16 pixels, and 8×8 pixels. Shown at the lower tier in FIG. 35 are macro blocks configured of 8×8 pixels that have been divided into blocks (partitions) of, from the left, 8×8 pixels, 8×4 pixels, 4×8 pixels, and 4×4 pixels.

That is to say, macro blocks of 32×32 pixels can be processed as blocks of 32×32 pixels, 32×16 pixels, 16×32 pixels, and 16×16 pixels, shown in the upper tier in FIG. 35.

Also, the 16×16 pixel block shown to the right side of the upper tier can be processed as blocks of 16×16 pixels, 16×8 pixels, 8×16 pixels, and 8×8 pixels, shown in the middle tier, in the same way as with the H.264/AVC format.

Further, the 8×8 pixel block shown to the right side of the middle tier can be processed as blocks of 8×8 pixels, 8×4 pixels, 4×8 pixels, and 4×4 pixels, shown in the lower tier, in the same way as with the H.264/AVC format.

By employing such a hierarchical structure, with the extended macro block sizes, compatibility with the H.264/AVC format regarding 16×16 pixel and smaller blocks is maintained, while defining larger blocks as a superset thereof.

The present invention can also be applied to extended macro block sizes as proposed above.

Also, while description has been made using the H.264/AVC format as an encoding format, other encoding formats/decoding formats may be used.

Note that the present invention may be applied to image encoding devices and image decoding devices at the time of receiving image information (bit stream) compressed by orthogonal transform and motion compensation such as discrete cosine transform or the like, as with MPEG, H.26×, or the like for example, via network media such as satellite broadcasting, cable television, the Internet, and cellular telephones or the like. Also, the present invention can be applied to image encoding devices and image decoding devices used for processing on storage media such as optical or magnetic discs, flash memory, and so forth. Moreover, the present invention can be applied to motion prediction compensation devices included in these image encoding devices and image decoding devices and so forth.

The above-described series of processing may be executed by hardware, or may be executed by software. In the event that the series of processing is to be executed by software, the program making up the software is installed from a program recording medium to a computer built into dedicated hardware, or a general-purpose personal computer capable of executing various types of functions by installing various types of programs, for example.

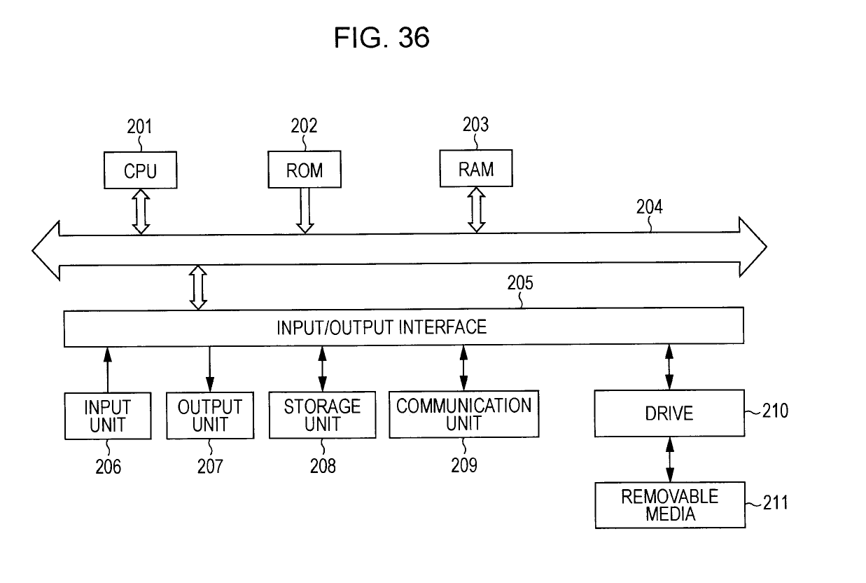

FIG. 36 is a block diagram illustrating a configuration example of hardware of a computer for executing the above-described series of processing by a program.

With the computer, CPU (Central Processing Unit) 201, ROM (Read Only Memory) 202, and RAM (Random Access Memory) 203 are mutually connected by a bus 204. An input/output interface 205 is further connected to the bus 204. Connected to the input/output interface 205 are an input unit 206, output unit 207, storage unit 208, communication unit 209, and drive 210.

The input unit 206 is made up of a keyboard, mouse microphone, and so forth. The output unit 207 is made up of a display, speaker, and so forth. The storage unit 208 is made up of a hard disk, nonvolatile memory, and so forth. The communication unit 209 is made up of a network interface and so forth. The drive 210 drives removable media 211 such as a magnetic disc, optical disc, magneto-optical disc, or semiconductor memory and so forth.

The above-described series of processing is performed with the computer configured as described above by the CPU 201 loading, for example, a program stored in the storage unit 208, to the RAM 203 via the input/output interface 205 and bus 204, and executing.

The program which the computer (CPU 201) executes can be recorded in removable media 211 as packaged media or the like for example, and provided. Also, the program can be provided via cable or wireless communication media such as local area networks, the Internet, digital satellite broadcasting, and so forth.

At the computer the program can be installed into the storage unit 208 via the input/output interface 205 by the removable media 211 being mounted to the drive 210. Also, the program may be received at the communication unit 209 via cable or wireless communication media, and installed to the storage unit 208. Besides this, the program can be installed in the ROM 202 or storage unit 208 beforehand.

Note that the program which the computer executes may be a program in which processing is performed in time-sequence following the order described in the Present Specification, or may be a program in which processing is performed in parallel, or at a necessary timing such as when a call-up is performed or the like.

Embodiments of the present invention are not restricted to the above-described embodiments, and that various modifications may be made without departing from the essence of the present invention.

For example, the above-described image encoding device 1 and image decoding device 101 can be applied to an optional electronic device. An example of this will be described next.

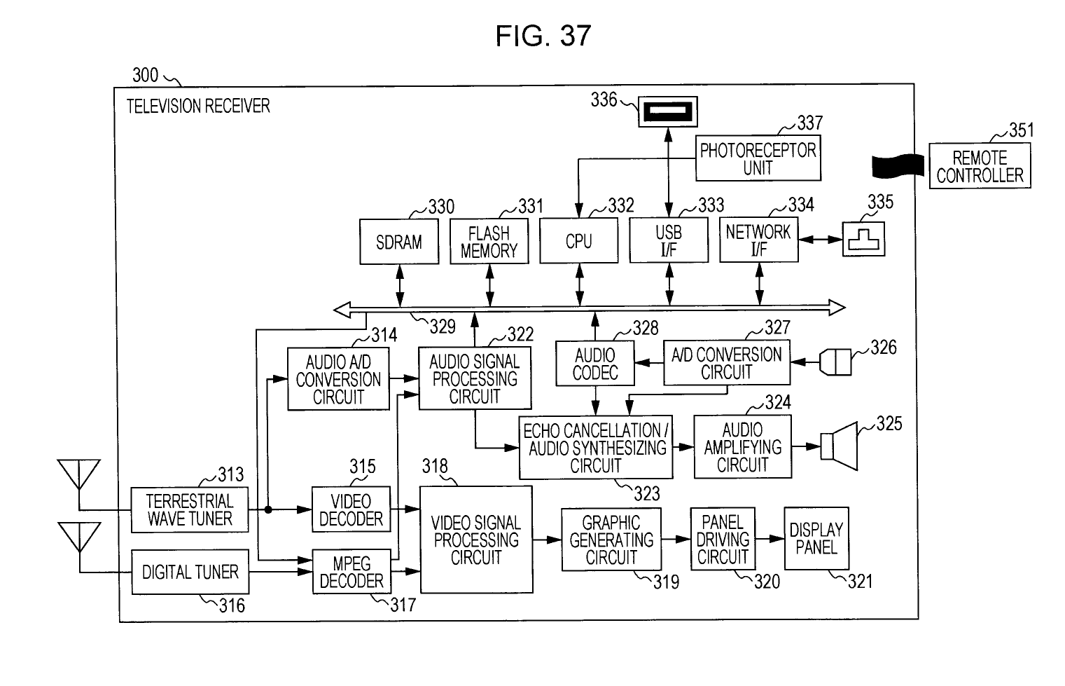

FIG. 37 is a block diagram illustrating a primary configuration example of a television receiver using an image decoding device to which the present invention has been applied.

A television receiver 300 shown in FIG. 37 includes a terrestrial wave tuner 313, a video decoder 315, a video signal processing circuit 318, a graphics generating circuit 319, a panel driving circuit 320, and a display panel 321.

The terrestrial wave tuner 313 receives broadcast wave signals of terrestrial analog broadcasting via an antenna and demodulates these, and obtains video signals which are supplied to the video decoder 315. The video decoder 315 subjects the video signals supplied from the terrestrial wave tuner 313 to decoding processing, and supplies the obtained digital component signals to the video signal processing circuit 318.

The video signal processing circuit 318 subjects the video data supplied from the video decoder 315 to predetermined processing such as noise reduction and so forth, and supplies the obtained video data to the graphics generating circuit 319.

The graphics generating circuit 319 generates video data of a program to be displayed on the display panel 321, image data by processing based on applications supplied via network, and so forth, and supplies the generated video data and image data to the panel driving circuit 320. Also, the graphics generating circuit 319 performs processing such as generating video data (graphics) for displaying screens to be used by users for selecting items and so forth, and supplying video data obtained by superimposing this on the video data of the program to the panel driving circuit 320, as appropriate.

The panel driving circuit 320 drives the display panel 321 based on data supplied from the graphics generating circuit 319, and displays video of programs and various types of screens described above on the display panel 321.

The display panel 321 is made up of an LCD (Liquid Crystal Display) or the like, and displays video of programs and so forth following control of the panel driving circuit 320.

Also, the television receiver 300 also has an audio A/D (Analog/Digital) conversion circuit 314, audio signal processing circuit 322, echo cancellation/audio synthesizing circuit 323, audio amplifying circuit 324, and speaker 325.

The terrestrial wave tuner 313 obtains not only video signals but also audio signals by demodulating the received broadcast wave signals. The terrestrial wave tuner 313 supplies the obtained audio signals to the audio A/D conversion circuit 314.

The audio A/D conversion circuit 314 subjects the audio signals supplied from the terrestrial wave tuner 313 to A/D conversion processing, and supplies the obtained digital audio signals to the audio signal processing circuit 322.

The audio signal processing circuit 322 subjects the audio data supplied from the audio A/D conversion circuit 314 to predetermined processing such as noise removal and so forth, and supplies the obtained audio data to the echo cancellation/audio synthesizing circuit 323.

The echo cancellation/audio synthesizing circuit 323 supplies the audio data supplied from the audio signal processing circuit 322 to the audio amplifying circuit 324.

The audio amplifying circuit 324 subjects the audio data supplied from the echo cancellation/audio synthesizing circuit 323 to D/A conversion processing and amplifying processing, and adjustment to a predetermined volume, and then audio is output from the speaker 325.

Further, the television receiver 300 also includes a digital tuner 316 and MPEG decoder 317.

The digital tuner 316 receives broadcast wave signals of digital broadcasting (terrestrial digital broadcast, BS (Broadcasting Satellite)/CS (Communications Satellite) digital broadcast) via an antenna, demodulates, and obtains MPEG-TS (Moving Picture Experts Group-Transport Stream), which is supplied to the MPEG decoder 317.

The MPEG decoder 317 unscrambles the scrambling to which the MPEG-TS supplied from the digital tuner 316 had been subjected to, and extracts a stream including data of a program to be played (to be viewed and listened to). The MPEG decoder 317 decodes audio packets making up the extracted stream, supplies the obtained audio data to the audio signal processing circuit 322, and also decodes video packets making up the stream and supplies the obtained video data to the video signal processing circuit 318. Also, the MPEG decoder 317 supplies EPG (Electronic Program Guide) data extracted from the MPEG-TS to the CPU 332 via an unshown path.

The television receiver 300 uses the above-described image decoding device 101 as the MPEG decoder 317 to decode video packets in this way. Accordingly, in the same way as with the case of the image decoding device 101, the MPEG decoder 317 constantly can use pixels adjacent to the macro block of the object block as a template. Accordingly, processing as to blocks within a macro block can be realized by parallel processing or pipeline processing and processing efficiency within the macro block can be improved.

The video data supplied from the MPEG decoder 317 is subjected to predetermined processing at the video signal processing circuit 318, in the same way as with the case of the video data supplied from the video decoder 315. The video data subjected to predetermined processing is then superimposed with generated video data as appropriate at the graphics generating circuit 319, supplied to the display panel 321 by way of the panel driving circuit 320, and the image is displayed.

The audio data supplied from the MPEG decoder 317 is subjected to predetermined processing at the audio signal processing circuit 322, in the same way as with the audio data supplied from the audio A/D conversion circuit 314. The audio data subjected to the predetermined processing is then supplied to the audio amplifying circuit 324 via the echo cancellation/audio synthesizing circuit 323, and is subjected to D/A conversion processing and amplification processing. As a result, audio adjusted to a predetermined volume is output from the speaker 325.

Also, the television receiver 300 also has a microphone 326 and an A/D conversion circuit 327.

The A/D conversion circuit 327 receives signals of audio from the user, collected by the microphone 326 provided to the television receiver 300 for voice conversation. The A/D conversion circuit 327 subjects the received audio signals to A/D conversion processing, and supplies the obtained digital audio data to the echo cancellation/audio synthesizing circuit 323.

In the event that the audio data of the user (user A) of the television receiver 300 is supplied from the A/D conversion circuit 327, the echo cancellation/audio synthesizing circuit 323 performs echo cancellation on the audio data of the user A. Following echo cancellation, the echo cancellation/audio synthesizing circuit 323 outputs the audio data obtained by synthesizing with other audio data and so forth, to the speaker 325 via the audio amplifying circuit 324.

Further, the television receiver 300 also has an audio codec 328, an internal bus 329, SDRAM (Synchronous Dynamic Random Access Memory) 330, flash memory 331, a CPU 332, a USB (Universal Serial Bus) I/F 333, and a network I/F 334.

The A/D conversion circuit 327 receives audio signals of the user input by the microphone 326 provided to the television receiver 300 for voice conversation. The A/D conversion circuit 327 subjects the received audio signals to A/D conversion processing, and supplies the obtained digital audio data to the audio codec 328.

The audio codec 328 converts the audio data supplied from the A/D conversion circuit 327 into data of a predetermined format for transmission over the network, and supplies to the network I/F 334 via the internal bus 329.

The network I/F 334 is connected to a network via a cable connected to a network terminal 335. The network I/F 334 transmits audio data supplied from the audio codec 328 to another device connected to the network, for example. Also, the network I/F 334 receives audio data transmitted from another device connected via the network by way of the network terminal 335, and supplies this to the audio codec 328 via the internal bus 329.

The audio codec 328 converts the audio data supplied from the network I/F 334 into data of a predetermined format, and supplies this to the echo cancellation/audio synthesizing circuit 323.

The echo cancellation/audio synthesizing circuit 323 performs echo cancellation on the audio data supplied from the audio codec 328, and outputs audio data obtained by synthesizing with other audio data and so forth from the speaker 325 via the audio amplifying circuit 324.

The SDRAM 330 stores various types of data necessary for the CPU 332 to perform processing.

The flash memory 331 stores programs to be executed by the CPU 332. Programs stored in the flash memory 331 are read out by the CPU 332 at a predetermined timing, such as at the time of the television receiver 300 starting up. The flash memory 331 also stores EPG data obtained by way of digital broadcasting, data obtained from a predetermined server via the network, and so forth.

For example, the flash memory 331 stores MPEG-TS including content data obtained from a predetermined server via the network under control of the CPU 332. The flash memory 331 supplies the MPEG-TS to a MPEG decoder 317 via the internal bus 329, under control of the CPU 332, for example.

The MPEG decoder 317 processes the MPEG-TS in the same way as with an MPEG-TS supplied from the digital tuner 316. In this way, with the television receiver 300, content data made up of video and audio and the like is received via the network and decoded using the MPEG decoder 317, whereby the video can be displayed and the audio can be output.

Also, the television receiver 300 also has a photoreceptor unit 337 for receiving infrared signals transmitted from a remote controller 351.

The photoreceptor unit 337 receives the infrared rays from the remote controller 351, and outputs control code representing the contents of user operations obtained by demodulation thereof to the CPU 332.

The CPU 332 executes programs stored in the flash memory 331 to control the overall operations of the television receiver 300 in accordance with control code and the like supplied from the photoreceptor unit 337. The CPU 332 and the parts of the television receiver 300 are connected via an unshown path.

The USB I/F 333 performs exchange of data with external devices from the television receiver 300 that are connected via a USB cable connected to the USB terminal 336. The network I/F 334 connects to the network via a cable connected to the network terminal 335, and exchanges data other than audio data with various types of devices connected to the network.

The television receiver 300 can improve predictive accuracy by using the image decoding device 101 as the MPEG decoder 317. As a result, the television receiver 300 can obtain and display higher definition decoded images from broadcasting signals received via the antenna and content data obtained via the network.

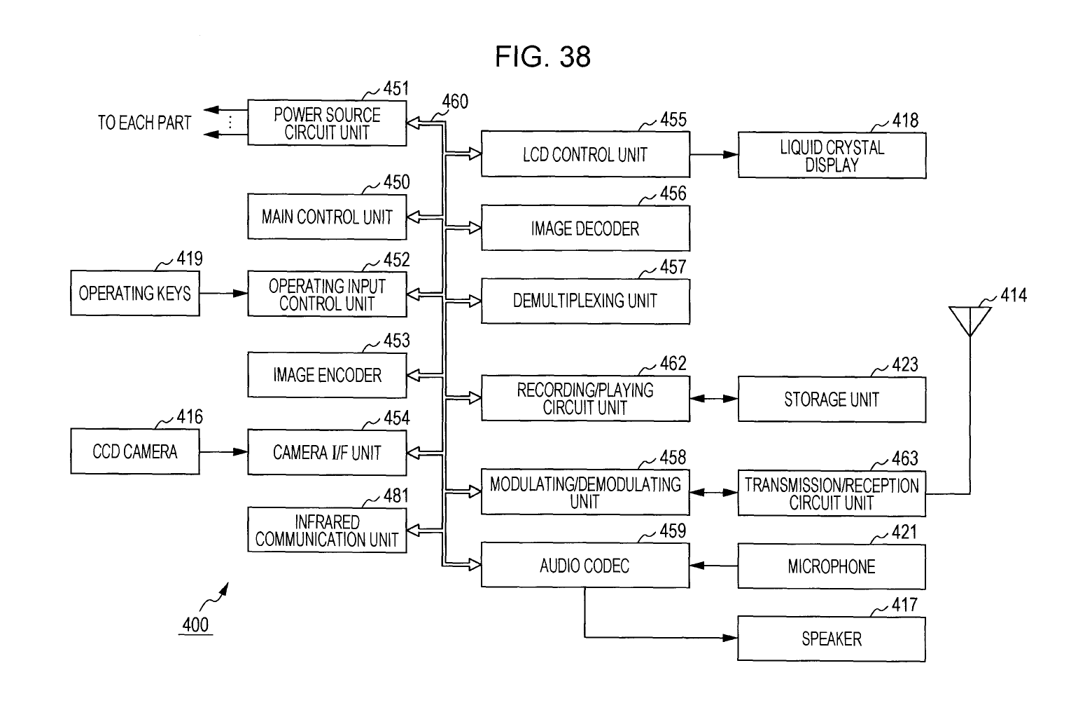

FIG. 38 is a block diagram illustrating an example of the principal configuration of a cellular telephone using the image encoding device and image decoding device to which the present invention has been applied.

A cellular telephone 400 illustrated in FIG. 38 includes a main control unit 450 arranged to centrally control each part, a power source circuit unit 451, an operating input control unit 452, an image encoder 453, a camera I/F unit 454, an LCD control unit 455, an image decoder 456, a demultiplexing unit 457, a recording/playing unit 462, a modulating/demodulating unit 458, and an audio codec 459. These are mutually connected via a bus 460.

Also, the cellular telephone 400 has operating keys 419, a CCD (Charge Coupled Device) camera 416, a liquid crystal display 418, a storage unit 423, a transmission/reception circuit unit 463, an antenna 414, a microphone (mike) 421, and a speaker 417.

The power source circuit unit 451 supplies electric power from a battery pack to each portion upon an on-hook or power key going to an on state by user operations, thereby activating the cellular telephone 400 to an operable state.

The cellular telephone 400 performs various types of operations such as exchange of audio signals, exchange of email and image data, image photography, data recording, and so forth, in various types of modes such as audio call mode, data communication mode, and so forth, under control of the main control unit 450 made up of a CPU, ROM, and RAM.

For example, in an audio call mode, the cellular telephone 400 converts audio signals collected at the microphone (mike) 421 into digital audio data by the audio codec 459, performs spread spectrum processing thereof at the modulating/demodulating unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (audio signals) transmitted to the base station are supplied to a cellular telephone of the other party via a public telephone line network.

Also, for example, in the audio call mode, the cellular telephone 400 amplifies the reception signals received at the antenna 414 with the transmission/reception circuit unit 463, further performs frequency conversion processing and analog/digital conversion, and performs inverse spread spectrum processing at the modulating/demodulating unit 458, and converts into analog audio signals by the audio codec 459. The cellular telephone 400 outputs the analog audio signals obtained by this conversion from the speaker 417.

Further, in the event of transmitting email in the data communication mode for example, the cellular telephone 400 accepts text data of the email input by operations of the operating keys 419 at the operating input control unit 452. The cellular telephone 400 processes the text data at the main control unit 450, and displays this as an image on the liquid crystal display 418 via the LCD control unit 455.

Also, at the main control unit 450, the cellular telephone 400 generates email data based on text data which the operating input control unit 452 has accepted and user instructions and the like. The cellular telephone 400 performs spread spectrum processing of the email data at the modulating/demodulating unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (email) transmitted to the base station are supplied to the predetermined destination via a network, mail server, and so forth.

Also, for example, in the event of receiving email in data communication mode, the cellular telephone 400 receives and amplifies signals transmitted from the base station with the transmission/reception circuit unit 463 via the antenna 414, further performs frequency conversion processing and analog/digital conversion processing. The cellular telephone 400 performs inverse spread spectrum processing at the modulating/demodulating circuit unit 458 on the received signals to restore the original email data. The cellular telephone 400 displays the restored email data in the liquid crystal display 418 via the LCD control unit 455.

Note that the cellular telephone 400 can also record (store) the received email data in the storage unit 423 via the recording/playing unit 462.

The storage unit 423 may be any rewritable storage medium. The storage unit 423 may be semiconductor memory such as RAM or built-in flash memory or the like, or may be a hard disk, or may be removable media such as a magnetic disk, magneto-optical disk, optical disc, USB memory, or memory card or the like, and of course, be something other than these.

Further, in the event of transmitting image data in the data communication mode for example, the cellular telephone 400 generates image data with the CCD camera 416 by imaging. The CCD camera 416 has an optical device such as a lens and diaphragm and the like, and a CCD as a photoelectric conversion device, to image a subject, convert the intensity of received light into electric signals, and generate image data of an image of the subject. The image data is converted into encoded image data by performing compressing encoding by a predetermined encoding method such as MPEG2 or MPEG4 for example, at the image encoder 453, via the camera I/F unit 454.

The cellular telephone 400 uses the above-described image encoding device 1 as the image encoder 453 for performing such processing. Accordingly, as with the case of the image encoding device 1, the image encoder 453 constantly can use pixels adjacent to the macro block of the object block as a template. Accordingly, processing as to blocks within a macro block can be realized by parallel processing or pipeline processing and processing efficiency within the macro block can be improved.

Note that at the same time as this, the cellular telephone 400 subjects the audio collected with the microphone (mike) 421 during imaging with the CCD camera 416 to analog/digital conversion at the audio codec 459, and further encodes.

At the demultiplexing unit 457, the cellular telephone 400 multiplexes the encoded image data supplied from the image encoder 453 and the digital audio data supplied from the audio codec 459, with a predetermined method. The cellular telephone 400 subjects the multiplexed data obtained as a result thereof to spread spectrum processing at the modulating/demodulating circuit unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (image data) transmitted to the base station are supplied to the other party of communication via a network and so forth.

Note that, in the event of not transmitting image data, the cellular telephone 400 can display the image data generated at the CCD camera 416 on the liquid crystal display 418 via the LCD control unit 455 without going through the image encoder 453.

Also, for example, in the event of receiving data of a moving image file linked to a simple home page or the like, the cellular telephone 400 receives the signals transmitted from the base station with the transmission/reception circuit unit 463 via the antenna 414, amplifies these, and further performs frequency conversion processing and analog/digital conversion processing. The cellular telephone 400 performs inverse spread spectrum processing of the received signals at the modulating/demodulating unit 458 to restore the original multiplexed data. The cellular telephone 400 separates the multiplexed data at the demultiplexing unit 457, and divides into encoded image data and audio data.

At the image decoder 456, the cellular telephone 400 decodes the encoded image data with a decoding method corresponding to the predetermined encoding method such as MPEG2 or MPEG4 or the like, thereby generating playing moving image data, which is displayed on the liquid crystal display 418 via the LCD control unit 455. Thus, the moving image data included in the moving image file linked to the simple home page, for example, is displayed on the liquid crystal display 418.

The cellular telephone 400 uses the above-described image decoding device 101 as an image decoder 456 for performing such processing. Accordingly, in the same way as with the image decoding device 101, the image decoder 456 constantly can use pixels adjacent to the macro block of the object block as a template. Accordingly, processing as to blocks within a macro block can be realized by parallel processing or pipeline processing and processing efficiency within the macro block can be improved.

At this time, the cellular telephone 400 converts the digital audio data into analog audio signals at the audio codec 459 at the same time, and outputs this from the speaker 417. Thus, audio data included in the moving image file linked to the simple home page, for example, is played.

Note that, in the same way as with the case of email, the cellular telephone 400 can also record (store) the data linked to the received simple homepage or the like in the storage unit 423 via the recording/playing unit 462.

Also, the cellular telephone 400 can analyze two-dimensional code obtained by being taken with the CCD camera 416 at the main control unit 450, so as to obtain information recorded in the two-dimensional code.

Further, the cellular telephone 400 can communicate with an external device by infrared rays with an infrared communication unit 481.

By using the image encoding device 1 as the image encoder 453, the cellular telephone 400 can, for example, improve the encoding efficiency of encoded data generated by encoding the image data generated at the CCD camera 416. As a result, the cellular telephone 400 can provide encoded data (image data) with good encoding efficiency to other devices.

Also, using the image encoding device 101 as the image encoder 456, the cellular telephone 400 can generate prediction images with high precision. As a result, the cellular telephone 400 can obtain and display decoded images with higher definition from a moving image file linked to a simple home page, for example.

Note that while the cellular telephone 400 has been described above so as to use a CCD camera 416, an image sensor (CMOS image sensor) using a CMOS (Complementary Metal Oxide Semiconductor) may be used instead of the CCD camera 416. In this case as well, the cellular telephone 400 can image subjects and generate image data of images of the subject, in the same way as with using the CCD camera 416.

Also, while the above description has been made with a cellular telephone 400, the image encoding device 1 and image decoding device 101 can be applied to any device in the same way as with the cellular telephone 400, as long as the device has imaging functions and communication functions the same as with the cellular telephone 400, such as for example, a PDA (Personal Digital Assistants), smart phone, UMPC (Ultra Mobile Personal Computer), net book, laptop personal computer, or the like.

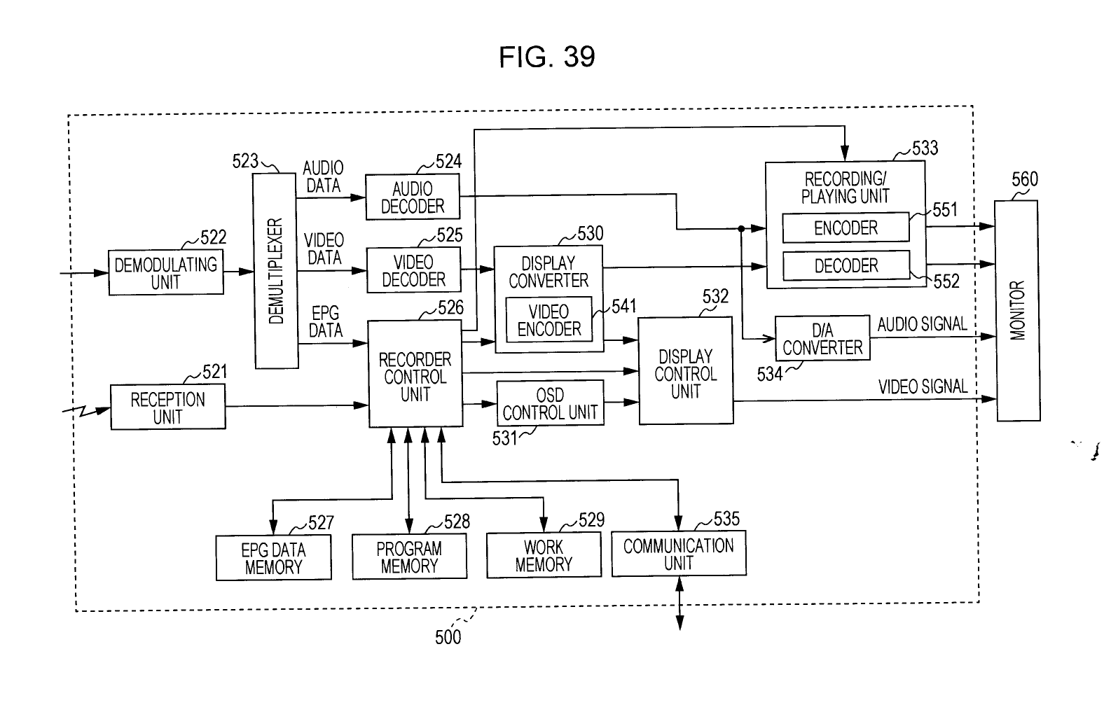

FIG. 39 is a block diagram illustrating an example of a primary configuration of a hard disk recorder using the image encoding device and image decoding device to which the present invention has been applied.

The hard disk recorder (HDD recorder) 500 shown in FIG. 39 is a device which saves audio data and video data included in a broadcast program included in broadcast wave signals (television signals) transmitted from a satellite or terrestrial antenna or the like, that have been received by a tuner, in a built-in hard disk, and provides the saved data to the user at an instructed timing.

The hard disk recorder 500 can extract the audio data and video data from broadcast wave signals for example, decode these as appropriate, and store in the built-in hard disk. Also, the hard disk recorder 500 can, for example, obtain audio data and video data from other devices via a network, decode these as appropriate, and store in the built-in hard disk.

Further, for example, the hard disk recorder 500 decodes the audio data and video data recorded in the built-in hard disk and supplies to a monitor 560, so as to display the image on the monitor 560. Also, the hard disk recorder 500 can output the audio thereof from the speaker of the monitor 560.

The hard disk recorder 500 can also, for example, decode and supply audio data and video data extracted from broadcast wave signals obtained via the tuner, or audio data and video data obtained from other devices via the network, to the monitor 560, so as to display the image on the monitor 560. Also, the hard disk recorder 500 can output the audio thereof from the speaker of the monitor 560.

Of course, other operations can be performed as well.

As shown in FIG. 39, the hard disk recorder 500 has a reception unit 521, demodulating unit 522, demultiplexer 523, audio decoder 524, video decoder 525, and recorder control unit 526. The hard disk recorder 500 further has EPG data memory 527, program memory 528, work memory 529, a display converter 530, an OSD (On Screen Display) control unit 531, a display control unit 532, a recording/playing unit 533, a D/A converter 534, and a communication unit 535.

Also, the display converter 530 has a video encoder 541. The recording/playing unit 533 has an encoder 551 and decoder 552.

The reception unit 521 receives infrared signals from a remote controller (not shown), converts into electric signals, and outputs to the recorder control unit 526. The recorder control unit 526 is configured of a microprocessor or the like, for example, and executes various types of processing following programs stored in the program memory 528. The recorder control unit 526 uses the work memory 529 at this time as necessary.

The communication unit 535 is connected to a network, and performs communication processing with other devices via the network. For example, the communication unit 535 is controlled by the recorder control unit 526 to communicate with a tuner (not shown) and primarily output channel tuning control signals to the tuner.

The demodulating unit 522 demodulates the signals supplied from the tuner, and outputs to the demultiplexer 523. The demultiplexer 523 divides the data supplied from the demodulating unit 522 into audio data, video data, and EPG data, and outputs these to the audio decoder 524, video decoder 525, and recorder control unit 526, respectively.

The audio decoder 524 decodes the input audio data by the MPEG format for example, and outputs to the recording/playing unit 533. The video decoder 525 decodes the input video data by the MPEG format for example, and outputs to the display converter 530. The recorder control unit 526 supplies the input EPG data to the EPG data memory 527 so as to be stored.

The display converter 530 encodes video data supplied from the video decoder 525 or the recorder control unit 526 into NTSC (National Television Standards Committee) format video data with the video encoder 541 for example, and outputs to the recording/playing unit 533. Also, the display converter 530 converts the size of the screen of the video data supplied from the video decoder 525 or the recorder control unit 526 to a size corresponding to the size of the monitor 560. The display converter 530 further converts the video data of which the screen size has been converted into NTSC video data by the video encoder 541, performs conversion into analog signals, and outputs to the display control unit 532.

Under control of the recorder control unit 526, the display control unit 532 superimposes OSD signals output from the OSD (On Screen Display) control unit 531 into video signals input from the display converter 530, and outputs to the display of the monitor 560 to be displayed.

The monitor 560 is also supplied with the audio data output from the audio decoder 524 that has been converted into analog signals by the D/A converter 534. The monitor 560 can output the audio signals from a built-in speaker.

The recording/playing unit 533 has a hard disk as a storage medium for recording video data and audio data and the like.

The recording/playing unit 533 encodes the audio data supplied from the audio decoder 524 for example, with the MPEG format by the encoder 551. Also, the recording/playing unit 533 encodes the video data supplied from the video encoder 541 of the display converter 530 with the MPEG format by the encoder 551. The recording/playing unit 533 synthesizes the encoded data of the audio data and the encoded data of the video data with a multiplexer. The recording/playing unit 533 performs channel coding of the synthesized data and amplifies this, and writes the data to the hard disk via a recording head.

The recording/playing unit 533 plays the data recorded in the hard disk via the recording head, amplifies, and separates into audio data and video data with a demultiplexer. The recording/playing unit 533 decodes the audio data and video data with the MPEG format by the decoder 552. The recording/playing unit 533 performs D/A conversion of the decoded audio data, and outputs to the speaker of the monitor 560. Also, the recording/playing unit 533 performs D/A conversion of the decoded video data, and outputs to the display of the monitor 560.

The recorder control unit 526 reads out the newest EPG data from the EPG data memory 527 based on user instructions indicated by infrared ray signals from the remote controller received via the reception unit 521, and supplies these to the OSD control unit 531. The OSD control unit 531 generates image data corresponding to the input EPG data, which is output to the display control unit 532. The display control unit 532 outputs the video data input from the OSD control unit 531 to the display of the monitor 560 so as to be displayed. Thus, an EPG (electronic program guide) is displayed on the display of the monitor 560.

Also, the hard disc recorder 500 can obtain various types of data supplied from other devices via a network such as the Internet, such as video data, audio data, EPG data, and so forth.

The communication unit 535 is controlled by the recorder control unit 526 to obtain encoded data such as video data, audio data, EPG data, and so forth, transmitted from other devices via the network, and supplies these to the recorder control unit 526. The recorder control unit 526 supplies the obtained encoded data of video data and audio data to the recording/playing unit 533 for example, and stores in the hard disk. At this time, the recorder control unit 526 and recording/playing unit 533 may perform processing such as re-encoding or the like, as necessary.

Also, the recorder control unit 526 decodes the encoded data of the video data and audio data that has been obtained, and supplies the obtained video data to the display converter 530. The display converter 530 processes video data supplied from the recorder control unit 526 in the same way as with video data supplied from the video decoder 525, supplies this to the monitor 560 via the display control unit 532, and displays the image thereof.

Also, an arrangement may be made wherein the recorder control unit 526 supplies the decoded audio data to the monitor 560 via the D/A converter 534 along with this image display, so that the audio is output from the speaker.

Further, the recorder control unit 526 decodes encoded data of the obtained EPG data, and supplies the decoded EPG data to the EPG data memory 527.

The hard disk recorder 500 such as described above uses the image decoding device 101 as the video decoder 525, decoder 552, and a decoder built into the recorder control unit 526. Accordingly, in the same way as with the image decoding device 101, the video decoder 525, decoder 552, and a decoder built into the recorder control unit 526 constantly can use pixels adjacent to the macro block of the object block as a template. Accordingly, processing as to blocks within a macro block can be realized by parallel processing or pipeline processing and processing efficiency within the macro block can be improved.

Accordingly, the hard disk recorder 500 can generate prediction images with high precision, with improved processing efficiency. As a result, the hard disk recorder 500 can obtain decoded images with higher definition from, for example, encoded data of video data received via a tuner, encoded data of video data read out from the hard disk of the recording/playing unit 533, and encoded data of video data obtained via the network, and display this on the monitor 560.

Also, the hard disk recorder 500 uses the image encoding device 1 as the image encoder 551. Accordingly, as with the case of the image encoding device 1, the encoder 551 constantly can use pixels adjacent to the macro block of the object block as a template. Accordingly, processing as to blocks within a macro block can be realized by parallel processing or pipeline processing and processing efficiency within the macro block can be improved.

Accordingly, with the hard disk recorder 500, the encoding efficiency of encoded data to be recorded in the hard disk, for example, can be improved. As a result, the hard disk recorder 500 can use the storage region of the hard disk more efficiently.

While description has been made above regarding a hard disk recorder 500 which records video data and audio data in a hard disk, it is needless to say that the recording medium is not restricted in particular. For example, the image encoding device 1 and image decoding device 101 can be applied in the same way as with the case of the hard disk recorder 500 for recorders using recording media other than an hard disk, such as flash memory, optical discs, videotapes, or the like.

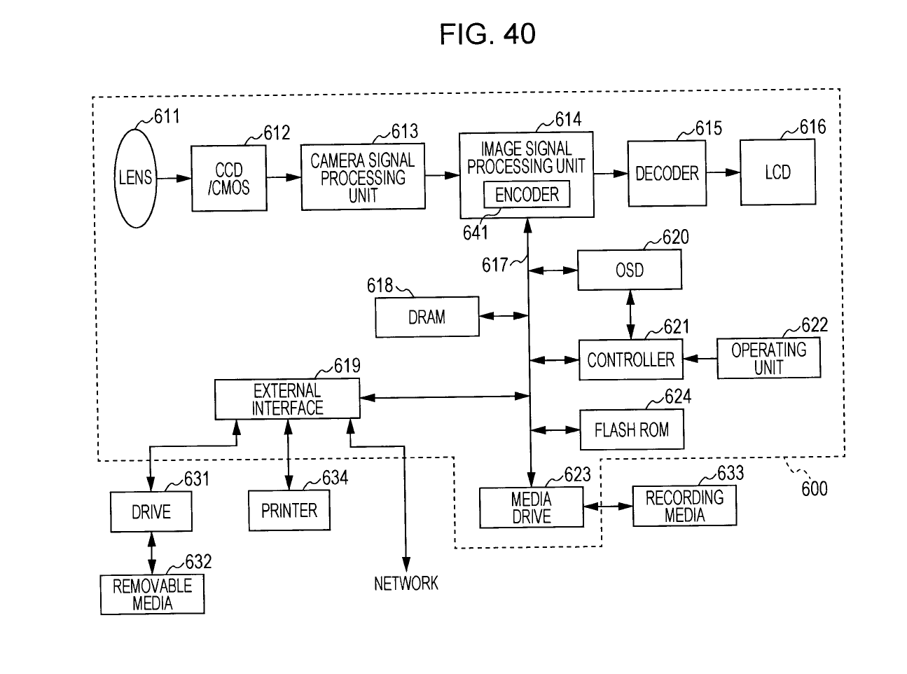

FIG. 40 is a block diagram illustrating an example of a primary configuration of a camera using the image decoding device and image encoding device to which the present invention has been applied.

A camera 600 shown in FIG. 40 images a subject and displays images of the subject on an LCD 616 or records this as image data in recording media 633.

A lens block 611 inputs light (i.e., an image of a subject) to a CCD/CMOS 612. The CCD/CMOS 612 is an image sensor using a CCD or a CMOS, which converts the intensity of received light into electric signals, and supplies these to a camera signal processing unit 613.

The camera signal processing unit 613 converts the electric signals supplied from the CCD/CMOS 612 into color different signals of Y, Cr, Cb, and supplies these to an image signal processing unit 614. The image signal processing unit 614 performs predetermined image processing on the image signals supplied from the camera signal processing unit 613, or encodes the image signals according to the MPEG format for example, with an encoder 641, under control of the controller 621. The image signal processing unit 614 supplies the encoded data, generated by encoding the image signals, to a decoder 615. Further, the image signal processing unit 614 obtains display data generated in an on screen display (OSD) 620, and supplies this to the decoder 615.

In the above processing, the camera signal processing unit 613 uses DRAM (Dynamic Random Access Memory) 618 connected via a bus 617 as appropriate, so as to hold image data, encoded data obtained by encoding the image data, and so forth, in the DRAM 618.

The decoder 615 decodes the encoded data supplied from the image signal processing unit 614 and supplies the obtained image data (decoded image data) to the LCD 616. Also, the decoder 615 supplies the display data supplied from the image signal processing unit 614 to the LCD 616. The LCD 616 synthesizes the image of decoded image data supplied from the decoder 615 with an image of display data as appropriate, and displays the synthesized image.

Under control of the controller 621, the on screen display 620 outputs display data of menu screens made up of symbols, characters, and shapes, and icons and so forth, to the image signal processing unit 614 via the bus 617.

The controller 621 executes various types of processing based on signals indicating the contents which the user has instructed using an operating unit 622, and also controls the image signal processing unit 614, DRAM 618, external interface 619, on screen display 620, media drive 623, and so forth, via the bus 617. FLASH ROM 624 stores programs and data and the like necessary for the controller 621 to execute various types of processing.

For example, the controller 621 can encode image data stored in the DRAM 618 and decode encoded data stored in the DRAM 618, instead of the image signal processing unit 614 and decoder 615. At this time, the controller 621 may perform encoding/decoding processing by the same format as the encoding/decoding format of the image signal processing unit 614 and decoder 615, or may perform encoding/decoding processing by a format which the image signal processing unit 614 and decoder 615 do not handle.

Also, in the event that starting of image printing has been instructed from the operating unit 622 for example, the controller 621 reads out the image data from the DRAM 618, and supplies this to a printer 634 connected to the external interface 619 via the bus 617, so as to be printed.

Further, in the event that image recording has been instructed from the operating unit 622 for example, the controller 621 reads out the encoded data from the DRAM 618, and supplies this to recording media 633 mounted to the media drive 623 via the bus 617, so as to be stored.

The recording media 633 is any readable/writable removable media such as, for example, a magnetic disk, magneto-optical disk, optical disc, semiconductor memory, or the like. The recording media 633 is not restricted regarding the type of removable media as a matter of course, and may be a tape device, or may be a disk, or may be a memory card. Of course, this may be a non-contact IC card or the like as well.

Also, an arrangement may be made wherein the media drive 623 and recording media 633 are integrated so as to be configured of a non-detachable storage medium, as with a built-in hard disk drive or SSD (Solid State Drive), or the like.

The external interface 619 is configured of a USB input/output terminal or the like for example, and is connected to the printer 634 at the time of performing image printing. Also, a drive 631 is connected to the external interface 619 as necessary, with a removable media 632 such as a magnetic disk, optical disc, magneto-optical disk, or the like connected thereto, such that computer programs read out therefrom are installed in the FLASH ROM 624 as necessary.

Further, the external interface 619 has a network interface connected to a predetermined network such as a LAN or the Internet or the like. The controller 621 can read out encoded data from the DRAM 618 and supply this from the external interface 619 to another device connected via the network, following instructions from the operating unit 622. Also, the controller 621 can obtain encoded data and image data supplied from another device via the network by way of the external interface 619, so as to be held in the DRAM 618 or supplied to the image signal processing unit 614.

The camera 600 such as described above uses the image decoding device 101 as the decoder 615. Accordingly, in the same way as with the image decoding device 101, the decoder 615 constantly can use pixels adjacent to the macro block of the object block as a template. Accordingly, processing as to blocks within a macro block can be realized by parallel processing or pipeline processing and processing efficiency within the macro block can be improved.

Accordingly, the camera 600 can smoothly generate prediction images with high precision. As a result, the camera 600 can obtain decoded images with higher definition from, for example, image data generated at the CC/CMOS 612, encoded data of video data read out from the DRAM 618 or recording media 633, or encoded data of video data obtained via the network, so as to be displayed on the LCD 616.

Also, the camera 600 uses the image encoding device 1 as the encoder 641. Accordingly, as with the case of the image encoding device 1, the encoder 641 constantly can use pixels adjacent to the macro block of the object block as a template. Accordingly, processing as to blocks within a macro block can be realized by parallel processing or pipeline processing and processing efficiency within the macro block can be improved.

Accordingly, with the camera 600, the encoding efficiency of encoded data to be recorded in the hard disk, for example, can be improved. As a result, the camera 600 can use the storage region of the DRAM 618 and recording media 633 more efficiently.

Note that the decoding method of the image decoding device 101 may be applied to the decoding processing of the controller 621. In the same way, the encoding method of the image encoding device 1 may be applied to the encoding processing of the controller 621.

Also, the image data which the camera 600 images may be moving images, or may be still images.

Of course, the image encoding device 1 and image decoding device 101 are applicable to devices and systems other than the above-described devices.

### REFERENCE SIGNS LIST

1 image encoding device
16 lossless encoding unit
24 intra prediction unit
25 intra TP motion prediction/compensation unit
26 motion prediction/compensation unit
27 inter TP motion prediction/compensation unit
28 template pixel setting unit
41 block address calculating unit
42 motion prediction unit
43 motion compensation unit
51 block address calculation unit
52 motion prediction unit
53 motion compensation unit
61 block classification unit
62 object block template setting unit
63 reference block template setting unit
101 image decoding device
112 lossless encoding unit
121 intra prediction unit
122 intra template motion prediction/compensation unit
123 motion prediction/compensation unit
124 inter template motion prediction/compensation unit
125 template pixel setting unit
126 switch

1. An image processing device comprising:
template pixel setting means for setting pixels of a template used for calculation of a motion vector of a block configuring a predetermined block of an image, out of pixels adjacent to one of said blocks by a predetermined positional relation and also generated from a decoded image, in accordance to the address of said block within said predetermined block; and
template motion prediction compensation means for calculating a motion vector of said block, using said template made up of said pixels set by said template pixel setting means.

2. The image processing device according to claim 1, further comprising:
encoding means for encoding said block, using said motion vector calculated by said template motion prediction compensation means.

3. The image processing device according to claim 1, wherein said template pixel setting means set, for an upper left block situated at the upper left of said predetermined block, pixels adjacent to the left portion, upper portion, and upper left portion of said upper left block, as said template.

4. The image processing device according to claim 1, wherein said template pixel setting means set, for an upper right block situated at the upper right of said predetermined block, pixels adjacent to the upper portion and upper left portion of said upper right block, and pixels adjacent to the left portion of an upper left block situated to the upper left in said predetermined block, as said template.

5. The image processing device according to claim 1, wherein said template pixel setting means set, for a lower left block situated at the lower left of said predetermined block, pixels adjacent to the upper left portion and left portion of said lower left block, and pixels adjacent to the upper portion of an upper left block situated to the upper left in said predetermined block, as said template.

6. The image processing device according to claim 1, wherein said template pixel setting means set, for a lower right block situated at the lower right of said predetermined block, a pixel adjacent to the upper left portion of an upper left block situated at the upper left in said predetermined block, pixels adjacent to the upper portion of an upper right block situated at the upper right in said predetermined block, and pixels adjacent to the left portion of a lower left block situated at the lower left in said predetermined block, as said template.

7. The image processing device according to claim 1, wherein said template pixel setting means set, for a lower right block situated at the lower right of said predetermined block, pixels adjacent to the upper portion and upper left portion of an upper right block situated at the upper right in said predetermined block, and pixels adjacent to the left portion of a lower left block situated to the lower left in said predetermined block, as said template.

8. The image processing device according to claim 1, wherein said template pixel setting means set, for a lower right block situated at the lower right of said predetermined block, pixels adjacent to the upper portion of an upper right block situated at the upper right in said predetermined block, and pixels adjacent to the left portion and upper left portion of a lower left block situated to the lower left in said predetermined block, as said template.

9. An image processing method comprising the step of:
an image processing device
setting pixels of a template used for calculation of a motion vector of a block configuring a predetermined block of an image, out of pixels adjacent to one of said blocks by a predetermined positional relation, in accordance to the address of said block within said predetermined block, and
calculating the motion vector of said block, using said template made up of said pixels that have been set.

10. An image processing device comprising:
decoding means for decoding an image of an encoded block;
template pixel setting means for setting pixels of a template used for calculation of a motion vector of a block configuring a predetermined block of an image, out of pixels adjacent to one of said blocks by a predetermined positional relation and also generated from a decoded image, in accordance to the address of said block within said predetermined block;
template motion prediction means for calculating a motion vector of said block, using said template made up of said pixels set by said template pixel setting means; and
motion compensation means for generating a prediction image of said block, using said image decoded by said decoding means, and said motion vector calculated by said template motion prediction means.

11. The image processing device according to claim 10, wherein said template pixel setting means set, for an upper left block situated at the upper left of said predetermined block, pixels adjacent to the left portion, upper portion, and upper left portion of said upper left block, as said template.

12. The image processing device according to claim 10, wherein said template pixel setting means set, for an upper right block situated at the upper right of said predetermined block, pixels adjacent to the upper portion and upper left portion of said upper right block, and pixels adjacent to the left portion of an upper left block situated to the upper left in said predetermined block, as said template.

13. The image processing device according to claim 10, wherein said template pixel setting means set, for a lower left block situated at the lower left of said predetermined block, pixels adjacent to the upper left portion and left portion of said lower left block, and pixels adjacent to the upper portion of an upper left block situated to the upper left in said predetermined block, as said template.

14. The image processing device according to claim 10, wherein said template pixel setting means set, for a lower right block situated at the lower right of said predetermined block, a pixel adjacent to the upper left portion of an upper left block situated at the upper left in said predetermined block, pixels adjacent to the upper portion of an upper right block situated at the upper right in said predetermined block, and pixels adjacent to the left portion of a lower left block situated at the lower left in said predetermined block, as said template.

15. The image processing device according to claim 10, wherein said template pixel setting means set, for a lower right block situated at the lower right of said predetermined block, pixels adjacent to the upper portion and upper left portion of an upper right block situated at the upper right in said predetermined block, and pixels adjacent to the left portion of a lower left block situated to the lower left in said predetermined block, as said template.

16. The image processing device according to claim 10, wherein said template pixel setting means set, for a lower right block situated at the lower right of said predetermined block, pixels adjacent to the upper portion of an upper right block situated at the upper right in said predetermined block, and pixels adjacent to the left portion and upper left portion of a lower left block situated to the lower left in said predetermined block, as said template.

17. An image processing method comprising the step of:
an image processing device
decoding an image of an encoded block,
setting pixels of a template used for calculation of a motion vector of a block configuring a predetermined block of an image, out of pixels adjacent to one of said blocks by a predetermined positional relation and also generated from a decoded image, in accordance to the address of said block within said predetermined block,
calculating a motion vector of said block, using said template made up of said pixels that have been set, and
generating a prediction image of said block, using said decoded image and said calculated motion vector.
